(19) United States
(12) Patent Application Publication
(10) Pub. No.: US 2024/0146769 A1
(43) Pub. Date: May 2, 2024

(54) SYSTEMS AND METHODS FOR MANAGING PRIVILEGES IN A DATA PROCESSING SYSTEM

(71) Applicant: Ab Initio Technology LLC, Lexington, MA (US)

(72) Inventors: Drew Polstra, Lexington, MA (US); Robert Parks, Weston, MA (US)

(73) Assignee: Ab Initio Technology LLC, Lexington, MA (US)

(21) Appl. No.: 18/278,264

(22) PCT Filed: Feb. 23, 2022
(86) PCT No.: PCT/US2022/017581

§ 371 Date: Aug. 22, 2023

Related U.S. Application Data
(60) Provisional application No. 63/153,182, filed on Feb. 24, 2021.

(51) Int. Cl. H04L 9/40; H04L 41/22

(52) U.S. Cl. CPC H04L 63/20; H04L 63/102; H04L 41/22

(57) ABSTRACT

Techniques for managing access privileges in a data processing system include obtaining a plurality of rules for granting and/or denying privileges to a first actor to perform at least one action on a first instance of a first data entity of data entities; identifying, from among attributes of the first data entity, a first attribute whose values are used by one or more of the plurality of rules; obtaining, from a user or from at least one data store, a first value of the first attribute; identifying, using the first value and from among the plurality of rules, a first rule that depends on the first value; generating a graphical user interface (GUI) including a visual rendering of at least some of the plurality of rules, the visual rendering emphasizing the first rule identified using the first value of the first attribute; and displaying the generated GUI to the user.

### CROSS-REFERENCE TO RELATED APPLICATIONS

The present application claims the benefit of priority under 35 U.S.C. 119(e) to U.S. Provisional Patent Application No. 63/153,182, filed on Feb. 24, 2021, and titled “Systems and Methods for Managing Privileges in a Data Processing System,” which is hereby incorporated by reference herein in its entirety.

### BACKGROUND

Modern data processing systems manage vast amounts of data (e.g., millions, billions, or trillions of data entities) and manage who is granted privileges to perform actions with respect to these data so that these data are managed securely. For example, a data processing system may grant and/or deny privilege to some individual users and/or some groups of users to perform actions (e.g., create, read, update, and/or delete—also referred to herein as “CRUD”) with respect to some of the data managed by a data processing system.

### SUMMARY

Some embodiments are directed to a method performed by a data processing system for managing access privileges to data stored by a data processing system in instances of data entities, the method comprising: using at least one computer hardware processor of the data processing system to perform: obtaining a plurality of rules for granting and/or denying privileges to a first actor to perform at least one action on one or more instances of a first data entity of the data entities, wherein the first data entity comprises attributes, the one or more instances comprises a first instance and the first instance comprises a value for zero, one, or more of the attributes of the first data entity; identifying, from among the attributes of the first data entity, a first attribute whose values are used by one or more of the plurality of rules; obtaining, from a user or from at least one data store, a first value of the first attribute; identifying, using the first value of the first attribute and from among the plurality of rules for granting and/or denying privileges, a first rule that depends on the first value of the first attribute; generating a graphical user interface (GUI) including a visual rendering of at least some of the plurality of rules, the visual rendering emphasizing the first rule for granting and/or denying privileges identified using the first value of the first attribute; and displaying the generated GUI to the user. These embodiments advantageously enable the data processing system to automatically identify and display to the user rules that relate to a given data entity and its attributes from among a multitude of rules.

Optionally, obtaining the first value of the first attribute may comprise obtaining the first value from the at least one data store. This advantageously enables the method to automatically detect and obtain up-to-date data relating to the internal state of the data processing system, which may change during the course of operation of the data processing system, so that the user may interact with the system to avoid any technical malfunctions.

Optionally, generating the GUI may comprise generating the GUI to include: a first portion comprising at least one GUI element for specifying values of at least one of the attributes of the first data entity; and a second portion comprising the visual rendering of the plurality of rules. Advantageously, this enables the user to specify and alter values of the data entity attributes and determine how these alterations of attribute values influence which privilege rules apply to the data entity (since whether or not a privilege rule applies may depend on the attribute values) Optionally, obtaining the first value of the first attribute comprises: obtaining the first value based on input provided by the user through the at least one GUI element in the first portion of the GUI. Optionally, the at least one GUI element may comprise a drop-down menu, a radio button, and/or a check box.

Optionally, the method may further comprise: obtaining a second value of the first attribute; identifying, using the second value of the first attribute and from among the plurality of rules for granting and/or denying privileges, a second rule that depends on the second value of the first attribute; and updating the visual rendering to identify and/or emphasize the second rule for granting and/or denying privileges identified using the second value of the first attribute. This advantageously enables the system to automatically identify how the relevance of particular rules or parts of rules will change when the value of the first attribute changes and to present these to the user for further interaction.

Optionally, the method may further comprise: obtaining, via user input provided through the first portion of the GUI, a second value of the first attribute; and updating the visual rendering of the plurality of rules in the second GUI portion based on the second value.

Optionally, the method may further comprise: obtaining, via user input provided through the first portion of the GUI, a first value of a second attribute of the first data entity; and updating the visual rendering of the plurality of rules in the second GUI portion based on the first value of the second attribute.

Optionally, the plurality of attributes may include a second attribute that can take values in a second set of values, and the method may further comprise: in response to obtaining the first value of the first attribute, identifying, based on the first value, a subset of the second set of values for the second attribute; and updating the first portion of the GUI to allow the user to select a value for the second attribute only from among the subset of the second set of values. This advantageously provides a system whereby the input received from the user regarding the first attribute is processed and used to guide the further interaction of the user with the system in a manner to prevent the introduction of run-time execution errors in the data processing system.

Optionally, generating the visual rendering may comprise generating text representing at least some of the plurality of rules, the text comprising text representing the first rule for granting and/or denying privileges identified using the first value of the first attribute.

Optionally, generating the visual rendering may comprise emphasizing, in the visual rendering, the text representing the first rule by highlighting, underlining, and/or changing font characteristics of at least some of the text representing the first rule.

Optionally, generating the visual rendering may comprise removing, from the visual rendering, at least some text corresponding to one or more rules different from the first rule.

Optionally, identifying the first attribute whose values are used by one or more of the plurality of rules comprises: generating rule chains from at least some of the plurality of rules; generating a rules tree from the rule chains; and identifying one or more attributes associated with one or more condition nodes in the rules tree, the one or more attributes including the first attribute. This processing advantageously enables the data processing system to quickly and efficiently identify all rules that depend on a given attribute. Optionally, identifying the first rule that depends on the first value of the first attribute may comprise filtering the rules tree based on the first value of the first attribute. This advantageously allows the relevant rule to be identified more quickly than by examining each rule one-at-a-time because using the rules tree reduces the number of rules that have to be examined from a large number of rules, which improves the speed and efficiency with which relevant rules can be identified.

Optionally, generating the rules tree from the rule chains may comprise merging identical nodes across the rule chains. Optionally, filtering the rules tree based on the first value of the first attribute may comprise identifying one or more applicable branches of the rules tree based on the first value of the first attribute. Optionally, identifying the one or more applicable branches of the rules tree may comprise identifying one or more branches of the rules tree including one or more nodes indicating a dependency on the first attribute and/or the first value of the first attribute. Optionally, the method may comprise generating, for each of the identified one or more attributes associated with the one or more condition nodes, a respective GUI element in the GUI to enable the user to provide input indicating a value for the first attribute.

Optionally, the at least one data store may store metadata specifying relationships among the data entities, the data entities may be organized into one or more hierarchies, and the metadata may specify the one or more hierarchies, wherein the first value of the first attribute indicates a first hierarchy, of the one or more hierarchies, to which the first data entity belongs. This advantageously enables the data processing system to automatically identify values for the attributes by processing the attribute values associated with other data entities having a specified relationship with the data entity in question.

Optionally, the first value of the first attribute may indicate at least one classification for the first data entity. Optionally, the privilege rules may comprise create, read, update, or delete privileges.

Some embodiments are directed to a system, comprising: at least one computer hardware processor; at least one non-transitory computer-readable storage medium storing processor executable instructions that, when executed by the at least one computer hardware processor, cause the at least one computer hardware processor to perform a method for managing access privileges to data stored by the system in instances of data entities, the method comprising: obtaining a plurality of rules for granting and/or denying privileges to a first actor to perform at least one action on one or more instances of a first data entity of the data entities, wherein the first data entity comprises attributes, the one or more instances comprises a first instance and the first instance comprises a value for zero, one, or more of the attributes of the first data entity; identifying, from among the attributes of the first data entity, a first attribute whose values are used by one or more of the plurality of rules; obtaining, from a user or from at least one data store, a first value of the first attribute; identifying, using the first value of the first attribute and from among the plurality of rules for granting and/or denying privileges, a first rule that depends on the first value of the first attribute; generating a graphical user interface (GUI) including a visual rendering of at least some of the plurality of rules, the visual rendering emphasizing the first rule for granting and/or denying privileges identified using the first value of the first attribute; and displaying the generated GUI to the user.

Some embodiments are directed to at least one non-transitory computer-readable storage medium storing processor executable instructions that, when executed by at least one computer hardware processor, cause the at least one computer hardware processor to perform a method for managing access privileges to data stored by a data processing system in instances of data entities, the method comprising: obtaining a plurality of rules for granting and/or denying privileges to a first actor to perform at least one action on one or more instances of a first data entity of the data entities, wherein the first data entity comprises attributes, the one or more instances comprises a first instance and the first instance comprises a value for zero, one, or more of the attributes of the first data entity; identifying, from among the attributes of the first data entity, a first attribute whose values are used by one or more of the plurality of rules; obtaining, from a user or from at least one data store, a first value of the first attribute; identifying, using the first value of the first attribute and from among the plurality of rules for granting and/or denying privileges, a first rule that depends on the first value of the first attribute; generating a graphical user interface (GUI) including a visual rendering of at least some of the plurality of rules, the visual rendering emphasizing the first rule for granting and/or denying privileges identified using the first value of the first attribute; and displaying the generated GUI to the user.

Some embodiments are directed to a method for editing rules for controlling access privileges to data stored by the data processing system in instances of data entities, the method comprising: using at least one computer hardware processor of the data processing system to perform: obtaining, via a graphical user interface (GUI), a selection of a first privilege and a selection of a first data entity of the data entities, wherein the first data entity comprises attributes including a first attribute; obtaining a first rule for granting and/or denying the first privilege to a first actor to perform at least one action on one or more instances of the first data entity; updating the first rule based on user input obtained through the GUI to obtain a second rule, the updating comprising: determining a condition under which the first rule applies, the determining comprising: obtaining, via the GUI, a selection of the first attribute; presenting, via the GUI, a plurality of selectable options corresponding to a respective plurality of values of the first attribute; and obtaining, via the GUI, a selection of a first value among plurality of values of the first attribute, the selection indicating that the first rule applies to the first data entity when the first attribute takes on the first value. These embodiments advantageously enable the method implemented in the data processing system to identify and obtain a first rule that relates to the data entity and privilege input by a user and to guide the user through the updating of that rule in accordance with the protocol of the data processing system. This in turn prevents the introduction of run-time execution errors in the data processing system.

Optionally, the first rule for granting and/or denying the first privilege to the at least one actor to perform the at least one action on one or more instances of the first data entity may be obtained by identifying a rule that depends on the first value of the first attribute according to the method for managing access privileges to data stored by a data processing system described above. This advantageously enables the system to predict rules that the users may want to edit and to then guide them through the editing process in a manner that prevents the introduction of run-time execution errors in the data processing system.

Optionally, the at least one data store may store metadata specifying relationships among the data entities, wherein the data entities are organized into one or more hierarchies, wherein the metadata specifies the one or more hierarchies, and wherein the first value of the first attribute indicates a first hierarchy, of the one or more hierarchies, to which the first data entity belongs. Optionally, presenting, via the GUI, the plurality of selectable options may comprise: identifying the plurality of selectable options corresponding to the respective plurality of values of the first attribute using the metadata specifying relationships among the plurality of data entities. This advantageously enables the data processing system to automatically identify predicted values for the attributes by processing the attribute values associated with other data entities having a specified relationship with the selected data entity.

Optionally, the first privilege may be a create, a read, an update, or a delete privilege. Optionally, presenting, via the GUI, the plurality of selectable options comprises presenting, via at least one GUI element in the GUI, the plurality of selectable options corresponding to the respective plurality of values of the first attribute. Optionally, the at least one GUI element comprises a drop-down menu, a radio button, and/or a check box. Optionally, obtaining, via the GUI, the selection of the first attribute comprises obtaining a selection of a sensitivity classification attribute for the first data entity. Optionally, obtaining, via the GUI, the selection of the first attribute comprises obtaining a selection of a workflow attribute for the first data entity. Optionally, the first rule specifies one or more conditions under which the first rule applies, the one or more conditions including the determined condition.

Some embodiments are directed to a system, comprising: at least one computer hardware processor; at least one non-transitory computer-readable storage medium storing processor executable instructions that, when executed by the at least one computer hardware processor, cause the at least one computer hardware processor to perform a method for editing rules for controlling access privileges to data stored by the system in instances of data entities, the method comprising: obtaining, via a graphical user interface (GUI), a selection of a first privilege and a selection of a first data entity of the data entities, wherein the first data entity comprises attributes; obtaining a first rule for granting and/or denying the first privilege to a first actor to perform at least one action on one or more instances of the first data entity; updating the first rule based on user input obtained through the GUI to obtain a second rule, the updating comprising: obtaining, via the GUI, a selection of the first attribute; presenting, via the GUI, a plurality of selectable options corresponding to a respective plurality of values of the first attribute; and obtaining, via the GUI, a selection of a first value among plurality of values of the first attribute, the selection indicating that the first rule applies to the first data entity when the first attribute takes on the first value.

Some embodiments are directed to at least one non-transitory computer-readable storage medium storing processor executable instructions that, when executed by at least one computer hardware processor, cause the at least one computer hardware processor to perform a method for editing rules for controlling access privileges to data stored by a data processing system in instances of data entities, the method comprising: obtaining, via a graphical user interface (GUI), a selection of a first privilege and a selection of a first data entity of the data entities, wherein the first data entity comprises attributes; obtaining a first rule for granting and/or denying the first privilege to a first actor to perform at least one action on one or more instances of the first data entity; updating the first rule based on user input obtained through the GUI to obtain a second rule, the updating comprising: determining a condition under which the first rule applies, the determining comprising: obtaining, via the GUI, a selection of the first attribute; presenting, via the GUI, a plurality of selectable options corresponding to a respective plurality of values of the first attribute; and obtaining, via the GUI, a selection of a first value among plurality of values of the first attribute, the selection indicating that the first rule applies to the first data entity when the first attribute takes on the first value.

Some embodiments are directed to a method for editing rules for controlling access privileges to data stored by a data processing system in instances of data entities, the method comprising: using at least one computer hardware processor of the data processing system to perform: obtaining, via a graphical user interface (GUI), a selection of a first privilege and a selection of a first data entity of the data entities, wherein the first data entity comprises attributes; obtaining a first rule for granting and/or denying the first privilege to a first actor to perform at least one action on one or more instances of the first data entity; updating the first rule based on user input obtained through the GUI to obtain a second rule, the updating comprising: in response to obtaining user input to edit the first actor specified in the first rule: identifying a plurality of actors to whom the first privilege can be granted based on at least one value of a first attribute of the attributes; and presenting, via the GUI, a plurality of selectable options corresponding to the plurality of actors. These embodiments advantageously enable the method implemented in the data processing system to identify and obtain a first rule that relates to the data entity and to guide the user through the updating of that rule by automatically suggesting potential actors to whom privileges are to be granted in accordance with the protocol of the data processing system. This in turn prevents the introduction of run-time execution errors in the data processing system.

Optionally, the first rule for granting and/or denying the first privilege to the first actor to perform the at least one action on one or more instances of the first data entity is obtained by identifying a rule that depends on the first value of the first attribute according to the method for managing access privileges to data stored by a data processing system in instances of data entities as described above. This advantageously enables the system to predict rules that the user may want to edit and to then guide them through the editing process in a manner that prevents the introduction of run-time execution errors in the data processing system.

Optionally the data processing system may comprise at least one data store that may store metadata specifying relationships among the data entities, wherein the data entities are organized into one or more hierarchies, the metadata specifies the one or more hierarchies, and the at least one value of the first attribute comprises a first value of the first attribute, and wherein the first value of the first attribute indicates a first hierarchy, of the one or more hierarchies, to which the first data entity belongs. Optionally, identifying a plurality of actors to whom the first privilege can be granted may comprise: identifying the plurality of actors to whom the first privilege can be granted using the metadata specifying relationships among the data entities. This advantageously enables the data processing system to automatically identify values for the attributes by processing the attribute values associated with other data entities having a specified relationship with the selected data entity.

Optionally, the first privilege may be a create, a read, an update, or a delete privilege. Optionally, presenting, via the GUI, a plurality of selectable options comprises: presenting, via at least one GUI element in the GUI, the plurality of selectable options corresponding to the plurality of actors. Optionally, the at least one GUI element comprises a drop-down menu, a radio button, and/or a check box. Optionally, the first rule specifies one or more conditions under which the first rule applies and one or more actors to whom the first privilege can be granted.

Optionally, the method may comprise obtaining a plurality of rules for granting and/or denying the first privilege to the first actor to perform the at least one action on one or more instances of the first data entity, the plurality of rules comprising the first rule; presenting, via the GUI, the plurality of rules arranged in a first order; and evaluating the plurality of rules in accordance with the first order. Optionally, the method may comprise in response to obtaining user input to update the first order of the plurality of rules via at least one GUI element in the GUI: presenting, via the GUI, the plurality of rules arranged in an updated order; and evaluating the plurality of rules in accordance with the updated order.

Some embodiments are directed to a system, comprising: at least one computer hardware processor; at least one non-transitory computer-readable storage medium storing processor executable instructions that, when executed by the at least one computer hardware processor, cause the at least one computer hardware processor to perform a method for editing rules for controlling access privileges to data stored by the system in instances of data entities, the method comprising: obtaining, via a graphical user interface (GUI), a selection of a first privilege and a selection of a first data entity of the data entities, wherein the first data entity comprises attributes; obtaining a first rule for granting and/or denying the first privilege to a first actor to perform at least one action on one or more instances of the first data entity; updating the first rule based on user input obtained through the GUI to obtain a second rule, the updating comprising: in response to obtaining user input to edit the first actor specified in the first rule: identifying a plurality of actors to whom the first privilege can be granted based on at least one value of a first attribute of the attributes; and presenting, via the GUI, a plurality of selectable options corresponding to the plurality of actors.

Some embodiments are directed to at least one non-transitory computer-readable storage medium storing processor executable instructions that, when executed by at least one computer hardware processor, cause the at least one computer hardware processor to perform a method for editing rules for controlling access privileges to data stored by a data processing system in instances of data entities, the method comprising: obtaining, via a graphical user interface (GUI), a selection of a first privilege and a selection of a first data entity of the data entities, wherein the first data entity comprises attributes; obtaining a first rule for granting and/or denying the first privilege to a first actor to perform at least one action on one or more instances of the first data entity; updating the first rule based on user input obtained through the GUI to obtain a second rule, the updating comprising: in response to obtaining user input to edit the first actor specified in the first rule: identifying a plurality of actors to whom the first privilege can be granted based on at least one value of a first attribute of the attributes; and presenting, via the GUI, a plurality of selectable options corresponding to the plurality of actors.

Various aspects described above may be used alternatively or additionally with aspects in any of the systems, methods, and/or processes described herein. For example, a system, such as a data processing system, may be configured to operate according to a method with one or more of the foregoing aspects. Such a data processing system may comprise at least one computer hardware processor, and at least one non-transitory computer-readable medium storing processor executable instructions that, when executed by the at least one computer hardware processor, cause the at least one computer hardware processor to perform such a method. Further, a non-transitory computer-readable medium may comprise processor executable instructions, that when executed by at least one computer hardware processor of a data processing system, cause the at least one computer hardware processor to perform a method with one or more of the foregoing aspects. As such, the foregoing is a non-limiting summary of the invention, which is defined by the attached claims.

### BRIEF DESCRIPTION OF DRAWINGS

Various aspects will be described with reference to the following figures. It should be appreciated that the figures are not necessarily drawn to scale. Items appearing in multiple figures are indicated by the same or a similar reference number in all the figures in which they appear.

FIG. 1A is a diagram illustrating an example enterprise system environment in which a data processing system 105 may be used, in accordance with some aspects of the technology described herein.

FIG. 1B is a block diagram of an illustrative data processing system 105 and a privileges management system 130 part of the data processing system 105, in accordance with some aspects of the technology described herein.

FIG. 1C is a diagram illustrating an example implementation of the data processing system 105, in accordance with some aspects of the technology described herein.

FIG. 1D is a diagram illustrating a scenario where attributes of an actor requesting access to a data entity instance and values of attributes of the data entity instance are evaluated to determine that the actor is granted access to the data entity instance, in accordance with some aspects of the technology described herein.

FIG. 1E is a diagram illustrating a scenario where attributes of an actor requesting access to a data entity instance and values of attributes of the data entity instance are evaluated to determine that the actor is denied access to the data entity instance, in accordance with some aspects of the technology described herein.

FIG. 1F is a diagram illustrating example data and rules stored in a data persistence layer 150 of the data processing system 105, in accordance with some aspects of the technology described herein.

FIG. 1G is an illustrative diagram of a scenario where an actor is prevented from accessing data in data processing system 105, in accordance with some aspects of the technology described herein.

FIGS. 1H-1I are illustrative diagrams of a scenario of FIG. 1G where an actor is prevented from accessing data in data processing system 105 but an administrator may utilize a graphical user interface that provides intuitive visualizations of the internal state of the data processing system and the CRUD operating mode for the actor requesting access in order to identify relevant privilege rules, in accordance with some aspects of the technology described herein.

FIG. 2 is a block diagram illustrating aspects of the data processing system 105, in accordance with some aspects of the technology described herein.

FIG. 3A is an illustrative diagram of an example graphical user interface (GUI) 300 through which a user may visualize one or more rules for granting and/or denying privileges to one or more actors to perform one or more actions on one or more instances of a data entity “DataElement” having at least two attributes, in accordance with some aspects of the technology described herein.

FIG. 3B is an illustrative diagram of the example GUI 300 showing how a visual rendering of at least some of the rule(s) of FIG. 3A may be updated in response to obtaining, through a first portion 302 of the GUI 300, input from a user indicating a value of an attribute “Security Group” of the data entity “DataElement”, in accordance with some aspects of the technology described herein.

FIG. 3C is an illustrative diagram of the example GUI 300 showing how a visual rendering of at least some of the rule(s) of FIG. 3A may be updated in response to obtaining, through a first portion 302 of the GUI 300, input from a user indicating a value of an attribute “Dataset” of the data entity “DataElement”, in accordance with some aspects of the technology described herein.

FIG. 4A is an illustrative diagram of an example GUI 400 executing in a simulation mode for a data entity, in accordance with some aspects of the technology described herein.

FIG. 4B is an illustrative diagram of the example GUI 400 showing how the visual rendering of the rules within GUI 400 may be updated in response to a user selecting a privilege of interest, in accordance with some aspects of the technology described herein.

FIG. 4C is an illustrative diagram of the example GUI 400 showing how the visual rendering of the rules within GUI 400 may be updated in response to obtaining, through a first portion 402 of the GUI 400, input from a user indicating that the “Security Group” attribute of data entity “DataElement” is set, in accordance with some aspects of the technology described herein.

FIG. 4D is an illustrative diagram of the example GUI 400 showing how the visual rendering of the rules within GUI 400 may be updated in response to obtaining, through a first portion 402 of the GUI 400, input from a user indicating that the “Security Group” attribute of data entity “DataElement” is not set, in accordance with some aspects of the technology described herein.

FIG. 5 is an illustrative diagram of an example GUI 500 executing in an evaluation mode for a data entity, in accordance with some aspects of the technology described herein.

FIG. 6A is a flowchart of an illustrative process 600 for visualizing privilege rules for a data entity, in accordance with some aspects of the technology described herein.

FIG. 6B is a flowchart of an example implementation of illustrative process 600 for visualizing privilege rules for a data entity.

FIG. 7A illustrates a table 700 of example rules for granting and/or denying privileges to actor(s) for performing action(s) on one or more instances of a “DataElement” data entity, in accordance with some aspects of the technology described herein.

FIG. 7B illustrates rule chains generated using the example rules of FIG. 7A, in accordance with some aspects of the technology described herein.

FIG. 7C illustrates an example rules tree generated using the example rule chains of FIG. 7B, in accordance with some aspects of the technology described herein.

FIG. 8A illustrates a table 800 of example rules for granting and/or denying privileges to actor(s) for performing action(s) on one or more instances of a “User Report” data entity, in accordance with some aspects of the technology described herein.

FIG. 8B illustrates rule chains generated using the example rules of FIG. 8A, in accordance with some aspects of the technology described herein.

FIG. 8C illustrates an example rules tree generated using the example rule chains of FIG. 8B, in accordance with some aspects of the technology described herein.

FIG. 8D illustrates a visual rendering, generated using the rules tree of FIG. 8C, of at least some of the example rules for granting and/or denying privileges to actor(s) for performing action(s) on one or more instances of a “User Report” data entity, in accordance with some aspects of the technology described herein.

FIG. 9A illustrates an example rules tree embodying rules having a logical ‘and’ condition, in accordance with some aspects of the technology described herein.

FIG. 9B illustrates a visual rendering, generated using the rules tree of FIG. 9A, of at least some of the example rules for granting and/or denying privileges to actor(s) for performing action(s) on one or more instances of a “Issue” data entity, in accordance with some aspects of the technology described herein.

FIG. 10A illustrates an example rules tree embodying rules having a logical ‘or’ condition, in accordance with some aspects of the technology described herein.

FIG. 10B illustrates a visual rendering, generated using the rules tree of FIG. 10A, of at least some of the example rules for granting and/or denying privileges to actor(s) for performing action(s) on one or more instances of a “Principal” data entity, in accordance with some aspects of the technology described herein.

FIG. 11A is an illustrative diagram of an example GUI 1115 through which a user may be provided with options for selecting a privilege of interest for one or more rules for granting and/or denying privileges and selecting a data entity to which one or more rules for granting and/or denying privileges apply, in accordance with some aspects for the technology described herein.

FIG. 11B-11D are illustrative diagrams of example GUIs 1116, 1117, 1118 through which a user may create new rules and/or edit existing rules associated with the data entity selected in FIG. 11A and the privilege of interest selected in FIG. 11A, in accordance with some aspects for the technology described herein.

FIG. 11E is an illustrative diagram of an example GUI 1119 through which a user may view one or more rules associated with a particular data entity and privilege of interest, in accordance with some aspects for the technology described herein.

FIGS. 12A-12E are illustrative diagrams of example GUIs 1200, 1202, 1204, 1206, and 1208 through which a user may create a new rule and/or edit existing rules for granting and/or denying privileges to actor(s) for performing action(s) with respect to a “BizAsset” data entity, in accordance with some aspects of the technology described herein.

FIG. 13 is a flowchart of an illustrative process 1300 for creating and/or editing rules associated with a data entity, in accordance with some aspects of the technology described herein.

FIG. 14 is a flowchart of an illustrative process 1400 for creating and/or editing rules associated with a data entity, in accordance with some aspects of the technology described herein.

FIG. 15 is a block diagram of an illustrative computing system environment that may be used in implementing some aspects of the technology described herein.

### DETAILED DESCRIPTION

Aspects of the technology described herein relate to increasing the speed, throughput, and accuracy of a data processing system by improving upon conventional techniques for managing data access privileges for data entities managed by the data processing system. A data processing system may manage thousands, millions, billions or trillions of data entities and instances thereof. The techniques described herein enable efficient implementation of techniques for managing privileges for such data entities and their instances in a way that reduces errors occurring in and the computational resources used by data processing systems that manage privileges using conventional privilege management techniques. The techniques developed by the inventors provide data processing system users with precise and concise control over who can perform create, read, update, and delete actions on instances of data entities and/or specific attributes associated with the data entities.

As described herein, a data processing system may manage data using data entities, which may be used to organize the data using an object-oriented paradigm. A data entity may specify attributes, which may take on different values such as numbers, strings, or references to other data entities when instantiated. One or more data entity instances may be instantiated from a data entity, and used to store data. For example, a data processing system for a bank may include a credit score data entity for storing information about customer credit scores. In this example, the credit score data entity may specify attributes such as a credit score value, a credit score agency, a credit score definition, and/or other attributes. The data processing system may instantiate multiple (e.g., hundreds, thousands, or millions) of instances of the credit score data entity to store credit score information for their customers as values of the attributes specified by the credit score data entity. Accordingly, similar to how object-oriented programming involves classes and instances thereof, a data processing system may be configured with definitions of data entities and manage data using instances of the data entities.

A data entity instance may include a value for zero, one, or more of the attributes of a data entity. A data entity instance may not be required to store all its attribute values together. In some embodiments, attribute values of a data entity instance may be stored using one or multiple data structures. For example, attribute values may be stored using one or more tables, records, lists, or any other suitable data structures, as aspects of the technology described herein do not require values of a particular data entity instance to be stored using the same underlying data structure in memory.

As described herein, a data processing system may be used for managing many different types of data. For example, in some applications, a data processing system may be used for metadata management. In such applications, data entity instances instantiated from respective data entities may store information (“metadata”) about other data. For example, the data entity instances may store metadata about data of an enterprise system (e.g., for a large multi-national corporation such as a credit card company, a phone company, a bank, etc.). In such applications, the data of the enterprise system may include millions or billions of datasets (e.g., tables, documents, records, etc.) deployed across multiple databases, data warehouses, data lakes, etc. Thus, the data processing system may manage a large amount (e.g., millions or billions) of data entity instances that contain metadata about the datasets. Although examples described herein may refer to metadata management, it should be appreciated that techniques developed by the inventors and described herein are not limited to being applied to any particular type of data and may be used within any data processing system using data entities and data entity instances instantiated from the data entities to manage data irrespective of whether the managed data is metadata or any other type of data (e.g., transactions, files, data records, tables, etc.).

One or more privileges for a data entity or attributes of the data entity may be granted and/or denied to one or more actors. An actor may be defined as a user of the data processing system for whom certain privileges or privileges in relation to access or use of a data entity, an instance of the data entity and/or attributes of the data entity may be granted and/or denied. An actor may be granted or denied privileges to perform one or more actions on instance(s) of a data entity. For example, one actor may be granted privileges to perform a create action on an instance of a data entity that allows the actor to create the instance of the data entity, while another actor or actors may be granted privileges to perform a read action on the data entity instance that allows the other actor or actors to read or otherwise view values of attributes specified by the data entity. An actor may be a user of a data processing system who is authorized to perform one or more actions with respect to one or more data entities and/or one or more data entity instances of the data entities managed by the data processing system.

The technology developed by the inventors and described herein improves the manner in which an underlying data processing system manages data access privileges. In conventional data processing systems, data access privileges are typically defined as rules and maintained in tables or spreadsheets, which is difficult for users of the data processing system to manipulate, interact with, configure, and manage. Moreover, such tables or spreadsheets can be quite large for enterprise data processing systems that manage large numbers (e.g., millions or billions) of data entities and their instances and involve hundreds, thousands, or tens of thousands of rules. Interacting with or manipulating (e.g., reading, writing, modifying, debugging, etc.) the information stored in such tables is time-consuming, inefficient, and extremely difficult for users of the data processing system. Such solutions result in various types of errors. One example of an error is creating or editing a rule for managing privileges that includes invalid values for rule parameters or is otherwise not specified in accordance with a format understood by the data processing system, either of which could result in run-time execution errors of the data processing system. Run-time execution errors may include errors during execution of the data processing system software programs for managing privileges, resulting in thrown exceptions, unavailable functionality, hanging, and/or unexpected exits from such software program(s). Another example of an error is providing data access to an unauthorized user or preventing an authorized user from accessing data in the data processing system. These types of errors impact the performance of the data processing and are difficult for users to identify and resolve.

Another problem with conventional techniques for managing data access privileges is that there may be many rules (e.g., hundreds, thousands, or tens of thousands of rules) controlling the data access privileges, and it is very difficult (if not impractical) for a user interested in authoring, testing, debugging, or editing access privileges for a particular piece of data to identify the relevant rules from among the many rules of a data processing system. Identifying such rules may be time consuming, expensive, and error prone.

Yet another problem is that, even if the relevant rules were identified, it is difficult to determine how these rules would be applied to particular data entities and their instances. The reason is that rules for controlling access to data stored by the data processing system in instances of data entities themselves frequently depend on other information. For example, whether a particular user has privileges to create, read, update, and/or delete an instance of a data entity may depend on information associated with the particular user (e.g., information indicating whether the user is part of a group of users having such privileges or has a particular role in the enterprise), information associated with the data entity or data entity instance (e.g., information indicating whether the data entity or data entity instance includes sensitive data, information indicating whether the data entity or data entity instance is associated with, for example by being in a same group or hierarchy as, another data entity or data entity instance for which the particular user has create, read, update, and/or delete (CRUD) privileges, and/or any other information). Simply put, the rules may depend on values of one or multiple variables and examining the rules alone, without having access to the values of the variables, does not allow a determination to be made regarding how the rules would be applied in practice, or how to author, debug, and/or edit these rules. All this makes conventional techniques for interacting with and manipulating data access privileges impractical, error-prone, and difficult for users of data processing systems.

The inventors have developed new technology that facilitates management of data access privilege rules in data processing systems. The technology developed by the inventors includes: (1) techniques for automatically identifying relevant privilege rules from among many potentially applicable rules; and (2) graphical user interfaces to provide intuitive visualizations of the internal state of the data processing system and the CRUD operating mode, for given users and data entities/data entity instances, that are controlled by the identified data access privilege rules based on any relevant variables. This allows not only the privilege rules that are implicated to be identified clearly to the user, in controlling access privileges for a specific data entity or entities and/or instance(s) thereof, but how these rules would be applied in practice based on the values of variables (e.g., the values stored in the data processing system) that the rules depend on. Additionally, the graphical user interfaces developed by the inventors guide the users through the process of creating and/or editing the rules by providing the user with various suggestions for values of one or multiple variables associated with the data entities/data entity instances. Accordingly, these visualizations allow users of the data processing system to author, test, and debug the rules efficiently and without introducing run-time and/or privilege errors during operation of the data processing system.

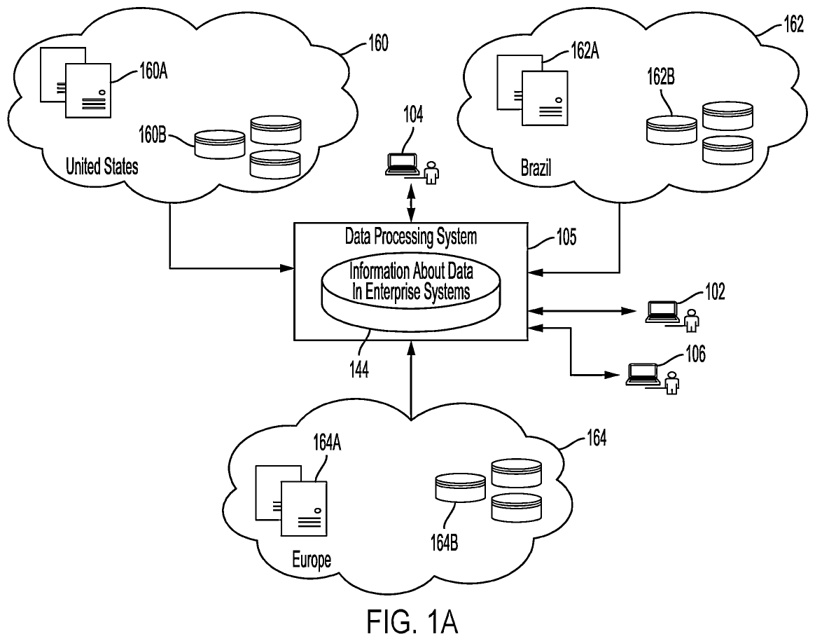

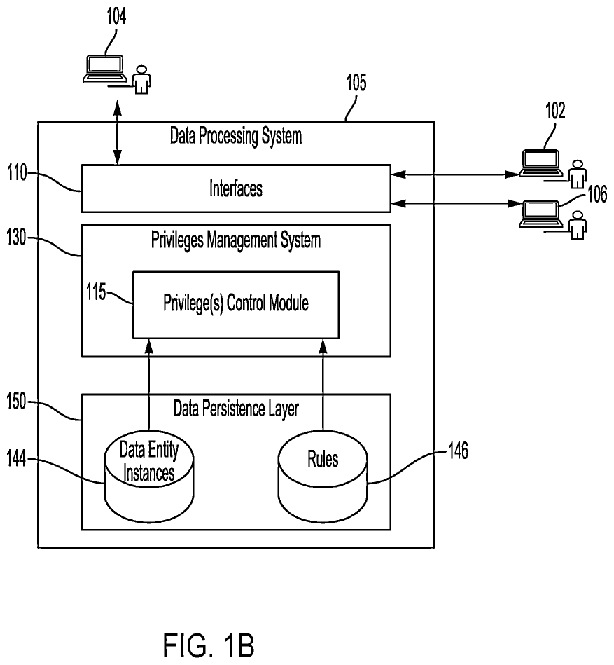

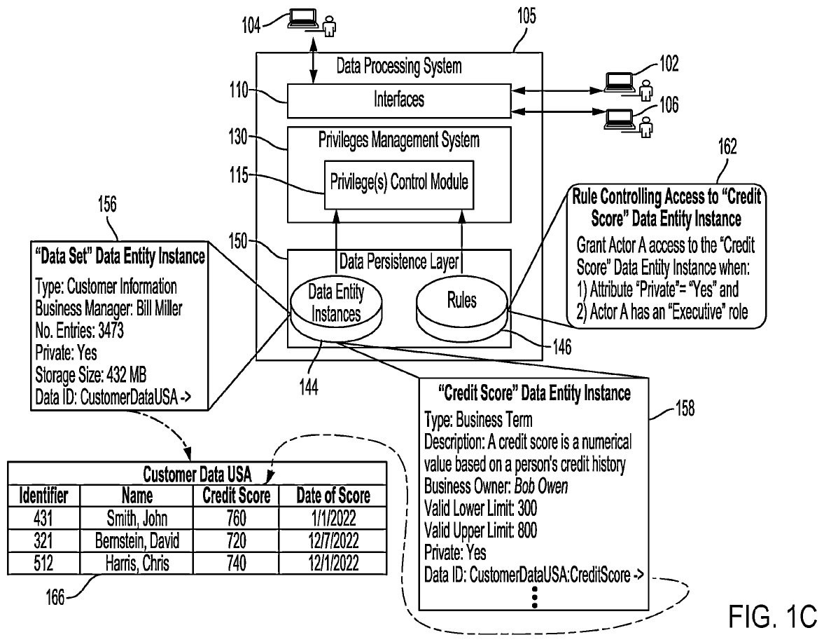

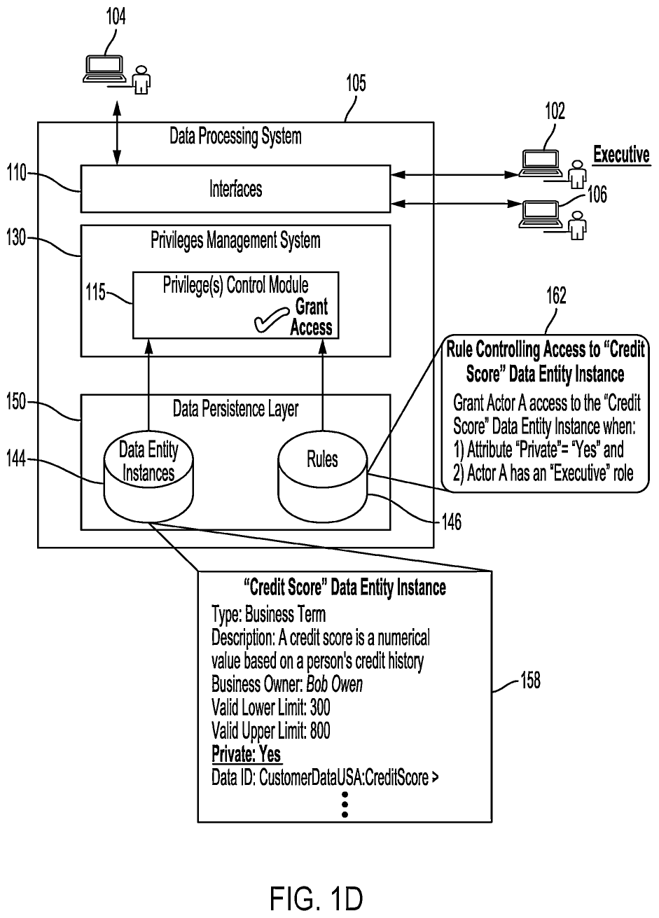

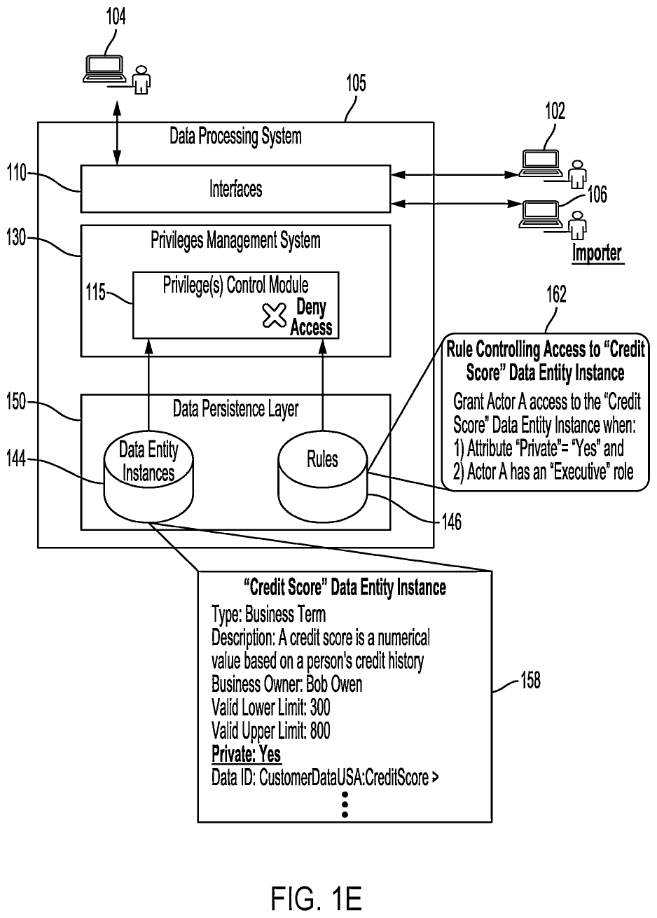

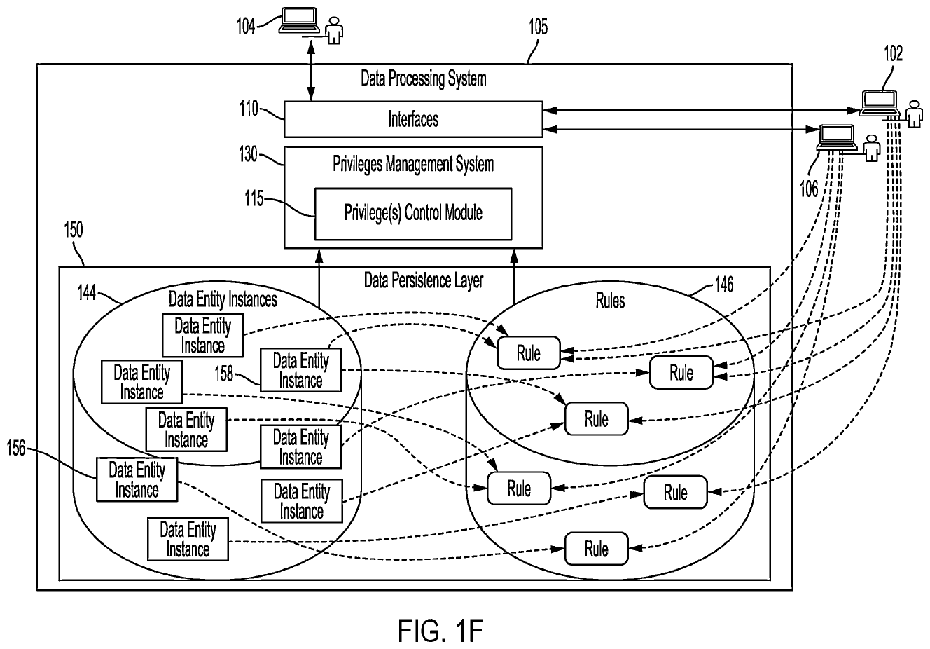

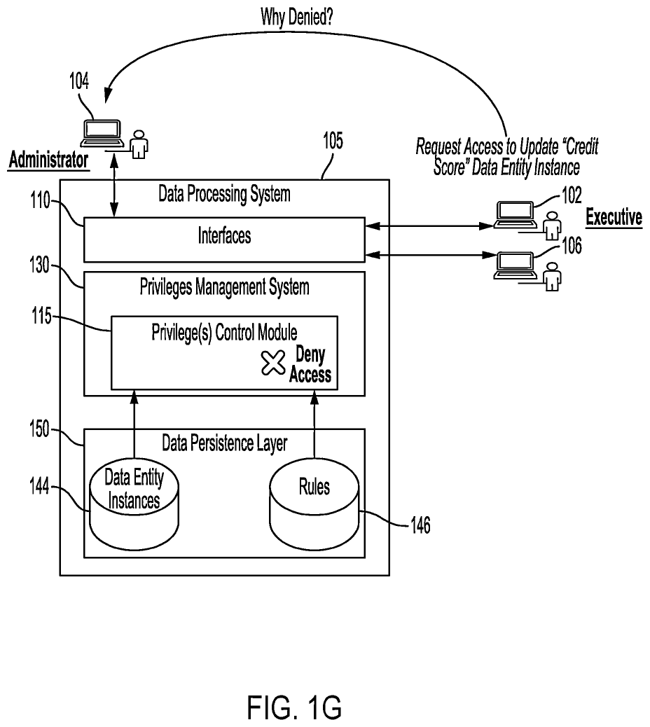

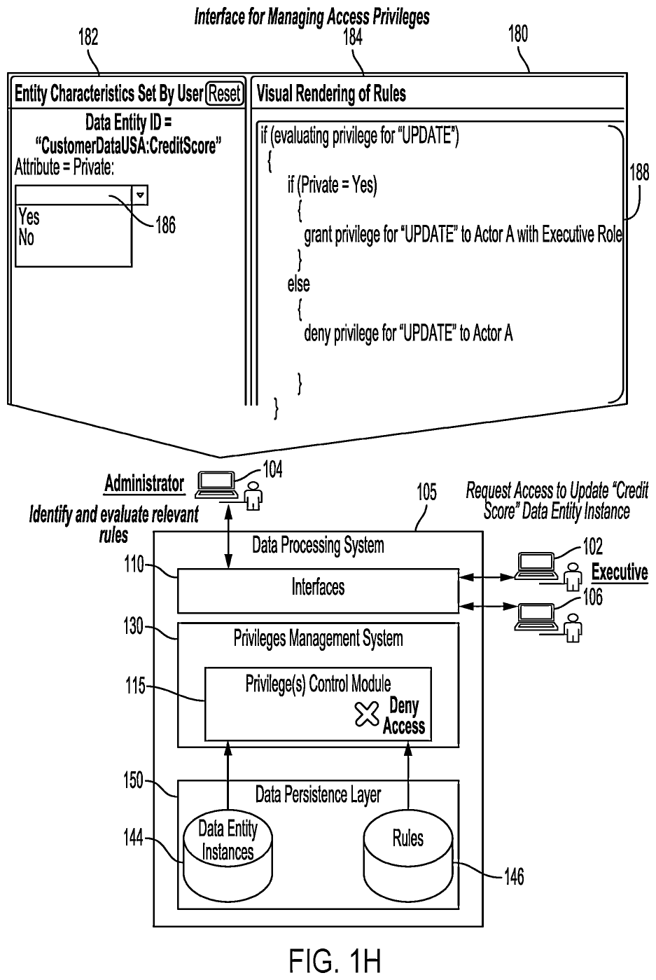

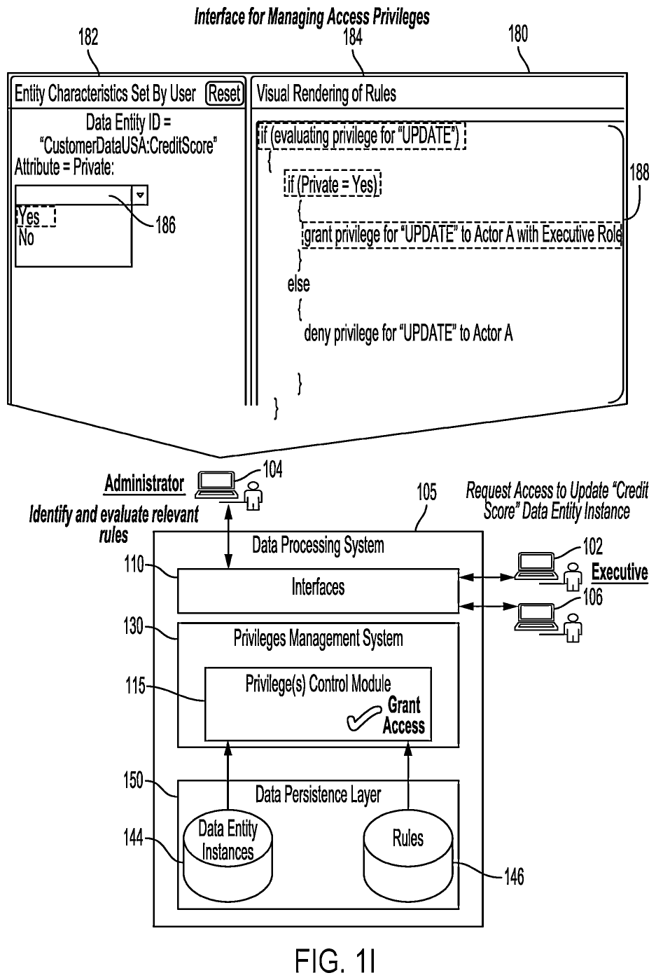

For example, in some embodiments, a user of a data processing system may wish to access rules controlling data access privileges for a particular data entity (e.g., rules for granting and/or denying privileges to actor(s) to perform action(s) on instance(s) of the data entity) and the data processing system may: (1) identify the rule(s) controlling data access privileges for the particular data entity from among multiple rules with which the data processing system is configured; (2) present a visualization of these rules to the user via a graphical user interface; and (3) allow the user to edit the identified rule(s). Examples of this are described herein including in FIGS. 1H-1I, FIGS. 3A-3C, FIG. 4A-4D, FIGS. 11A-11E, and FIGS. 12A-12E.

According to some aspects, when a rule depends on the value(s) of one or more variables, a user may input (e.g., via a graphical user interface) different values for the variable(s) to understand the impact of these values on the rule. In this way, a user can change a value of a variable on which a rule depends and determine whether changing the value of the variable changes any data access privileges controlled by the rule. This mode of operation may be referred to as a “simulator” mode of operation because, in this mode, a user can simulate the effect of different variable values, on which the rules depend, to understand the impact of these values on access privileges. In some embodiments, the rules can be defined and/or tested by simulating different conditions and exploring ‘what if’ scenarios to understand the resulting privileges that will be granted or denied for a particular data entity and/or instance(s) of the data entity.

Additionally or alternatively, according to some aspects, when a rule for controlling access privileges for a particular data entity depends on the value(s) of one or more variables, the data processing system may access the variable value(s) for one or more instances of that data entity in the data processing system and use the accessed value(s) to evaluate the rule. This mode of an operation may be referred to as an “evaluator” mode of operation because, in this mode, the access privileges for a particular data entity that would be granted by rules when evaluated using the actual variable value(s) for instance(s) of the data entity in the data processing system can be determined and displayed (as opposed to simulated values, for example, input by a user through a graphical user interface). In some embodiments, a user can evaluate the rules for a particular data entity to understand why certain privileges are granted or not granted for the data entity and/or instance(s) of the data entity, in a visual manner without having to expend considerable amounts of manual resources to parse and evaluate the privileges.

The graphical user interfaces described herein that present visualizations of rules not only allow a user to understand the internal state of the data processing system and which privilege rules apply (e.g., to a particular actor, a data entity, and/or instance of the data entity), but also allow the user to author, test, and debug the rules efficiently and without introducing run-time and/or privilege errors during operation of the data processing system. For example, the graphical user interfaces may guide an administrator and/or other user of the data processing system through the process of creating and/or editing the rules by providing the user with various suggestions for values of one or multiple variables associated with the data entities, thereby preventing creation of rules with erroneous variables.

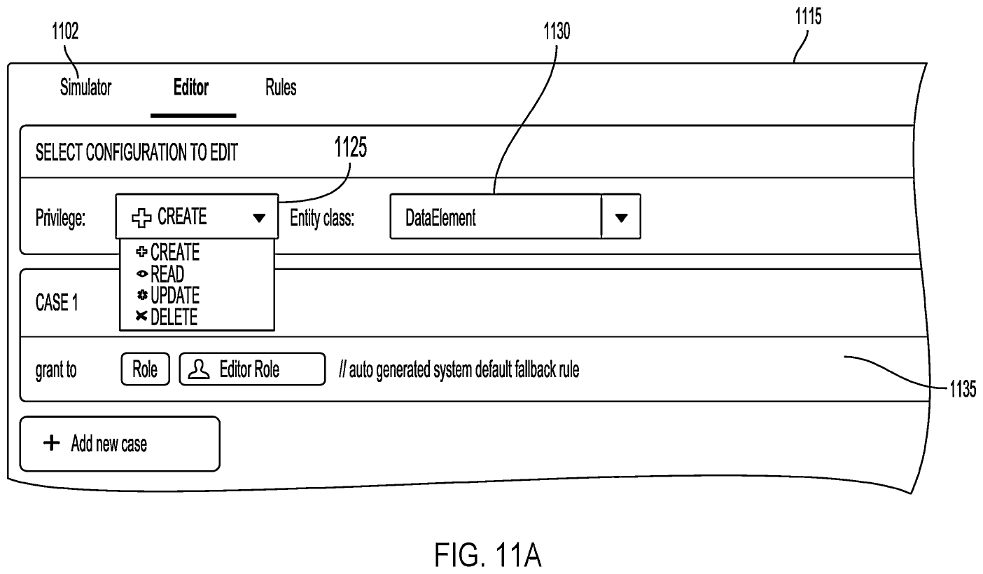

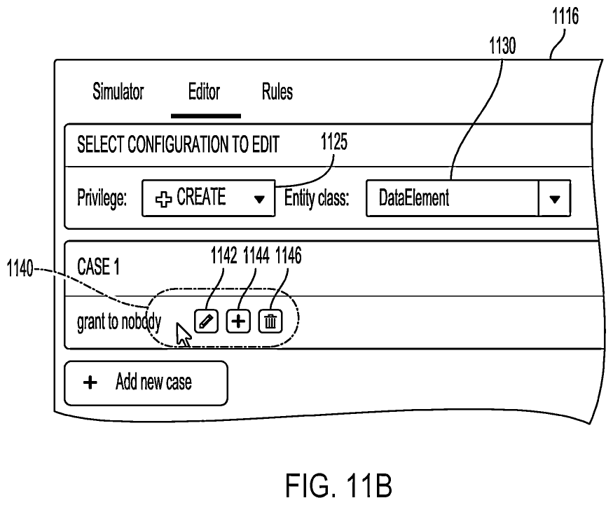

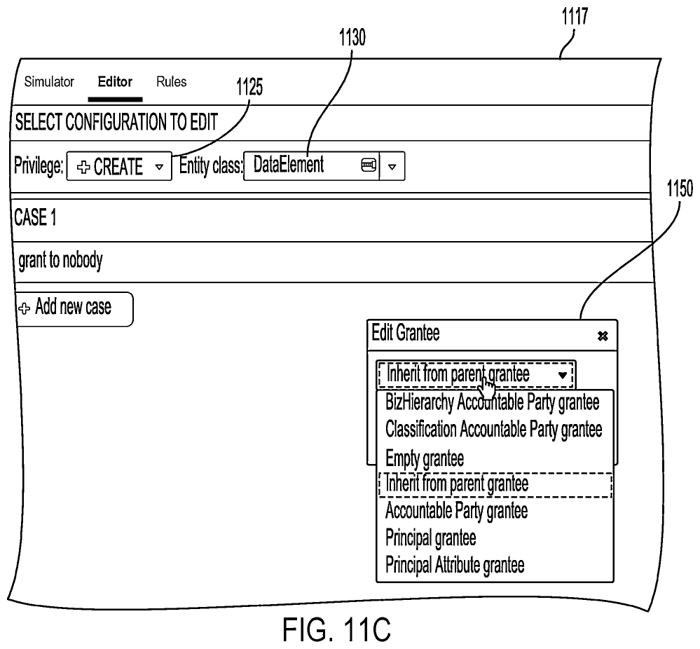

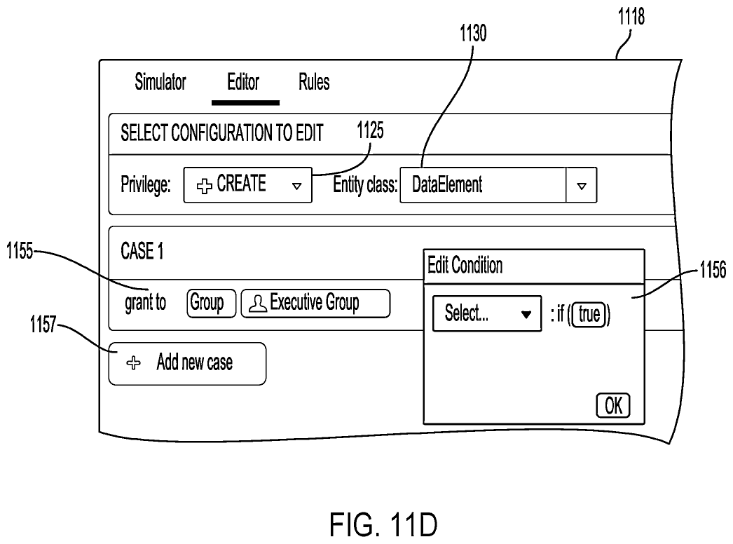

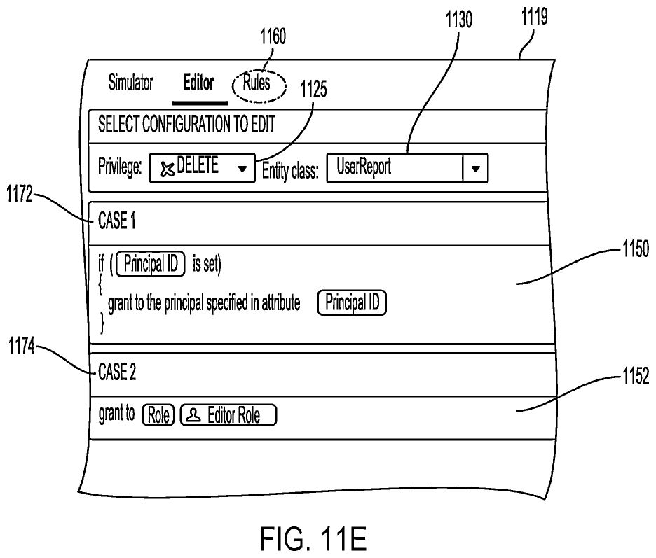

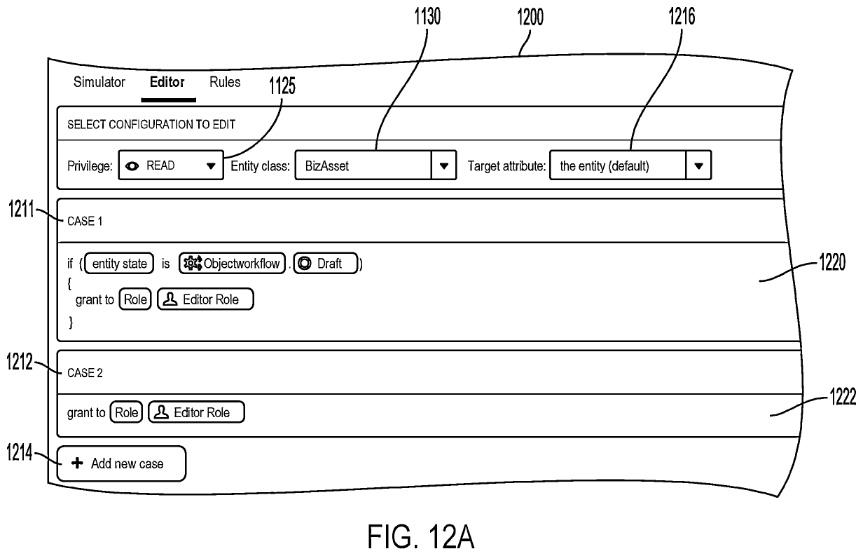

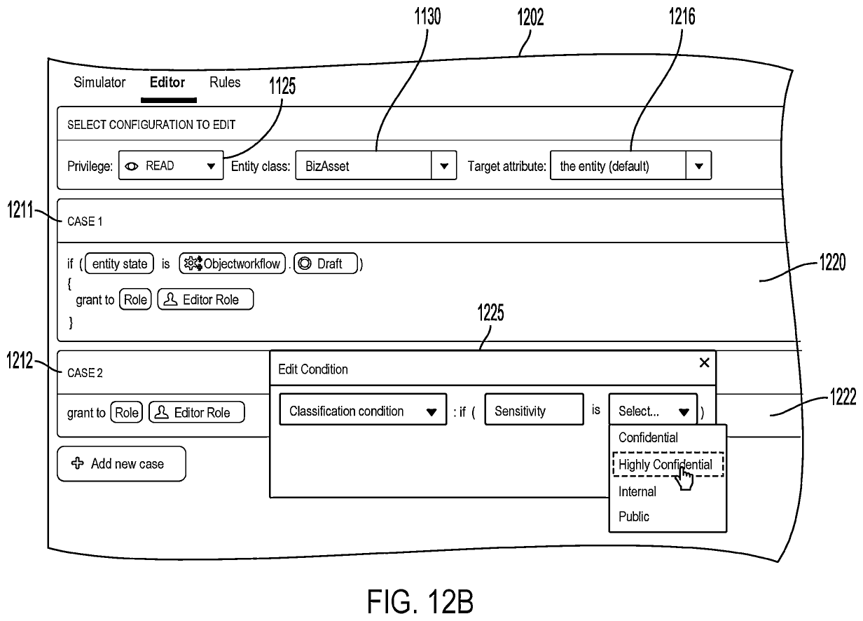

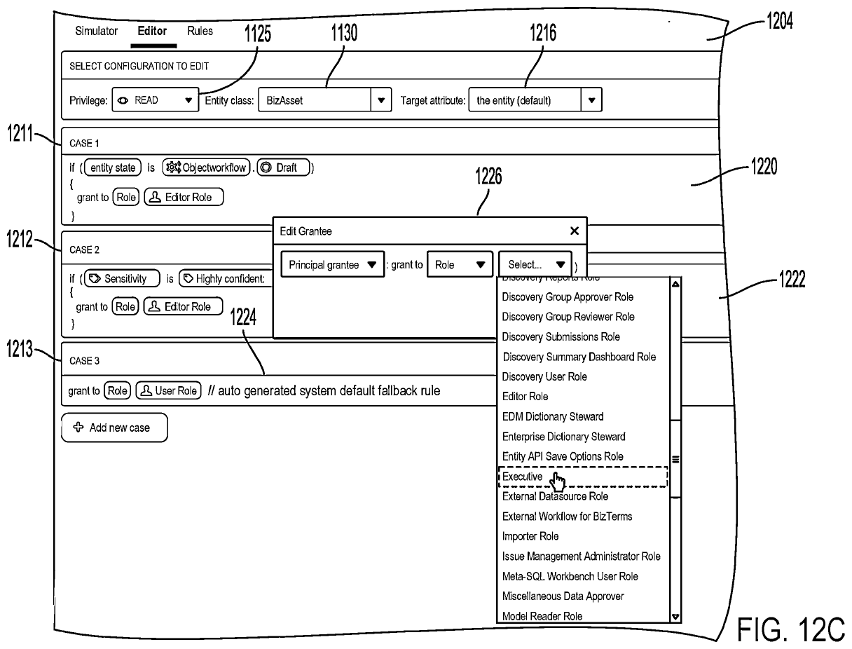

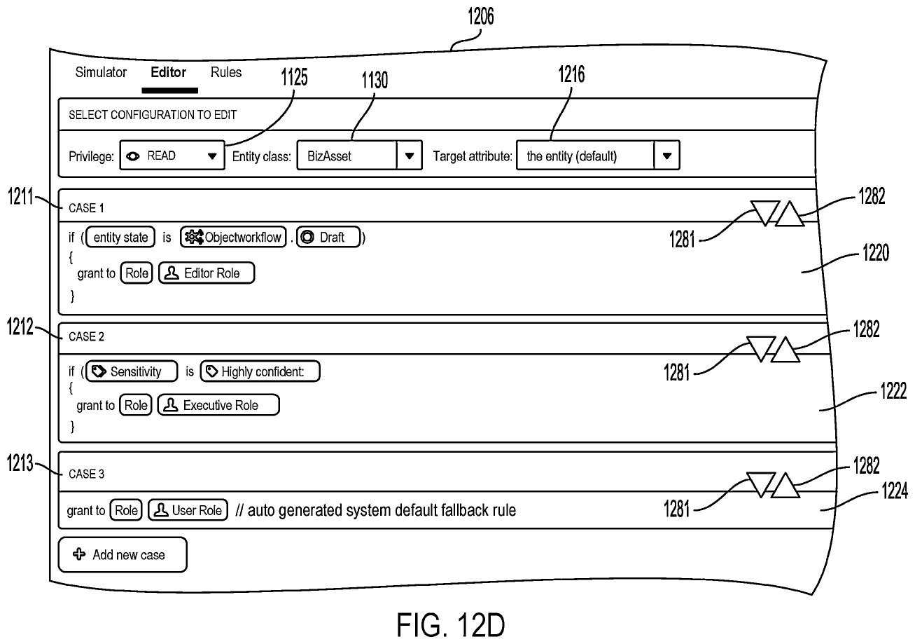

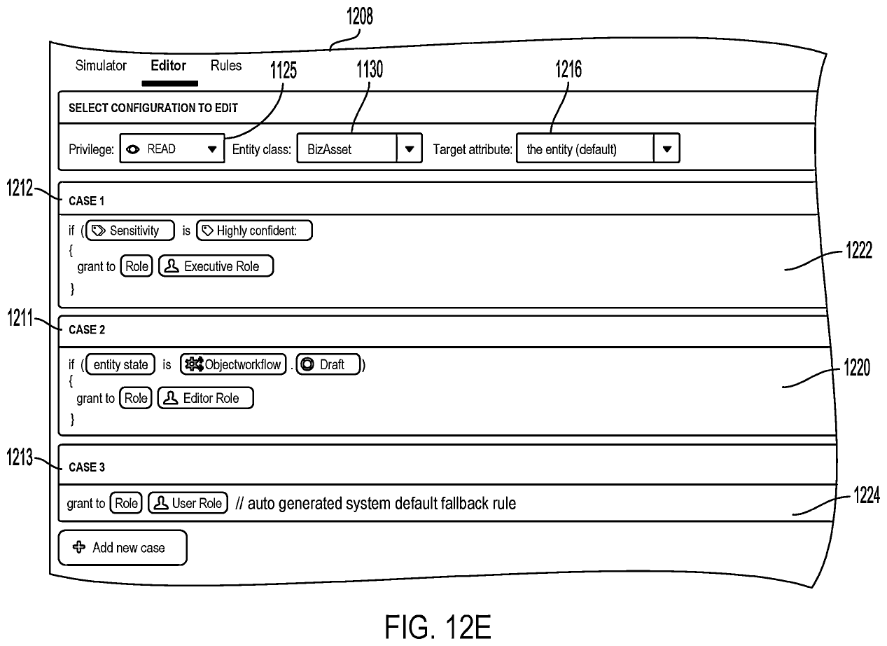

Furthermore, a user of a data processing system may utilize a graphical user interface to edit rules controlling data access privileges for a particular data entity. The data processing system may allow a user to edit these rules via the graphical user interface. This mode of an operation may be referred to as an “editor” mode of operation because, in this mode, a user can create, make changes to, and/or delete rules associated with a data entity via the graphical user interface. Examples of this are described herein including in FIGS. 11A-11E and FIGS. 12A-12E.

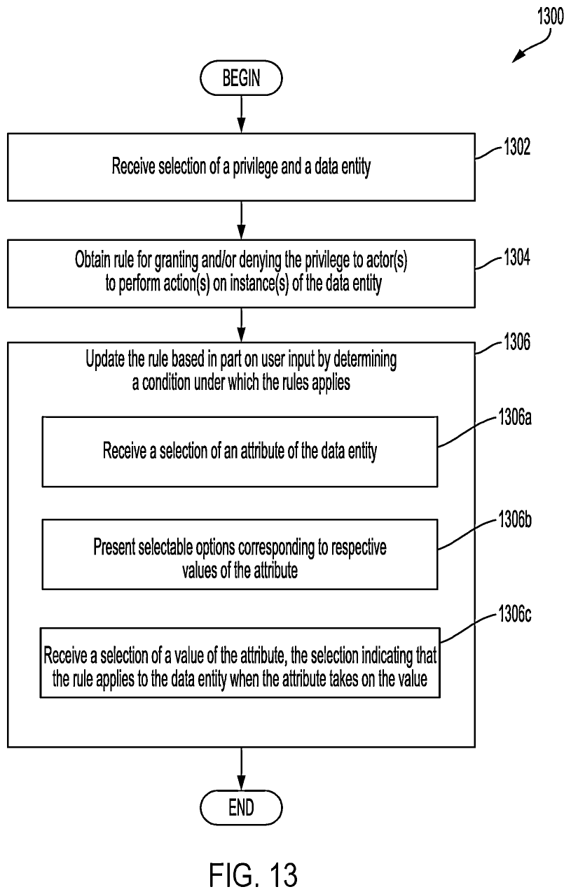

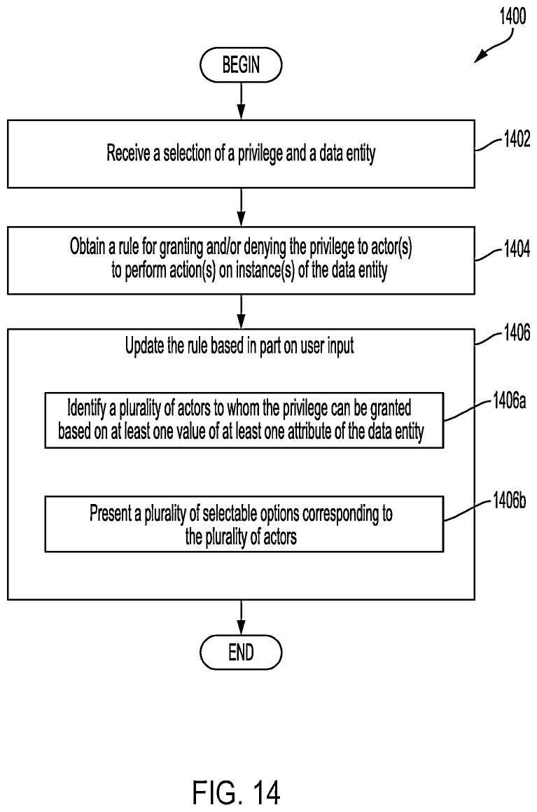

In some embodiments, the editor may facilitate or guide creating and/or editing privilege rules by prompting user input and constraining the ways in which one or more rule parameters may be specified when the user interacts with the data processing system. For example, in some embodiments, a user may wish to specify or edit a value for an attribute on which the rule depends, and the editor may provide the user with a list of selectable options corresponding to possible values for that attribute. In this manner, the user may be prevented from providing free-form input corresponding to the attribute values and other parameters such that potential technical malfunctions are avoided. This is described in more detail herein including with reference to FIG. 13. As another example, a user may wish to specify one or more actors who will be granted/denied privileges by a rule to perform an action on instance(s) of a particular data entity, and the editor may provide the user with a list of potential actors that may be selected by the user. The potential actors may comprise or consist of actors associated with one or more other data entities related to the particular data entity in question (e.g., one or more actors having a privilege to perform an action on instance(s) of a data entity related to the particular data entity in a hierarchy). This is described in more detail herein including with reference to FIG. 14. Constraining the parameters for a rule (e.g., attributes, attribute values, actors, etc.) that a user may specify and/or edit prevents the creation of a rule with a format that is not understood by the data processing system and/or that includes invalid values for rule parameters, either of which could result in technical malfunctions, such as run-time execution errors, of the data processing system.

As described above, the technology developed by the inventors enables users of a data processing system to author, test, and/or debug privilege rules associated with one or more data entities and/or instances of the data entities managed by the data processing system. In this respect, a key technical challenge is to identify the relevant privilege rules from among the many (e.g., hundreds, thousands, tens of thousands of) rules part of the data processing system configuration. Complicating this challenge is the fact that, for many privilege rules, the answer to the question of whether a privilege rule applies to a specific data entity or instance thereof depends on the internal state of the data processing system because the answer depends on the values of attributes of that data entity. Since the attribute values of a data entity may change (e.g., in the course of operation of the data processing system), it is generally not possible to determine whether a particular privilege rule applies to a specific data entity or instance thereof without accessing attribute values of that specific data entity in the data processing system (which may include accessing attribute values stored in multiple data entity instances of the data entity). As such, according to some aspects, the determination of which privilege rules apply to which data entities is performed dynamically based on a real-time determination of data entity attribute values stored in the data processing system.

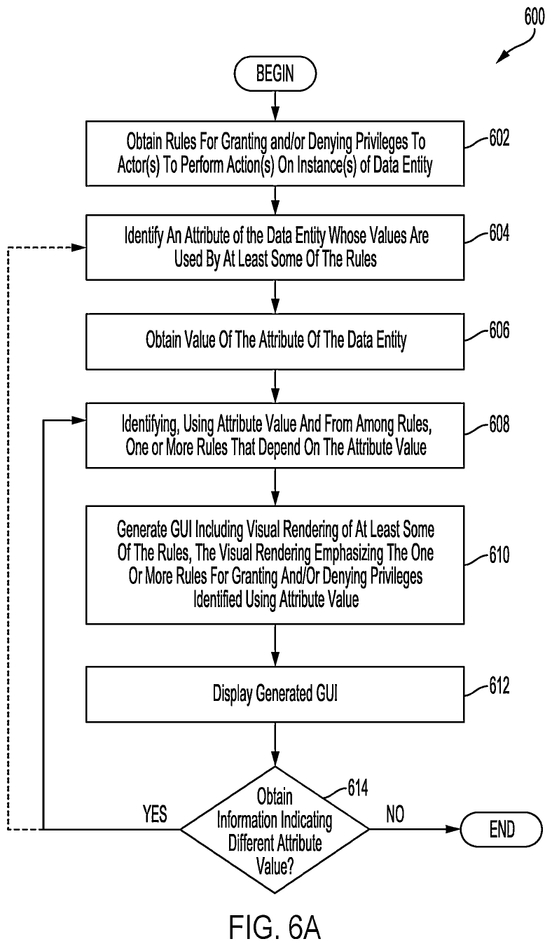

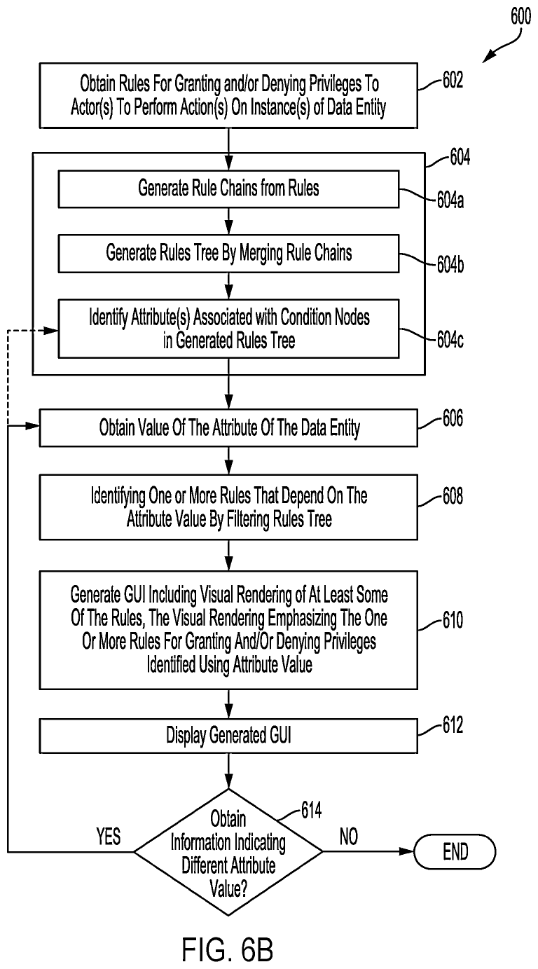

For example, in some embodiments, in order to identify one or more privilege rules for controlling access privileges for a data entity (e.g., for granting and/or denying privileges to actor(s) to perform action(s) on instance(s) of the data entity), a data processing system may: (1) identify, from among attributes of the data entity one or more attributes whose values are used by one or more privilege rules with which the data processing system is configured; (2) determine the value(s) for any such attribute(s) (e.g., by looking them up in a data processing system in “evaluator” mode or obtaining potential values interactively from user in “simulator” mode or both); and (3) identify the privilege rule(s) that depend on the determined attribute value(s). Aspects of this process for identifying relevant privilege rules are described herein including with reference to FIGS. 6A-8D.

According to some aspects, the data processing system may generate an internal representation of privilege rules that may be used to perform the above-described process for identifying relevant privilege rules. For example, the internal representation of privilege rules may be used to both: (1) identify attributes of the data entity whose values are used by one or more privilege rules; and (2) identify the privilege rule(s) that depend on the determined attribute value(s).

According to some aspects, the internal representation may be implemented using any suitable data structure(s) to represent a privilege rules tree. In some embodiments, the privilege rules tree may be generated from rule chains representing privilege rules, as described herein including with reference to FIG. 6B. In some embodiments, the privilege rules tree may include condition nodes, which may be used to identify attributes of a data entity whose values are used by one or more privilege rules. In some embodiments, the privilege rules tree may be filtered based on attribute values (e.g., values looked up in the data processing system and/or specified by a user) to identify one or more privilege rule(s) applicable to the data entity.

Some embodiments described herein address all of the above-described issues that the inventors have recognized with conventional techniques for managing privileges for data entities managed by a data processing system. However, not every embodiment described herein addresses every one of these issues, and some embodiments may not address any of them. As such, it should be appreciated that embodiments of the technology described herein are not limited to addressing all or any of the above-described issues of conventional techniques for managing privileges for data entities managed by a data processing system.

Accordingly, some embodiments provide for a method for managing access privileges (e.g., create, read, update, delete privileges) to data stored by a data processing system in instances of data entities, the method comprising: (1) obtaining a plurality of rules for granting and/or denying privileges to a first actor to perform at least one action on one or more instances of a first data entity of the data entities, wherein the first data entity comprises attributes; (2) identifying, from among the attributes of the first data entity, a first attribute whose values are used by one or more of the plurality of rules; (3) obtaining, from a user or from at least one data store, a first value of the first attribute; (4) identifying, using the first value of the first attribute and from among the plurality of rules for granting and/or denying privileges, a first rule that depends on the first value of the first attribute; (5) generating a graphical user interface (GUI) including a visual rendering of at least some of the plurality of rules, the visual rendering emphasizing the first rule for granting and/or denying privileges identified using the first value of the first attribute; and (6) displaying the generated GUI to the user.

In some embodiments, the first value of the first attribute of the data entity may be obtained from a data store (e.g., when using the technology in an “evaluator” mode).

In some embodiments, the first value of the first attribute of a data entity may be specified by a user (e.g., when using the technology in a “simulator” mode). The user may specify the value through a GUI. Accordingly, in some such embodiments, the GUI may include: (1) a first portion comprising at least one GUI element (e.g., a drop-down menu, a radio button, a check box, etc.) for specifying values of at least one of the attributes of the first data entity; and (2) a second portion comprising the visual rendering of the plurality of rules. The visual rendering may be updated in response to a user specifying different values for the first attribute. Examples of this are provided herein.

In some embodiments, the method further includes: obtaining a second value of the first attribute; identifying, using the second value of the first attribute and from among the plurality of rules for granting and/or denying privileges, a second rule that depends on the second value of the first attribute; and updating the visual rendering to emphasize the second rule for granting and/or denying privileges identified using the second value of the first attribute.

In some embodiments, the plurality of attributes includes a second attribute that can take values in a second set of values, and the method further comprises: in response to obtaining the first value of the first attribute, identifying, based on the first value, a subset of the second set of values for the second attribute; and updating the first portion of the GUI to allow the user to select a value for the second attribute only from among the subset of the second set of values.

In some embodiments, generating the visual rendering comprises generating text representing at least some of the plurality of rules, the text comprising text representing the first rule for granting and/or denying privileges identified using the first value of the first attribute. In some embodiments, generating the visual rendering comprises emphasizing, in the visual rendering, the text representing the first rule by highlighting, underlining, and/or changing font characteristics of at least some of the text representing the first rule. In some embodiments, generating the visual rendering comprises removing, from the visual rendering, at least some text corresponding to one or more rules different from the first rule.

In some embodiments, the GUI generated for allowing the user to input values of data entity attributes includes only those data entity attributes whose values are used by one or more rules controlling access privileges to one or more instances of the data entity. Accordingly, in some embodiments, identifying the first attribute whose values are used by one or more rules of the plurality of rules comprises: generating rule chains from at least some of the plurality of rules; generating a rules tree from the rule chains; identifying one or more attributes associated with one or more condition nodes in the rules tree, the one or more attributes including the first attribute, and generating, for each of the identified one or more attributes associated with the one or more condition nodes, a respective GUI element in the GUI to enable the user to provide input indicating a value for the first attribute.

In some embodiments, the at least one data store further stores metadata specifying relationships among the data entities, wherein the data entities are organized into one or more hierarchies, the metadata specifies the one or more hierarchies, and wherein the first value of the first attribute indicates a first hierarchy, of the one or more hierarchies, to which the first data entity belongs. In some embodiments, the first value of the first attribute indicates at least one classification for the first data entity.

In some embodiments, a data entity managed by a data processing system may include data and one or more attributes, each of which may be single-valued or multi-valued. In general, the data entity may be considered to represent data; the data entity includes fields and/or attributes, and the data in the data entity may be stored in the fields or attributes of the data entity. Data in a data entity may include content such as, for example, text, a data record, one or more alphanumeric values, and/or one or more references to other data entities. For example, a value of an attribute of a data entity may be a reference (e.g., or a pointer or any other suitable reference) to another data entity. As an example, the data entity may represent a transaction. As another example, a data entity may represent a file. As another example, a data entity may represent a document. In this example, the data in the data entity may include text in the document. As another example, a data entity may represent an issue to be resolved (e.g., a data error, a request to reset a password, a problem with a purchase order, invoice or other document). In this example, the data in the data entity may include text describing the issue. It will however be appreciated that the technology described herein is not limited to a particular type of data entity nor to the cognitive content of the information represented by the data entity. Instead, the technology is directed to the technical features that enable the processing of new and existing rules in a manner to prompt appropriate user input and interaction with the data processing system and reduce any possible technical malfunctions that might otherwise be introduced.

In some embodiments, a data entity may have one or multiple attributes. The values of the attributes may provide information about the data entity. For this reason, the attribute values may be considered to be metadata and/or data tags relating to the data entity. As one example, a data entity may have an attribute indicating its name and/or other identifier. As another example, a data entity may have a definition attribute specifying a semantic meaning of the data entity. As another example, the data entity may be part of one or more hierarchies of data entities and may have an attribute indicating the hierarchy or hierarchies to which the data entity belongs. As another example, a data entity may have one or more classification attributes including, by way of example and not limitation, a governance group classification attribute which may specify a list of one or more governance groups to which the data entity belongs, a sensitivity classification attribute which may indicate the sensitivity level of data in the data entity (e.g., “Internal”, “Public”, “Confidential”, “Highly Confidential”), and a personally identifiable information (“PIP”) classification attribute indicating a level of harm (e.g., “Level 1”, “Level 2”, etc.) that would result from improper use, access, and/or modification of the data in instance(s) of the data entity. As another example, a data entity may have an attribute specifying one or more actors authorized to perform one or more actions (e.g., create, read, access, update, delete) on instance(s) of the data entity. As another example, a data entity may have an attribute indicating valid values (via a range, a list) for another value associated with data entity. As another example, a data entity may have an attribute (e.g., a workflow attribute) specifying a set of workflow tasks related to the data entity, with each task in the set of tasks being performed by the data processing system either automatically of in response to input provided by one or more actors. In some embodiments, a workflow attribute may specify a workflow for changing a value of an attribute of the data entity. The tasks in such a workflow may include making a proposed change to the attribute value, submitting the proposed change for review, reviewing the proposed change, and approving or rejecting the proposed change. One or more actors may perform the workflow tasks resulting in different workflow states: start state, draft state, pending approval state, published state, and abandoned state. These examples of attributes and hierarchies are illustrative and non-limiting, and any of the examples may be combined with one or more of the other examples. Additional examples of attributes and hierarchies are provided herein and described in U.S. Patent Application Publication No.: 2020/0234242, titled “Finite State Machines for Implementing Workflows for Data Objects Managed by a Data Processing System,” which is incorporated by reference herein in its entirety.

In some embodiments, the rules may define data access privileges (for example, granting and/or denying privileges) for the data entities and may include privilege rules to control who can create, read, update, and delete (CRUD) data stored in instance(s) of data entities and/or particular attributes of the data entities. The data entities may be organized in a hierarchical manner with different types of accountable parties specified at any level. Some accountable parties may have special data access privileges while other accountable parties may have restricted access to data.

It should be appreciated that the techniques described herein may be implemented in any of numerous ways, as the techniques are not limited to any particular manner of implementation. Examples of details of implementation are provided herein solely for illustrative purposes. Furthermore, the techniques disclosed herein may be used individually or in any suitable combination, as aspects of the technology described herein are not limited to the use of any particular technique or combination of techniques.

As described above, the inventors have recognized that a data processing system may be configured to manage millions or billions of data entities and instances thereof. For example, the techniques described herein may be used, in some embodiments, for metadata management in an enterprise setting, whereby data entity instances store information about individual data sets (e.g., tables, transactions, documents, data records, etc.) stored across a globally distributed enterprise system comprising many databases, data warehouses, data lakes, etc. As described above, in this context, a data entity instance may store information about a corresponding dataset such as, for example, when the dataset was created, where it is stored, its size, the identity of the user(s) that are allowed to edit the dataset, information identifying which application programs use the dataset, information identifying the sensitivity level of the data, etc. Since a large organization (e.g., a financial institution such as a bank or credit card company, a utility such as a phone or electric company, etc.) will typically manage millions or billions of such datasets, there may be millions or billions of data entity instances storing information about such datasets that would be managed by the data processing system.

FIG. 1A is a diagram illustrating an example environment in which a data processing system 105 may be used, in accordance with some aspects of the technology described herein. The example of FIG. 1A is an implementation in which the data processing system 105 is used for metadata management. It should be appreciated that techniques described herein are not limited to being applied to any particular type of data and may be used within any data processing system using data entities and data entity instances to manage data irrespective of whether the managed data is metadata or any other type of data (e.g., transactions, files, data records, tables, etc.).

FIG. 1A illustrates an enterprise system comprising systems 160, 162, 164 distributed across multiple geographic locations (e.g., different cites, countries, continents, etc.). Each of the systems 160, 162, 164 may store vast amounts of data (e.g., in one or more database systems, data warehouses, data lakes, etc.). For example, the systems 160, 162, 164 may be components of an enterprise system of a global bank, with the system 160 being located in the United States, system 162 being located in Brazil, and system 164 being located in Europe.

As shown in the example embodiment of FIG. 1A, each of the systems 160, 162, 164 includes a respective set of computing devices. System 160 includes servers 160A, and databases 160B. System 162 includes servers 162A and databases 162B. System 164 includes servers 164A and databases 164B. During operation of the enterprise system, each of the systems 160, 162, 164 may generate and/or store large amounts of data (e.g., terabytes of data). For example, the enterprise system may be for a credit card company, where each of the systems 160, 162, 164 generates and/or stores transaction data, credit scores, and/or any other suitable data. In another example, the enterprise system may be for a bank, where each of the systems 160, 162, 164 generates and/or stores data about bank records, loans, account holders, and/or any other suitable data. In another example, the enterprise system may be for a phone company, where each of the systems 160, 162, 164 generates and/or stores data about phone calls, text messages, data usage, and/or any other suitable data.

In some embodiments, the database systems 160B, 162B, 164B may be configured to store data (e.g., of an enterprise system). Each of the database systems 160B, 162B, 164B may comprise a database, data warehouse, data lake, and/or any other database system. The database systems 160B, 162B, 164B may be of any suitable type(s), either the same type or different types. For example, each of these systems may include one or more relational database systems (e.g., ORACLE, SQL SERVER, etc.) As another example, in some embodiments, each of these systems may include one or more other types of database systems (e.g., non-relational (e.g., NoSQL) database system, a multi-file system, or any other suitable type of database system).

In the example embodiment of FIG. 1A, the data processing system 105 stores information 144 describing data stored in the systems 160, 162, 164. In this sense, the information 144 may be considered to be metadata. The metadata may include any of numerous types of information about the data stored in the enterprise systems 160, 162, 164. For example, the metadata may include information about systems that process data (e.g., servers 160A, 162A, 164A), software applications executing on the enterprise system that are used to process data, and/or rules for the applications in storing the data. In another example, the metadata may include information about data throughout the enterprise software system such as how the data were generated, the size of data, description of the data, which user(s) are permitted to read, update, create, delete or perform any other action with respect to the data, and/or any other suitable information about the data.

In some embodiments, the data processing system may be configured to manage the metadata using data entity instances and data entity definitions. For example, the information 144 stored by the data processing system 105 may include a data entity instance for each of multiple datasets (e.g., tables) stored by the enterprise system. Each such data entity instance may store information about the dataset (e.g., when the dataset was created or updated, where the dataset is stored, size of the dataset, the identity of the user(s) that are allowed to read, edit, delete, or perform any other suitable action with respect to the dataset, information identifying which software applications use the dataset, information identifying the sensitivity level of the data in the dataset, and/or any other suitable metadata). As another example, the information 144 stored by the data processing system 105 may include data entity instances for respective columns of tables in the enterprise system. Each such data entity instance may store information about the column (e.g., the meaning of the values in the column, who is authorized to read, write, update, and/or delete values in the column, the range of permitted values of entries in the column, and/or any other suitable metadata). As yet another example, information 144 stored by the data processing system 105 may include a data entity instance for each of multiple software applications configured to be executed by some system or device part of the enterprise system. Such a data entity instance may store information about the software application (e.g., which datasets the software application processes, where the application puts its output, a description of the application's functionality, the application's version, the application's dependency on data and/or other applications, where the executables of the application may be found, and/or any other suitable metadata). As yet another example, the information 144 stored by the data processing system 105 may include a data entity instance for each of multiple systems part of the enterprise system.

As can be readily appreciated from the foregoing, in such a metadata management scenario, the data processing system 105 may manage millions or billions of such data entity instances, which is why it is important that querying, creating, updating, deleting, or performing any other suitable actions with respect to the data entity instances be performed efficiently as possible.

In some embodiments, the data processing system 105 may be configured to obtain the information 144 about data from the various systems 160, 162, 164. For example, the data processing system 105 may query database 160B, 162B, 164B for metadata of the various systems 160, 162, 164. In some embodiments, the data processing system 105 may be configured to generate metadata using information obtained from the systems 160, 162, 164 (e.g., by querying database systems 160B, 162B, 164B for metadata). In some embodiments, the data processing system 105 may be configured to store metadata about data stored in the systems 160, 162, 164. For example, the systems 160, 162, 164 may each be a data lake, data warehouse, database system, or other type of system. The metadata may be stored in instances of data entities, as described herein.

As shown in FIG. 1A, one or more users 102, 104, 106 may access the information 107 about the data in the enterprise systems by interacting with the data processing system 105. User(s) 102, 104, 106 may interact with the data processing system 105 using one or more computing devices through one or more interfaces (e.g., user interface(s)) provided by the data processing system 105). Example interfaces through which a user, such as an administrator 104, may interact with the data processing system 105 are described herein with reference to FIGS. 1G-1H, FIGS. 3A-3C, FIG. 4A-4D, FIGS. 11A-11E, and FIGS. 12A-12E.

FIG. 1B is a diagram illustrating an example implementation of the data processing system 105 of FIG. 1A, in accordance with some aspects of the technology described herein. As shown in FIG. 1B, the data processing system 105 includes interfaces 110, a privileges management system 130, and a data persistence layer 150.

Interfaces 110 may be configured to include user interfaces through which user(s) 102, 104, 106 may access information from the data processing system 105 (e.g., using computing device(s)). The interfaces 110 may be configured to generate graphical user interfaces (GUIs) through which users may access data from the information 144 about data stored in systems 160, 162, 164. The GUIs may allow the users to: (1) request information about data entity instances stored by the data processing system; (2) view information about data entity instances stored by the data processing system; (3) visualize privilege rules to understand the internal state of the data processing system and which privilege rules apply to a particular actor, data entity, and/or data entity instance; and (4) author, test, and/or debug the privilege rules.

According to some aspects, the GUIs may allow users to access information 144 (e.g., metadata) stored about data stored by systems 160, 162, 164. For example, the GUIs may allow user(s) 102, 104, 106 to track data being generated in an enterprise system (e.g., quality metrics, and other characteristics of the data). In another example, the GUIs may allow the user(s) 102, 104, 106 to visualize information describing components of a process flow including: input data, a description of a process performed on the input data, and output data. In another example, the interfaces 110 may include scripting interfaces through which scripts may be received for execution by the data processing system 105. In another example, the interfaces 110 may include graph-based computer programs(s) 116, third party application(s), and/or other interfaces.

In the context of metadata management, in some embodiments, the interfaces 110 may be configured to generate graphical user interfaces (GUIs) through which users may access data from the information 144 about data stored in systems 160, 162, 164. The GUIs may allow the users to: (1) request information about data entity instances stored by the data processing system; and (2) view information about data entity instances stored by the data processing system. In some embodiments, the GUIs may allow users to access information 144 (e.g., metadata) stored about data stored by systems 160, 162, 164. For example, the GUIs may allow user(s) 102, 104 to track data being generated in an enterprise software system (e.g., quality metrics, and other characteristics of the data). In another example, the GUIs may allow user(s) 102, 104 to visualize lineage information. Lineage information may include information about relationships between different data entity instances. Aspects of lineage information are described in U.S. Pat. No. 10,489,384, entitled “SYSTEMS AND METHODS FOR DETERMINING RELATIONSHIPS AMONG DATA ELEMENTS”, which is incorporated herein by reference in its entirety.

Privileges management system (PMS) 130 may be configured to perform various functions related to managing access privileges (e.g., create, read, write, and/or update privileges) to data stored by the data processing system 105 (e.g., in instances 144 of data entities). The data processing system 105 may be configured to manage thousands, millions, billions, or even trillions of data entity instances. In turn, the PMS 130 may be configured to manage access privileges for any suitable number of data entity instances as appropriate. The PMS 130 may be configured to manage access privileges to the instances of the data entities for one or more of users 102, 104, 106. PMS 130 may include a privilege(s) control module 115 configured to control, for a particular user among users 102, 104, 106, whether that user has privileges to perform create, read, write, and/or update actions on instances of data entities managed by the data processing system 105.

Data persistence layer 150 may be configured to store information about data entities and instances thereof. The information may include information defining data entities, instances of the data entities, and relations among the data entities and instances thereof. The data persistence layer 150 may provide a central repository for all metadata of a system (e.g., an enterprise system). For example, the data persistence layer 150 may store the information about data stored in databases 160B, 162B, and 164B in the form of data entity instances 144. For example, each of the databases 160B, 162B, 164B may be a data lake, data warehouse, database system, or other type of datastore. The data persistence layer 150 may be configured to store rules 146 for controlling access privileges to at least some of the data entity instances 144.

Table 166 shown in FIG. 1C illustrates example data stored in a database such as database 164B. Table 166 stores a set of information about customers (e.g., of a bank). The columns of the table 166 include “Identifier”, “Name”, “Credit Score”, and “Date of Score”. The data persistence layer 150 stores a “Data Set” data entity instance 156 that stores metadata about the data of table 166. The data entity instance 156 stores values of attributes including a “Type” of the data entity instance 156, a “Business Manager”, “No. Entries”, “Private”, “Storage Size”, and “Data ID”. In some embodiments, the “Data Set” data entity instance 156 may store values of other attributes in addition to or instead of those shown in FIG. 1C.

In applications where a data entity instance contains metadata about data (e.g., information about a table), the data entity instance may include information that can be used to identify and/or access the data. As shown in the example of FIG. 1C, the “Data ID” attribute identifies data (e.g., a table) that the information in the “Data Set” data entity instance 156 describes. For example, the value of “Data ID” may be an identifier of the table 166. In some embodiments, the value of “Data ID” may allow a user to navigate to the table 166. For example, the value of “Data ID” may be a hyperlink that navigates to the table 166 in database 164B. In some embodiments, the data entity instance may not itself store information about the data, though the data processing system may store information associating a data entity instance with information that can be used to identify and/or access the data itself. For example, the data processing system may store such information in one or more tables (e.g., within data persistence layer 150) or in any other suitable way.

As shown in the example of FIG. 1C, the data persistence layer 150 further stores a “Credit Score” data entity instance 158. The “Credit Score” data entity instance 158 may be an instance of a “BizTerm” data entity. The “Credit Score” data entity instance 158 includes values for the attributes “Type”, “Description”, “Business Owner”, “Valid Lower Limit”, “Valid Upper Limit”, “Private”, and “Data ID”. As indicated by the arrow between the “Data ID” attribute and the “Credit Score” column of table 166, the “Credit Score” data entity instance 158 describes data in the “Credit Score” column of table 166. As shown in the example of FIG. 1C, the “Data ID” attribute indicates data that the information in the “Credit Score” data entity instance 158 describes. For example, the value of “Data ID” may be an identifier of the “Credit Score” column in table 166. In some embodiments, the value of “Data ID” may allow a user to navigate to the “Credit Score” column of table 166. For example, the value of “Data ID” may be a hyperlink that provides information from the “Credit Score” column to a user.

The data entity instance 158 has values for the respective attributes of the data entity “BizTerm”. For example, the data entity instance 158 has a value of “Business Term” for the “Type” attribute, a value of “Bob Owen” for the “Business Owner” attribute, a value of “800” for the “Valid Upper Limit” attribute, a value of “300” for the “Valid Lower Limit” attribute, and a value of “Yes” for the “Private” attribute. As indicated by the dots, the data entity instance 158 may have values for other attributes not shown in FIG. 1C.

As shown in the example of FIG. 1C, the data persistence layer 150 stores a privilege rule 162. Privilege rule 162 controls access privileges to the “Credit Score” data entity instance 158. The “Credit Score” data entity instance 158 may be an instance of a “BizTerm” data entity and privilege rule 162 may depend on values of one or more attributes specified by the “BizTerm” data entity. For example, privilege rule 162 depends on the value for the “Private” attribute in the data entity instance 158. Privilege rule 162 may also depend on attributes of an actor requesting access privileges (e.g., to create, read, update, and/or delete) to the data entity instance 158. Attributes of an actor may include a role of an actor in an enterprise, a group that the actor belong to, and/or other attributes.

Privilege rule 162 indicates conditions under which access privileges to perform at least one action (e.g., an “Update” Action) on the data entity instance 158 are granted and/or denied to at least one actor (e.g., Actor A). For example, privilege rule 162 indicates that Actor A is granted access privileges to perform an “Update” action on data entity instance 158 when the value of the “Private” attribute is “Yes”, and Actor A has an “Executive” role.

Privileges control module 115 may be configured to grant or deny access to one or more actors using access privilege rules 146. As described herein, one or more access privilege rules 146 for controlling access privileges to a data entity instance, may depend on values of attributes specified by the data entity (and/or other data entities related to the data entity). The privileges control module 115 may be configured to access any such attribute values (e.g., from data entity instances 144 in data persistence layer 150) and evaluate the rule(s) using the accessed values.

FIGS. 1D and 1E illustrates scenarios where privileges control module 115 may, using privilege rule 162, determine whether an actor requesting access to the data entity instance 158 is granted or denied access to the data entity instance. Privilege rule 162 depends on values of the “Private” attribute in the data entity instance and a role of the actor requesting access. Privilege rule 162 specifies one or more conditions for granting or denying access to an actor requesting access. In particular, privilege rule 162 indicates that an actor requesting access to the data entity instance (e.g., to perform a particular action on the data entity instance) is granted such access when the value of the “Private” attribute in the data entity instance is “Yes” and the actor requesting access has an “Executive” role.

As shown in FIG. 1D, when an actor 102 with an “Executive” role requests access to the data entity instance 158, the privileges control module 115 grants access to actor 102 because the conditions specified by the privilege rule 162 are met. On the other hand, as shown in FIG. 1E, when an actor 106 with an “Importer” role requests access to the data entity instance 158, the privileges control module 115 denies access to actor 106 because the conditions specified by the privilege rule 162 are not met.

FIG. 1F is a diagram illustrating example data stored in the data persistence layer 150 of the data processing system 105. As shown in the example of FIG. 1F, the data persistence layer 150 may store large numbers (e.g., thousands, millions, billions) of data entity instances 144 storing information about respective components of the enterprise system of FIG. 1A (e.g., datasets, software application, systems or any other component of the enterprise system). A component may be a dataset, an application (e.g., one or more computer programs), a system (e.g., a database system), and/or other component of the enterprise system. For example, a data entity instance may store information about data (e.g., a table) in the enterprise system. In another example, a data entity instance may store information about an application of the enterprise system. In yet another example, a data entity instance may store information about users of the enterprise system. As shown in FIG. 1F, the data persistence layer 150 stores the data entity instances 156, 158 described herein with reference to FIG. 1C.

Data persistence layer 150 may be configured to support tens, hundreds, thousands or tens of thousands of data entities. And, in an enterprise system environment, the data persistence layer 150 may be configured to store thousands, millions or billions of data entity instances 144. For example, the data persistence layer 150 may store at least 10,000 data entity instances, at least 50,000 data entity instances, at least 100,000 data entity instances, at least 500,000 data entity instances, at least 1,000,000 data entity instances, at least 5 million data entity instances, at least ten million data entity instances, at least 50 million data entity instances, at least 100 million data entity instances, at least 500 million data entity instances, at least one billion data entity instances, at least 5 billion data entity instances, between 100,000 and 5 million data entity instances, between 1 and 500 million data, between one million and 5 billion data entity instances, or any other range within these ranges.

Data persistence layer 150 may store large numbers (e.g., hundreds, thousands) of privilege rules 146 for controlling access to one or more data entity instances 144. A privilege rule may depend on the internal state of the data processing system, such as information stored in the data entity instances 144 (e.g., attribute values in the data entity instances) and information about actors in the enterprise who may request access to the data entity instances (e.g., roles, groups they belong to, etc.). Such dependencies increase the difficulty of making determinations regarding how the privilege rules 146 would be applied in practice or how to author, debug, and/or edit these rules.

Privilege management system 130 may be configured to not only automatically identify relevant privilege rules from among many potentially applicable rules but also generate graphical user interfaces to provide intuitive visualizations of the internal state of the data processing system and the CRUD operating mode, for given actors and data entity instances 144, that are controlled by the identified privilege rules based on any relevant variables. The graphical user interfaces allow for efficient evaluation of how these rules would be applied in practice based on the values of variables (e.g., the values stored in the data processing system) that the rules depend on. Additionally, the graphical user interfaces guide users through the process of creating and/or editing the rules by providing the user with various suggestions for values of one or multiple variables associated with the data entities/data entity instances. Accordingly, these visualizations allow users of the data processing system to author, test, and debug the rules efficiently and without introducing run-time and/or privilege errors during operation of the data processing system.

As shown in the example of FIG. 1F, the data stored by the data persistence layer 150 may be used to provide visualizations in graphical user interfaces (GUIs) provided on device(s) to user(s) 102, 104, 106. The interfaces 110 of the data processing system 105 may be configured to provide information about data entity instances and rules stored by the data processing system 105. For example, the user may wish to access the value(s) of one or more attributes of a data entity and/or instance(s) of the data entity. In another example, the user may wish to access values of multiple attributes of multiple data entities and/or instance(s) of the data entities. In yet another example, a user may wish to evaluate the rules for a particular data entity to understand why certain privileges are granted or not granted for the data entity and/or instance(s) of the data entity. In another example, the user may wish to view lineage information. Lineage information may include information about relationships between different data entity instances. Aspects of lineage information are described in U.S. Pat. No. 10,489,384, entitled “SYSTEMS AND METHODS FOR DETERMINING RELATIONSHIPS AMONG DATA ELEMENTS”, which is incorporated herein by reference in its entirety.

FIG. 1G depicts a diagram illustrating a scenario where an actor 102 with a particular role (e.g., executive role) is prevented from accessing data (e.g., in one or more instances of data entities) in data processing system 105. For example, an actor 102 is prevented from performing an “Update” action on the “Credit Score” data entity instance 158. In this scenario, actor 102 may contact an administrator 104 to inquire about the reason for denied access. The data processing system 105 may include a privileges management system 130 that may be configured to control data access privileges for data entities (e.g., granting and/or denying privileges to actor(s) to perform action(s) on instances 144 of the data entities). As mentioned above, a large number of rules 146 for controlling data access privileges may exist in the data processing system 105 and the applicability of each of these privilege rules may depend on information associated with the actors (e.g., roles of actors in an enterprise) and the data entity instances (e.g., attribute values in the instances of the data entities). The volume of privilege rules in the system, the format in which they are stored (e.g., spreadsheet format), and their dependency on other information, makes it very difficult for the administrator 104 to identify privilege rules applicable to the actor 102 requesting access and the portion of data to which access is requested. For example, in order to identify an applicable privilege rule, the administrator 104 would have to manually examine each and every privilege rule (among e.g., hundreds, thousands, tens of thousands of rules) in the system. Complicating this challenge is the fact that, for many rules, the answer to the question of whether a privilege rule applies to a specific data entity depends on the internal state of the data processing system because the answer depends on the values of attributes of that data entity. Therefore, the administrator 104 would have to individually look up the values of attributes of the data entity across various data entity instances to determine whether or not each particular rule is triggered.

FIGS. 1H-1I are diagrams illustrating the scenario of FIG. 1G where actor 102 is prevented from performing an “Update” action on the “Credit Score” data entity instance 158. However, in FIGS. 1H-1I, the data processing system 105 enables the administrator 104 to, using the techniques described herein, utilize graphical user interfaces (e.g., graphical user interface 180) that provide intuitive visualizations of the internal state of the data processing system and the CRUD operating mode for actor 102 requesting access in order to identify relevant privilege rules from among many potentially applicable rules. As shown in FIG. 1H, a relevant privilege rule 188 for controlling access to the “Credit Score” data entity instance 158 is identified by the data processing system 105 and a visualization of this identified rule is presented to the administrator 104 via graphical user interface 180.

As shown in FIG. 1H, GUI 180 includes a first portion 182 and a second portion 184. The first portion 182 includes a GUI element 186 for selecting a value of the “Private” attribute. The user may select a value from among two values (Yes, No) displayed via the GUI element 186 for the “Private” attribute. The second portion 184 of GUI 180 includes a visual rendering of privilege rule 188 for granting and/or denying privileges to an actor requesting access to perform at least one action (e.g., an “Update” action) on the “Credit Score” data entity instance. The privilege rule 188 depends on a value of the “Private” attribute. The privilege rule 188 indicates that an actor with an executive role may be granted privilege for performing an “Update” action on the “Credit Score” data entity instance if a value of the “Private” attribute is “Yes”.

Selection of a particular value for the “Private” attribute via GUI element 186 may cause the visual rendering of the rules in the second portion 184 to be updated as depicted in FIG. 1I. The visual rendering may be updated by emphasizing the visual rendering of the privilege rule 188 that depends on the selected value of the “Private” attribute. At least part of the text representing the privilege rule 188 may be emphasized by highlighting. The highlighted portion associated with the privilege rule 188 indicates that Actor A with an executive role may be granted privileges to performing an “Update” action on “Credit Score” data entity instance if a value of the “Private” attribute is “Yes” (e.g., as indicated by selection of “Yes” for the “Private” attribute in the first portion 182).

By interacting with the graphical user interface 180, the administrator 104 can readily evaluate any identified rules to address situations where otherwise authorized users (e.g., an executive) are prevented from accessing data stored in instances of data entities managed by the data processing system 105. For example, using the techniques described herein, the administrator 104 can remedy the “denied access” situation in FIG. 1G such that the executive is granted access to perform the “Update” action on the “Credit Score” data entity instance.

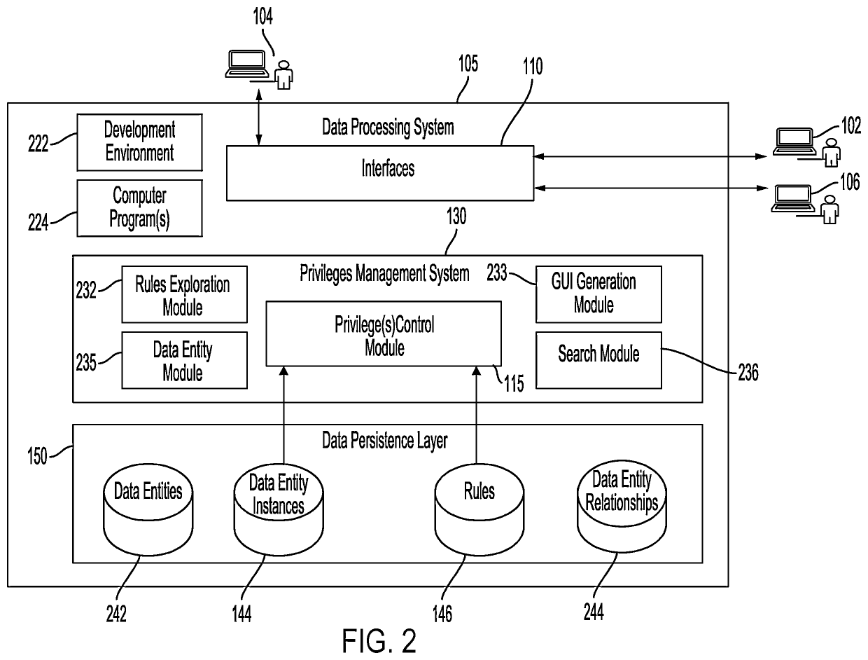

FIG. 2 is a block diagram of an illustrative data processing system 105 and a privileges management system 130 part of the data processing system 120, in accordance with some aspects of the technology described herein. As shown in FIG. 2, data processing system 105 includes a privileges management system (PMS) 130 and data persistence layer 150. In turn, the privileges management system 130 includes, among other components: (1) rules exploration module 232; (2) GUI generation module 233; (3) privilege(s) control module 115; (4) data entity module 235; and (5) search module 236. Data persistence layer 150 provides access to data entities 242, metadata 244 related to (e.g., associated with) the data entities 242, instances 144 of the data entities 242, and rules 146 for controlling access privileges to at least some of the data entity instances 144.

Privileges management system 130 is configured to perform various functions related to controlling access (e.g., create, read, write, and/or update privileges) to the data entities 242 and/or instances 144 of the data entities. The data processing system 105, in some embodiments, may be configured to manage thousands, millions, billions, or even trillions of data entities. In turn, the PMS 130 may be configured to manage access privileges for any suitable number of instances of these data entities as appropriate. The PMS 130 may be configured to control access privileges to the instances of the data entities for one or more of actors 102, 104, 106. For example, PMS 130 may be configured to control, for a particular actor among actors 102, 104, 106, whether that actor has privileges to perform create, read, write, and/or update actions on instances of data entities managed by data processing system 105.

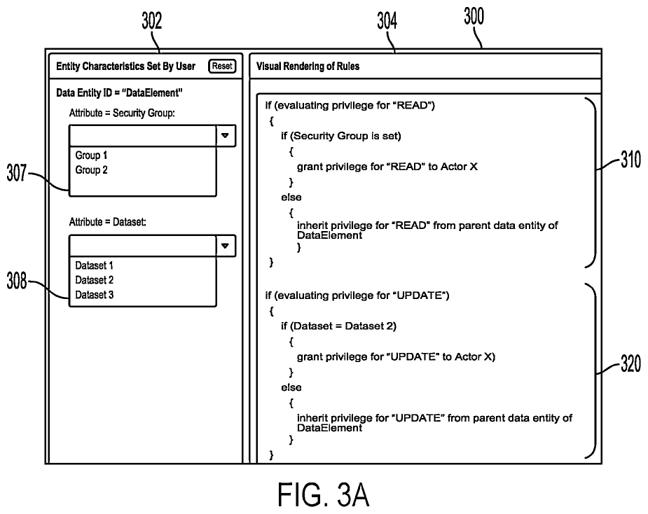

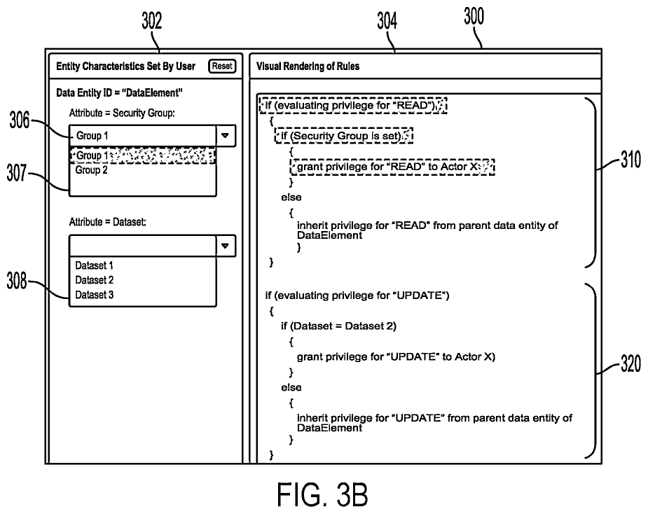

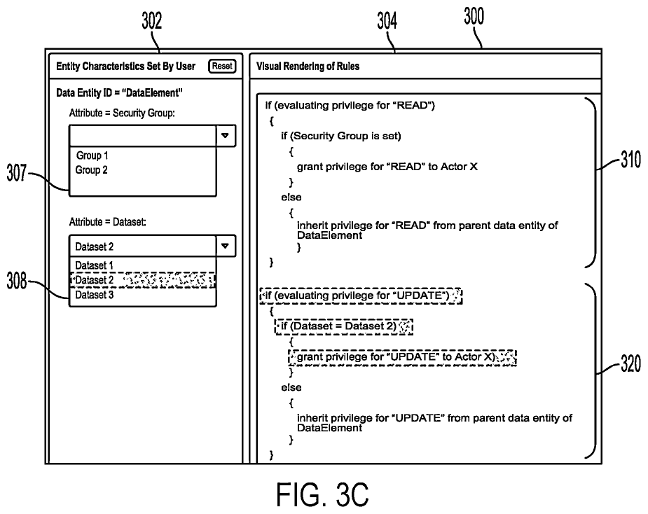

According to some aspects, rules exploration module 232 allows a user, such as administrator 104 to explore, create, and/or modify rules for controlling access privileges to data entities managed by the data processing system 105. Such rules may control whether actor(s) have privileges to perform certain action(s) on instance(s) of the data entities. In some embodiments, rules exploration module 232 may be configured to identify, for a particular data entity (or entities), one or more rule(s) relevant for controlling access privileges for the particular data entity (or entities), from among the many rules (e.g., rules 146) for controlling access privileges to data entities managed by data processing system 120. The identified rules may be then provided to GUI generation module 233, which may generate one or more graphical user interfaces through which users can explore, create, and/or modify rules. Examples of such graphical user interfaces are provided herein including in FIGS. 3A-3C, 4A-4D, and 5. It will be appreciated that the user may be any other user, such as a non-technical user of the data processing system.

According to some aspects, rules exploration module 232 may be configured to assist the user in creating and/or editing the one or more rules by automatically determining and presenting the user with selectable options for various attributes and/or values of attributes associated with the data entities via graphical user interfaces. Examples of such graphical user interfaces are provided herein including in FIGS. 11A-11E and FIGS. 12A-12E.

According to some aspects, privileges control module 115 may be configured to grant or deny access to one or more actors using access privilege rules 146. As described herein, one or more access privilege rules 146 for controlling access privileges, may depend on values of attributes of the data entity (and/or other data entities related to the data entity). In some such embodiments, the privileges control module 115 may be configured to access any such attribute values (e.g., in data entity instances 144 in data persistence layer 150) and evaluate the rule(s) using the accessed values.

According to some aspects, data entity module 235 may be configured to manage data entities 242. For example, the data entity module 235 may be configured to access, modify, and/or store data entities 242 and any associated information. For example, the data entity module 235 may be used to access values of attributes of data entities stored in data entity instances 144 in data persistence layer 150. As another example, the data entity module 235 may be used to access metadata 244 specifying relationships among data entities (e.g., information specifying the structure of a hierarchy of data entities).

According to some aspects, search module 236 may provide a programmatic interface (e.g., an API) and/or a user interface (e.g., a GUI) for searching for data entities among data entities 242 in data persistence layer 150. In some embodiments, the search module 236 may utilize search index to perform a search. In some embodiments, the search module 236 may update and/or recalculate the search index to optimize future searches (e.g., in response to the addition of new data entities, deletion of data entities, and/or modification of data entities in the data persistence layer 150).

According to some aspects, to avoid synchronization issues that occur in conventional data processing systems, the PMS 130 may be the only system through which changes to access privileges for data entities 242 or instances 144 of data entities 242 may be made. Accordingly, in some embodiments, changes to rules for controlling access privileges to at least some of the data entities 242 or instances 144 of data entities 242 may be made only via the PMS 130.

In the illustrated example of FIG. 2, the PMS 130 has access to any data stored in the data persistence layer 150. For example, the PMS 130 may have access (e.g., direct access) to the memory or memories in which the data in the data persistence layer 150 are stored.

For example, the PMS 130 has access to the data entities 242 persisted in data persistence layer 150. For example, privileges management system 130 has access to any data stored within any of the data entities 242 including, by way of example, current value(s) of any attribute of any one of data entities 242 across one or more instances 144 of the data entities 242. Examples of data entity attributes are provided herein and include, but are not limited to, attributes whose values, for particular data entities, identify one or more groups (e.g., hierarchies of data entities, groups of entities having a same classification, or any other suitable groups of data entities) to which the particular data entity belongs.

As another example, the PMS 130 has access to metadata 244 related to the data entities 242. In some embodiments, the PMS 130 has access to metadata specifying relationships among at least some of the data entities 242. For example, in some embodiments, at least some of the data entities 242 may be organized into one or more hierarchies, and the PMS 130 may access metadata specifying the one or more hierarchies. In this way, the PMS 130 may identify, for a particular data entity, one or more other data entities related to the particular data entity according to a hierarchy. For example, the PMS 130 may identify, for a particular data entity, one or more of its ancestors (e.g., parent data entities(s), grandparent data entities(s), etc.), one or more of its descendants (e.g., one or more child or grandchild data entities), and/or one or more of its sibling data entities (e.g., data entities sharing at least one common ancestor with the particular data entity) in the hierarchy.

As shown in FIG. 2, data persistence layer 150 stores data entities 242. The data persistence layer 150 may store any data of data entities 242 including, but not limited to, values of attributes of data entities 242 in instances 144 of the data entities 242. The data persistence layer 150 may comprise one or multiple data stores configured to store the data entities 242, the data entity instances 144, the rules 146 and the data entity relationships 244. Each data store may include one or multiple storage devices storing data in one or more formats of any suitable type. For example, the storage device(s) part of a data store may store data using one or more database tables, spreadsheet files, flat text files, and/or files in any other suitable format (e.g., a native format of a mainframe). The storage device(s) may be of any suitable type and may include one or more servers, one or more database systems, one or more portable storage devices, one or more non-volatile storage devices, one or more volatile storage devices, and/or any other device(s) configured to store data electronically. In embodiments where a data store includes multiple storage devices, the storage devices may be co-located in one physical location (e.g., in one building) or distributed across multiple physical locations (e.g., in multiple buildings, in different cities, states, or countries). The storage devices may be configured to communicate with one another using one or more networks of any suitable type, as aspects of the technology described herein are not limited in this respect.

According to some aspects, data persistence layer 140 may store additional types of data including, but not limited to, metadata specifying relationships among the data entities 242 and information for facilitating searching among the data entities 242 (e.g., a search index maintained for the data entities 242). For example, as shown in FIG. 2, data persistence layer 150 further includes metadata 244 specifying relationships among data entities 242.

According to some aspects, metadata 244 may specify one or more hierarchies of data entities (in data entities 242). The hierarchies may be specified in any suitable way and using any suitable data structure(s), for example using one or more tree data structures, pointers, or in any other suitable way, as aspects of the technology described herein are not limited in this respect. In some embodiments, metadata 244 may specify one or more groups of entities, explicitly or implicitly.

Although shown as part of data processing system 120 in the example of FIG. 2, in some embodiments, data persistence layer 150 may be external to the data processing system 105.

As shown in FIG. 2, data processing system 105 includes one or multiple computer programs 224 configured to operate on data in data persistence layer 150. The computer programs 224 may be of any suitable type and written in any suitable programming language(s). For example, computer programs 224 may include one or more computer programs written at least in part using the structured query language (SQL) and configured to access data in one or more data stores part of data persistence layer 150. As another example, data processing system 105 may be configured to execute programs in the form of graphs and computer programs 224 may comprise one or more computer programs developed as dataflow graphs. A dataflow graph may include components, termed “nodes” or “vertices,” representing data processing operations to be performed on input data and links between the components representing flows of data. Techniques for executing computations encoded by dataflow graphs are described in U.S. Pat. No. 5,966,072, titled “Executing Computations Expressed as Graphs,” which is incorporated by reference herein in its entirety.

In the illustrated example of FIG. 2, data processing system 105 further includes development environment 222 that may be used by a person (e.g., software developer) to develop one or more of computer programs 224 for operating on data in data persistence layer 150. An environment for developing computer programs as data flow graphs is described in U.S. Pat. Pub. No.: 2007/0011668, titled “Managing Parameters for Graph-Based Applications,” which is incorporated by reference herein in its entirety.

According to some aspects, one or more of computer programs 224 may be configured to perform any suitable operations on data in data persistence layer 150. For example, one or more of computer programs 224 may be configured to access data from one or more sources, transform the accessed data (e.g., by changing data values, filtering data records, changing data formats, sorting the data, combining data from multiple sources, splitting data into multiple portions, and/or in any other suitable way), calculate one or more new values from accessed data, and/or write the data to one or multiple destinations.

FIG. 3A is an illustrative diagram of an example GUI 300 through which a user may visualize one or more rules for granting and/or denying privileges to one or more actors to perform one or more actions on one or mor instances of a data entity “DataElement” having at least two attributes “Security Group” and “Dataset”. GUI 300 includes a first portion 302 and a second portion 304. The first portion 302 includes a GUI element 307 for selecting a value of attribute “Security Group” of the data entity ‘DataElement” and a GUI element 308 for selecting a value of attribute “Dataset” of the data entity “DataElement”. According to some aspects, a user may select a value from among the two values (Group 1, Group 2) displayed via the GUI element 307 for attribute “Security Group” and a value from among the three values (Dataset 1, Dataset 2, Dataset 3) displayed via the GUI element 308 for attribute “Dataset”. As can be seen in FIG. 3A, none of the values for attributes “Security Group” and “Dataset” are selected. According to some aspects, GUI elements 307, 308 include drop-down menus, but other GUI elements, such as, radio buttons, check boxes, etc., may be used without departing from the scope of this disclosure.

The second portion 304 of GUI 300 includes a visual rendering of one or more rules for granting and/or denying privileges to at least one actor to perform at least one action on one or more instances of the data entity “DataElement”. The visual rendering in the second portion 304 includes a visual rendering of a first rule 310 including text representing the first rule for granting and/or denying privileges to an actor (e.g., Actor X) to perform a “READ” action on one or more instances of the data entity “DataElement”. The first rule 310 depends on a value of attribute “Security Group” of the data entity “DataElement”. The first rule 310 indicates that Actor X may be granted privilege for performing a “READ” action on one or more instances of the data entity “DataElement” if a value of attribute “Security Group” is set. If the value of attribute “Security Group” is not set, the privilege for performing a “READ” action on one or more instances of the data entity “DataElement” is inherited from a parent data entity of data entity “DataElement”. The visual rendering in the second portion 304 also includes a visual rendering of a second rule 320 including text representing the second rule for granting and/or denying privileges to an actor (e.g., Actor X) to perform an “UPDATE” action on one or more instances of the data entity “DataElement”. The second rule 320 depends on a value of attribute “Dataset” of the data entity “DataElement”. The second rule 320 indicates that Actor X may be granted privilege for performing an “UPDATE” action on one or more instances of the data entity “DataElement” if a value of attribute “Dataset” is set to “Dataset 2”. If the value of attribute “Dataset” is not set to “Dataset 2”, the privilege for performing an “UPDATE” action on one or more instances of the data entity “DataElement” is inherited from a parent data entity of data entity “DataElement”.

It will be appreciated that while FIG. 3A depicts the second portion 304 of GUI including a visual rendering of two rules, one associated with attribute “Security Group” and the other associated with attribute “Dataset”, the second portion 304 may include a visual rendering of a number of rules associated with various attributes of data entity “DataElement”, without departing from the scope of this disclosure.

In some embodiments, the selectable values presented for attribute “Dataset” may depend on the value selected or otherwise obtained for attribute “Security Group”. In response to obtaining a particular value for attribute “Security Group”, a subset of a set of values that the attribute “Dataset” can take may be identified and the first portion 302 of the GUI 300 may be updated to allow a user to select a value for attribute “Dataset” only from among the subset of the set of values.

In some embodiments, selection of a particular value shown in FIG. 3A associated with attributes “Security Group” and/or “Dataset” in the first portion 302 of the GUI 300 may cause the visual rendering of the rules in the second portion 304 to be updated, as shown in FIGS. 3B and 3C.

FIG. 3B is an illustrative diagram of the example GUI 300 showing how a visual rendering of at least some of the rule(s) of FIG. 3A may be updated in response to obtaining, through the first portion 302 of the GUI 200, input from a user indicating a value of the attribute “Security Group” of the data entity “DataElement”. As shown in FIG. 3B, selection of a value 306 (e.g., Group 1) of attribute “Security group” via GUI element 307 in the first portion 302 of the GUI 300 causes the visual rendering of the rules in second portion 304 of the GUI 300 to be updated. The visual rendering may be updated by emphasizing the visual rendering of the first rule 310 that depends on the selected value of attribute “Security Group”. FIG. 3B illustrates at least part of the text representing the first rule 310 being emphasized by highlighting. The highlighted portion associated with the first rule 310 indicates that Actor X may be granted a privilege for performing a “READ” action on one or more instances of the data entity “DataElement” if a value of attribute “Security Group” is set (e.g., as indicated by selection of Group 1 for attribute “Security Group” in the first portion 302).

FIG. 3C is an illustrative diagram of the example GUI 300 showing how a visual rendering of at least some of the rule(s) of FIG. 3A may be updated in response to obtaining, through the first portion 302 of the GUI 300, input from a user indicating a value of the attribute “Dataset” of the data entity “DataElement”. As shown in FIG. 3C, selection of a value (e.g., Dataset 2) of attribute “Dataset” via GUI element 308 in the first portion 302 of the GUI 300 causes the visual rendering of the rules in second portion 304 of the GUI 300 to be updated. The visual rendering may be updated by emphasizing the visual rendering of the second rule 320 that depends on the selected value of attribute “Dataset”. FIG. 3C illustrates at least part of the text representing the second rule 320 being emphasized by highlighting. The highlighted portion associated with the second rule 320 indicates that Actor X may be granted a privilege for performing an “UPDATE” action on one or more instances of the data entity “DataElement” if a value of attribute “Dataset” is set to “Dataset 2” (e.g., as indicated by selection of Dataset 2 for attribute “Dataset” in the first portion 302).

Although FIGS. 3B and 3C illustrate emphasizing visual rendering of rule(s) by highlighting, other ways of emphasizing can be used without departing from the scope of this disclosure. For example, the visual rendering of the rule(s) in the second portion 304 of the GUI 300 may be emphasized by underlining, and/or changing font characteristics (e.g., font type, font size, font weight, font width, and/or other font characteristics) of at least some of the text representing the rule(s). In some embodiments, the visual rendering of the rule(s) in the second portion 304 of the GUI 300 may be emphasized by removing, from the visual rendering, at least some text corresponding to one or more rules different from the rule(s) that depend on the selected values of attributes in the first portion 302 of the GUI 300 (i.e. rules that do not depend on the selected values of attributes). Furthermore, it will be appreciated that the contribution of this embodiment can be applied to data entities having any number of attributes and corresponding possible values and that this contribution is not limited to the particular example described where the data entity has two attributes, each attribute having three possible values.

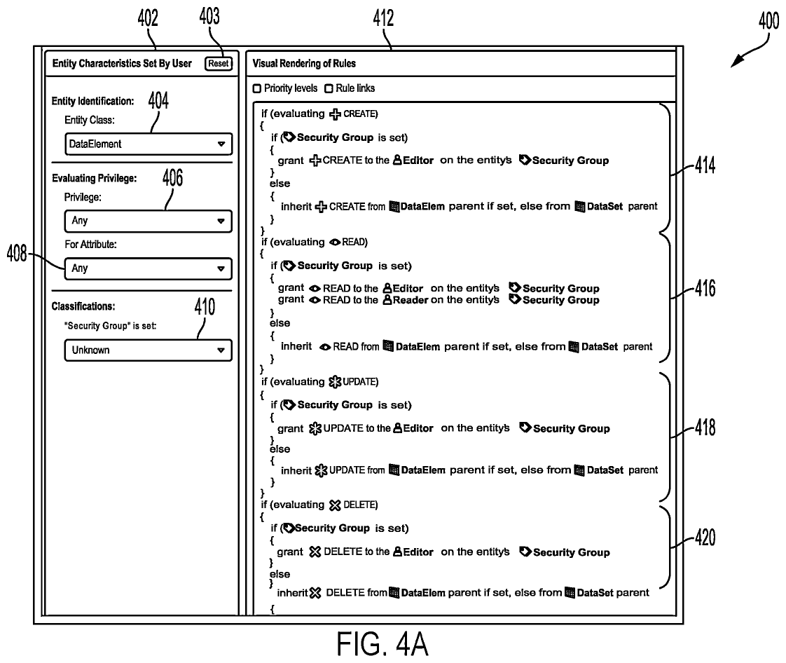

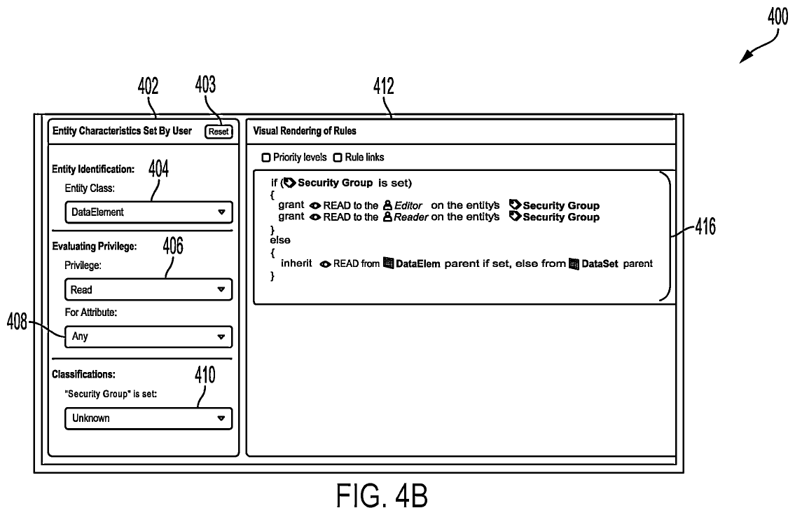

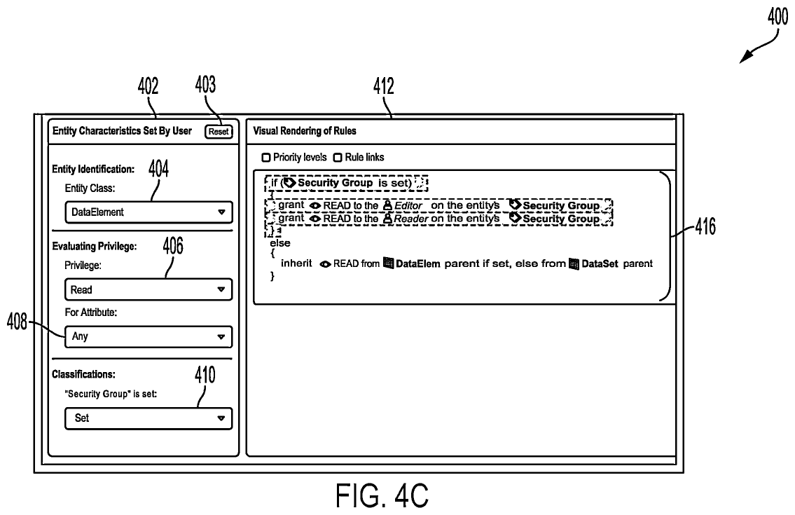

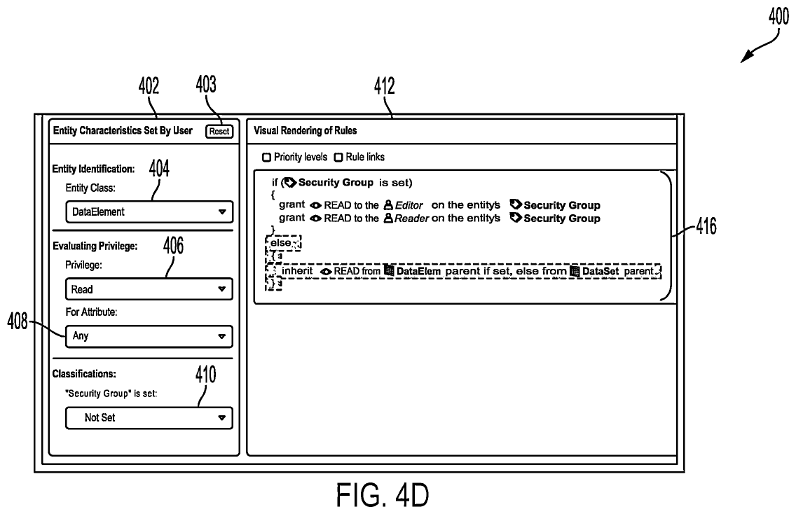

FIG. 4A is an illustrative diagram of an example GUI 400 executing in a simulation mode for a data entity. In the simulation mode, value(s) of attribute(s) of the data entity, such as, data entity “DataElement” 404 may be obtained from a user, for example, an administrator 104. Although this data entity may be defined, there may not be any instances of the data entity in a data store, for example, data entity instances data store 144. Accordingly, the value(s) of attribute(s) of the data entity 404 are selected by the user.

As shown in FIG. 4A, the GUI 400 includes a first portion 402 and a second portion 412. The first portion 402 includes a GUI element 404 for selecting a data entity for which a visual rendering of rule(s) is generated in the second portion 412 of the GUI 400. The first portion 402 includes a GUI element 406 for selecting a privilege of interest (e.g., Create, Read, Update, or Delete). The first portion 402 includes a GUI element 408 for selecting a value of an attribute of the data entity 404. The first portion 402 includes a GUI element 410 for selecting a value of another attribute (“Security Group”) of the data entity 404. The first portion 402 includes a GUI element 403 for resetting the values associated with the data entity, privilege, attributes, and/or other elements in the first portion 402 to default values.

The second portion 412 of the GUI 400 includes a visual rendering of one or more rules for granting and/or denying privileges to at least one actor to perform at least one action on one or more instances of the data entity 404. The visual rendering in the second portion 412 includes a visual rendering of a first rule 414 including text representing the first rule for granting and/or denying privileges to one or more actors (e.g., Editor and/or other actors) to perform a “CREATE” action on one or more instances of the data entity 404. The first rule 414 depends on a value of attribute “Security Group” of the data entity 404. The first rule 414 indicates that a user with an Editor role may be granted privileges for performing a “CREATE” action on one or more instances of the data entity 404 if a value of attribute “Security Group” is set. If the value of attribute “Security Group” is not set, the privilege for performing a “CREATE” action on one or more instances of the data entity 404 is inherited from a parent data entity of data entity 404 or a parent of another data entity “DataSet”.

The visual rendering in the second portion 412 of the GUI 400 includes a visual rendering of a second rule 416 including text representing the second rule for granting and/or denying privileges to one or more actors (e.g., Editor, Reader, and/or other actors) to perform a “READ” action on one or more instances of the data entity 404. The second rule 416 depends on a value of attribute “Security Group” of the data entity 404. The second rule 416 indicates that a user with Editor and Reader roles may be granted privileges for performing a “READ” action on one or more instances of the data entity 404 if a value of attribute “Security Group” is set. If the value of attribute “Security Group” is not set, the privilege for performing a “READ” action on one or more instances of the data entity 404 is inherited from a parent data entity of data entity 404 or a parent of another data entity “DataSet”.

The visual rendering in the second portion 412 of GUI 400 includes a visual rendering of a third rule 418 including text representing the third rule for granting and/or denying privileges to one or more actors (e.g., Editor, and/or other actors) to perform an “UPDATE” action on one or more instances of the data entity 404. The third rule 418 depends on a value of attribute “Security Group” of the data entity 404. The third rule 418 indicates that a user with an Editor role may be granted privileges for performing an “UPDATE” action on one or more instances of the data entity 404 if a value of attribute “Security Group” is set. If the value of attribute “Security Group” is not set, the privilege for performing an “UPDATE” action on one or more instances of the data entity 404 is inherited from a parent data entity of data entity 404 or a parent of another data entity “DataSet”.

The visual rendering in the second portion 412 of GUI 400 includes a visual rendering of a fourth rule 420 including text representing a portion of the fourth rule for granting and/or denying privileges to one or more actors (e.g., Editor, and/or other actors) to perform a “DELETE” action on one or more instances of the data entity 404. The fourth rule 420, like the other rules 414, 416, and 418 depends on a value of attribute “Security Group” of the data entity 404.

FIG. 4B is an illustrative diagram of the example GUI 400 showing how the visual rendering of the rules within GUI 400 may be updated in response to a user selecting a privilege of interest, in accordance with some embodiments of the technology described herein. As shown in FIG. 4B, selection of a “READ” privilege as the privilege of interest via GUI element 406 causes the visual rendering of the rules in second portion 412 of the GUI 400 to be updated. In some embodiments, the visual rendering of the rules may be updated by emphasizing the visual rendering of rule(s) associated with the selected privilege of interest. FIG. 4B illustrates the visual rendering of rule 416 associated with the selected privilege of interest being emphasized by removing, from the visual rendering, at least some text corresponding to one or more rules that are not associated with the selected privilege of interest. For example, only text corresponding to rule 416 associated with the “READ” privilege is rendered in the second portion 412 of GUI 400, whereas text corresponding to all the other rules 414, 418, 420 is removed from the visual rendering. It will be understood other forms of emphasizing may be used as described herein.

FIG. 4C is an illustrative diagram of the example GUI 400 showing how the visual rendering of the rules within GUI 400 may be updated in response to obtaining, through the first portion 402 of the GUI 400, input from a user indicating that the “Security Group” attribute of data entity “DataElement” is set. As shown in FIG. 4C, selection of a value (e.g., set) of attribute “Security Group” via GUI element 410 in the first portion 402 of the GUI 400 causes the visual rendering of the rules in second portion 412 of the GUI 400 to be updated. The visual rendering may be updated by emphasizing the visual rendering of the second rule 416 that is associated with the selected privilege of interest (e.g., READ) and depends on the selected value (e.g., set) of attribute “Security Group”. FIG. 4C illustrates at least part of the text representing the second rule 416 being emphasized by highlighting. The highlighted portion associated with the second rule 416 indicates that a user with Editor and Reader roles may be granted privileges for performing a “READ” action on one or more instances of the data entity 404 if the value of attribute “Security Group” is set.

FIG. 4D is an illustrative diagram of the example GUI 400 showing how the visual rendering of the rules within GUI 400 may be updated in response to obtaining, through a first portion 402 of the GUI 400, input from a user indicating that the “Security Group” attribute of data entity “DataElement” is not set. As shown in FIG. 4D, selection of a value (e.g., not set) of attribute “Security Group” via GUI element 410 in the first portion 402 of the GUI 400 causes the visual rendering of the rules in second portion 412 of the GUI 400 to be updated. The visual rendering may be updated by emphasizing the visual rendering of the second rule 416 that is associated with the selected privilege of interest (e.g., READ) and depends on the selected value (e.g., not set) of attribute “Security Group”. FIG. 4D illustrates at least part of the text representing the second rule 416 being emphasized by highlighting. The highlighted portion associated with the second rule 416 indicates that the privilege for performing a “READ” action on one or more instances of the data entity 404 is inherited from a parent data entity of data entity 404 or a parent of another data entity “DataSet”.

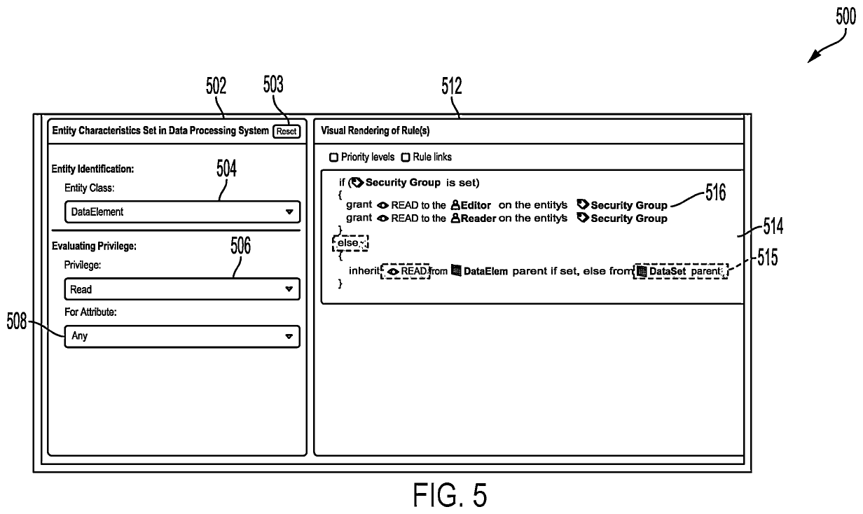

FIG. 5 is an illustrative diagram of an example GUI 500 executing in an evaluation mode for a data entity, in accordance with some embodiments of the technology described herein. In the evaluation mode, one or multiple instances of a data entity, such as, data entity “DataElement” 504 may be available in the data entity instances data store 144. Values of attributes of the data entity 504 may be obtained from the data store 144. The obtained values may be used to evaluate privileges. In the evaluation mode, the values of the attributes of the data entity 504 are not obtained from the user.

As shown in FIG. 5, the GUI 500 includes a first portion 502 and a second portion 512. The first portion 502 includes a GUI element 504 that identifies the data entity 504 for which a visual rendering of rule(s) is generated in the second portion 512 of the GUI 500. The first portion 502 includes a GUI element 506 that identifies the privilege of interest (e.g., READ). The first portion 502 includes a GUI element 508 that identifies a value of an attribute of the data entity 504.

The second portion 512 of the GUI 500 includes a visual rendering of one or more rules for granting and/or denying privileges to at least one actor to perform at least one action on one or more instances of the data entity 504. The visual rendering in the second portion 512 includes a visual rendering of a rule 514 including text representing the rule for granting and/or denying privileges to one or more actors (e.g., Editor, Reader, and/or other actors) to perform a “READ” action on one or more instances of the data entity 504. The visual rendering in the second portion 512 may be associated with the privilege of interest (i.e., READ) identified in the first portion 502. As shown in FIG. 5, at least part of the text representing the rule 514 may be emphasized by highlighting. The highlighted portion 515 associated with the rule 514 indicates that a value of attribute “Security Group” of the data entity 504 is not set and that a READ privilege for the data entity 504 is inherited from a parent of another entity “DataSet”. In some embodiments, a different part 516 of the text representing the rule 414 may be emphasized if a value of attribute “Security Group” of the data entity 504 is set.

FIG. 6A is a flowchart of an illustrative process 600 for visualizing privilege rules for a data entity, in accordance with some embodiments of the technology described herein. Process 600 may be executed by any suitable data processing system and, for example, may be executed by data processing system 105 described with reference to FIG. 2.

Process 600 begins at act 602, during which rules for granting and/or denying privileges to actor(s) to perform action(s) on instance(s) of a data entity are obtained. The rules may be obtained from any suitable source(s), for example, from a data store 146 communicatively coupled to the data processing system 120, as aspects of the technology described herein are not limited in this respect. In some embodiments, the rules may define data access privileges (for example, granting and/or denying privileges) for the data entity and may include privilege rules to control who can create, read, update, and delete instances of the data entity and/or particular attributes of the data entity. For example, rules 414, 416, 418, and 420 associated with data entity “DataElement” 404 as shown in FIG. 4A may be obtained from data store 146. As another example, rules 310 and 320 associated with data entity “DataElement” as shown in FIGS. 3B and 3C may be obtained from data store 146.

Next, at act 604, an attribute of the data entity whose values are used by at least some of the rules obtained at act 602 is identified. For example, referring to FIG. 4A, the “Security Group” attribute of the “DataElement” data entity may be identified as an attribute whose values are used by each of the rules 414, 416, 418, and 420. As another example, referring to FIGS. 3B and 3C, attribute “Security Group” of the data entity “DataElement” may be identified as an attribute whose values are used by rule 310 whereas attribute “Dataset” of the data entity “DataEement” may be identified as an attribute whose values are used by rule 320.

Next, at act 606, a value of the identified attribute of the data entity is obtained. In some embodiments, value(s) of the identified attribute may be obtained from a user (e.g., an administrator). The value(s) may be obtained from the user in a simulation mode described above. For example, referring to FIG. 4A, a value for the “Security Group” attribute may be obtained from the user via GUI element 410. In other embodiments, the value(s) of the identified attribute may be obtained from the data entity instances data store 144. The value(s) may be obtained from data store 146 in an evaluation mode described above.

Next, at act 608, one or more rules that depend on the attribute value obtained at act 606 are identified. The rule(s) may be identified using the attribute value and from among the rules obtained at act 602. For example, referring to FIG. 4A, if the value of the “Security Group” attribute indicates that the Security Group is set, all the rules 414, 416, 418, and 420 may be identified as each of these rules depends on whether the Security Group attribute is set. In other embodiments, a first value of the attribute may cause a first set of rules to be identified and a second value (e.g., different from the first value) of the attribute may cause a second set of rules to be identified. In yet other embodiments, different values for different attributes may cause different sets of rules to be identified.

Next, at act 610, a GUI including a visual rendering of at least some of the rules obtained at act 602 is generated. In some embodiments, the GUI includes a first portion and a second portion. The first portion includes GUI element(s) that enable selection of or otherwise present obtained values of attributes of the data entity. The second portion includes the visual rendering of rule(s) identified at act 608. The visual rendering emphasizes the rule(s) identified at act 608. For example, FIGS. 3B and 3C illustrate emphasizing of visual rendering of rule(s) in the second portion 304 of GUI 300. The rule(s) may be emphasized by visually emphasizing text representing the identified rule(s). The text may be visually emphasized by highlighting, underlining, and/or changing font characteristics of at least some of the text representing the rule(s). In some embodiments, the visual rendering emphasizes the identified rule(s) by removing, from the visual rendering, at least some text corresponding to rules different from the identified rule(s). Next, at act 612, the generated GUI may be displayed to the user.

Next, process 600 proceeds to act 614, where a determination may be made regarding whether information indicating a different attribute value has been obtained, for example, from the user or data store 144. In response to determining that information indicating a different attribute value has been obtained, the process loops back to either act 608 or 604. In some embodiments, when the information indicates a different attribute value for the same attribute that was previously identified at act 604, the process proceeds to act 608, where one or more rules that depend on the different attribute value are identified. In other embodiments, when the information indicates a different attribute value for another attribute different from the attribute that was previously identified at act 604, the process loops back to act 604, where the other attribute of the data entity whose values are used by at least some of the rules is identified. In either case, process 600 proceeds through the remaining downstream acts until a determination is made at act 614 that information indicating a different attribute value has not been obtained. In response to a determination that information indicating a different attribute value has not been obtained, the process ends.

FIG. 6B is a flowchart of an example implementation of illustrative process 600 for visualizing privilege rules for a data entity. Process 600 may be executed by any suitable data processing system and, for example, may be executed by data processing system 105 described with reference to FIG. 2.

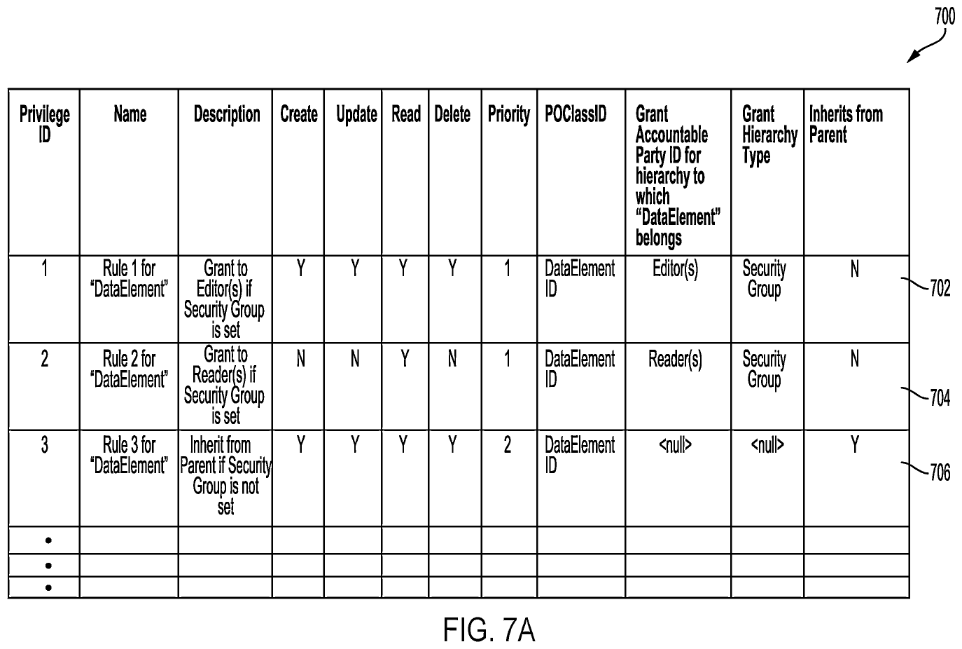

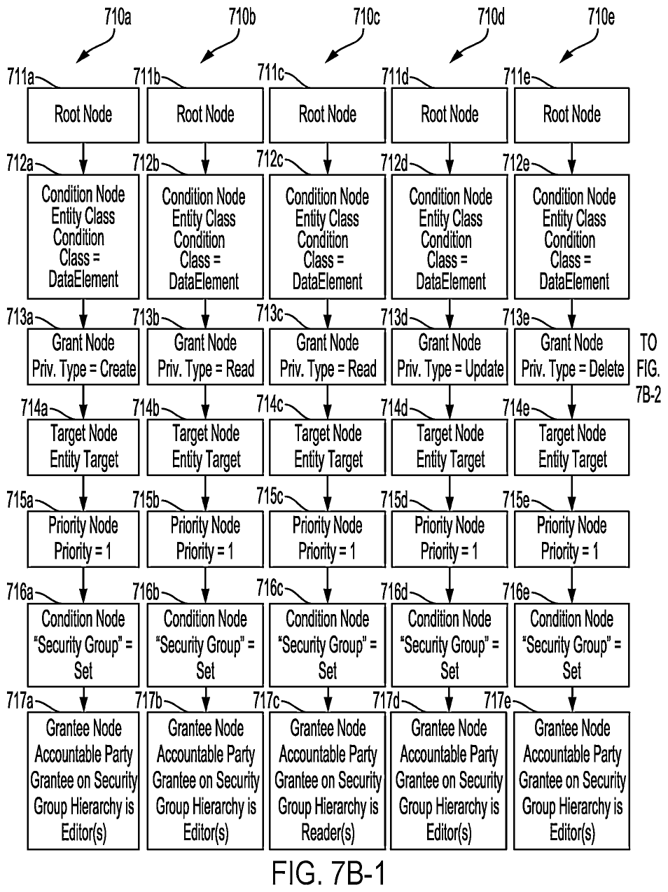

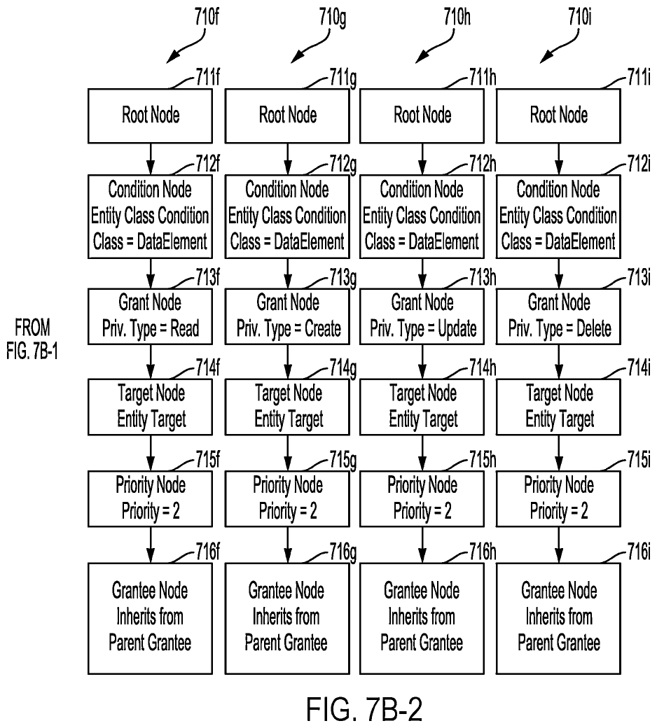

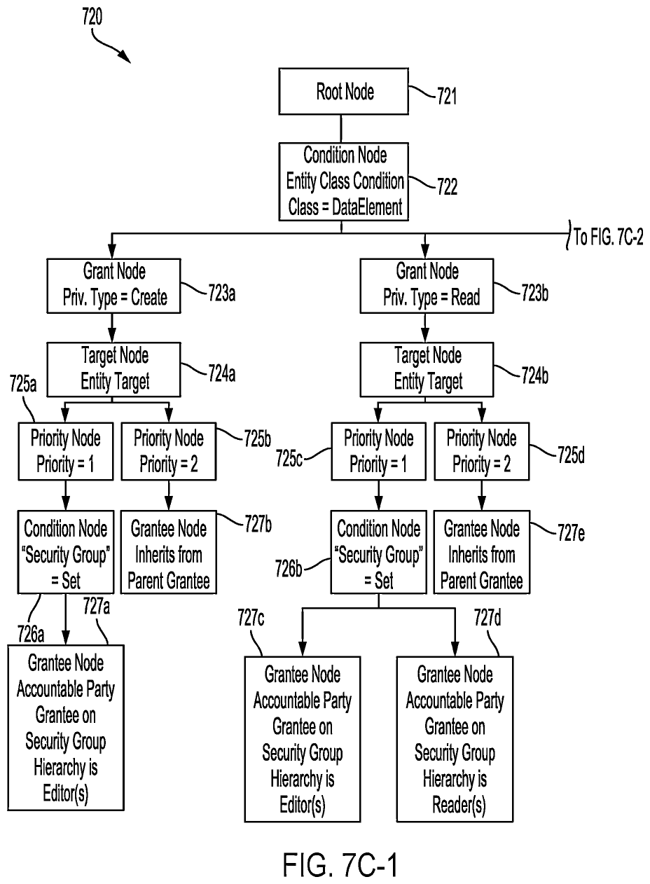

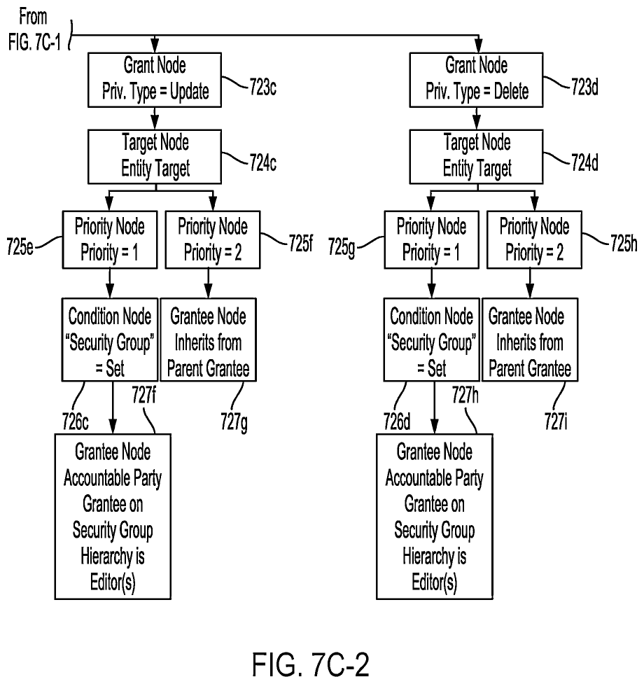

Process 600 begins at act 602, during which rules for granting and/or denying privileges to actor(s) to perform action(s) on one or more instances of a data entity are obtained. The rules may be obtained from data store 146. In some embodiments, the rules may define data access privileges (for example, granting and/or denying privileges) for the data entity and may include privilege rules to control who can perform create, read, update, and delete actions on instances of the data entity and/or particular attributes of the data entity. For example, FIG. 7A illustrates table 700 of example rules obtained from data store 146 for granting and/or denying privileges to actor(s) for performing action(s) on one or more instances of a “DataElement” data entity. Table 700 includes three rules 702, 704, and 706 for granting and/or denying privileges to actors to perform create, update, read, and delete actions on one or more instances of the “DataElement” data entity. For example, rule 702 indicates that an actor specified in the “Grant Accountable Party ID for hierarchy to which “DataElement” belongs” column is granted privileges to perform create, update, read, and delete actions (e.g., indicated by “Y”) on one or more instances of the “DataElement” data entity if the value of the attribute “Security Group” is set. Rule 704 indicates that an actor specified in the “Grant Accountable Party ID for hierarchy to which “DataElement” belongs” column is granted privileges to perform a read action (e.g., indicated by “Y” for read and “N” for the other actions) on one or more instances of the “DataElement” data entity if the value of the attribute “Security Group” is set. Rule 706 indicates that privilege information is inherited from the parent of the “DataElement” entity or the “Dataset” parent if the value of the attribute “Security Group” is not set. For example, any grantees (e.g., actors, accountable parties, etc.) assigned to the parent data entity are inherited and granted privileges to perform create, update, read, and delete actions (e.g., indicated by “Y”) on one or more instances of the “DataElement” data entity if the value of the attribute “Security Group” is not set.

As shown in FIG. 7A, each rule 702, 704, and 706 includes information regarding which actor is granted privilege to perform which action on one or more instances of the “DataElement” data entity. Each column of table 700 indicates certain characteristics or parameters of the rules. For example, a “Name” column identifies a name for the rule; a “Description” column describes the rule; a “Create Privilege” column indicates whether an actor has privilege or is granted privilege to perform a create action on one or more instances of a data entity identified in the “POClassID” column; an “Update Privilege” column indicates whether an actor has privilege or is granted privilege to perform an update action on one or more instances of a data entity identified in the “POClassID” column; a “Read Privilege” column indicates whether an actor has privilege or is granted privilege to perform a read action on one or more instances of a data entity identified in the “POClassID” column; a “Delete Privilege” column indicates whether an actor has privilege or is granted privilege to perform a delete action on one or more instances of a data entity identified in the “POClassID” column; a “Priority” column indicates an ordering for the rule; a “POClassID” column identifies the data entity; a “Grant Accountable Party ID for hierarchy to which “DataElement” belongs” column indicates particular actors, actors with certain roles, and/or accountable parties or groups of actors who are granted privileges to perform actions on one or more instances of the data entity; a “Grant Hierarchy Type” column identifies an attribute whose value indicates the actor who is granted privileges to perform actions on one or more instances of the data entity; and a “Inherits from Parent” column indicates whether a particular rule specifies that privilege information is inherited from a parent data entity.

In some embodiments, the “DataElement” data entity may be part of a hierarchy of data entities and may have an attribute indicating the hierarchy to which the “DataElement” data entity belongs. Column “Grant Accountable Party ID for hierarchy to which “DataElement” belongs” of table 700 may identify an accountable party associated with the hierarchy to which the “DataElement” data entity belongs. In some embodiments, a grant accountable party ID may identify a group of actors who are granted privileges to perform actions on one or more instances of a data entity. For example, the grant accountable party ID for rule 702 may indicate that a group of editors is granted privileges to perform actions on one or more instances of the “DataElement” data entity. Similarly, the grant accountable party ID for rule 704 may indicate that a group of readers is granted privileges to perform actions on one or more instances of the “DataElement” data entity.

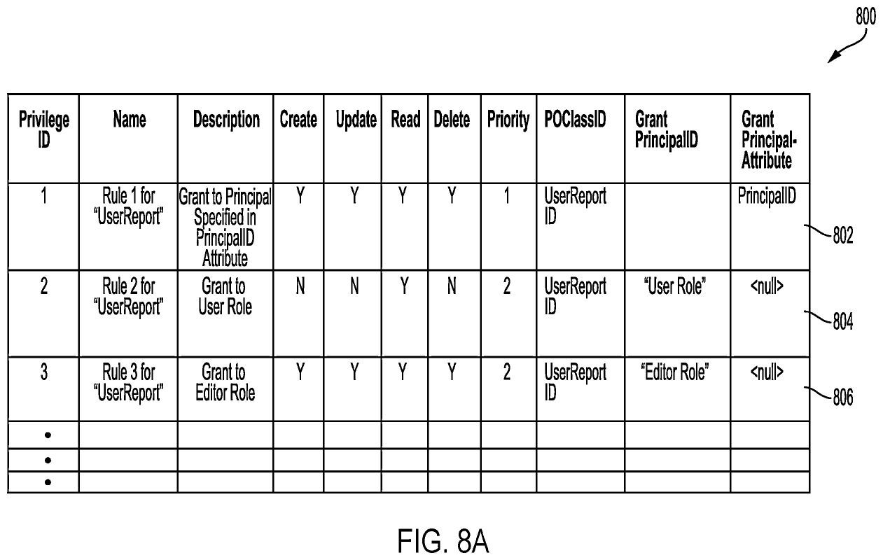

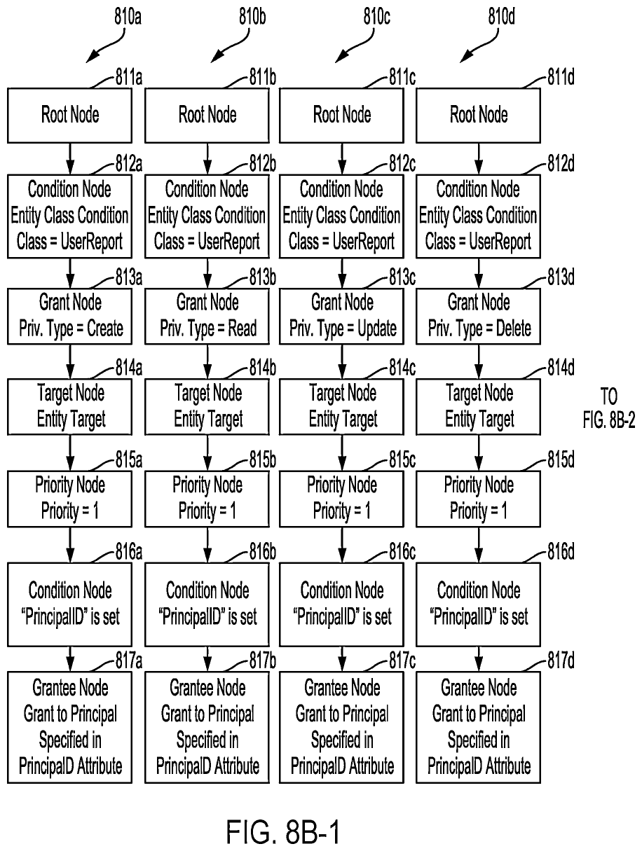

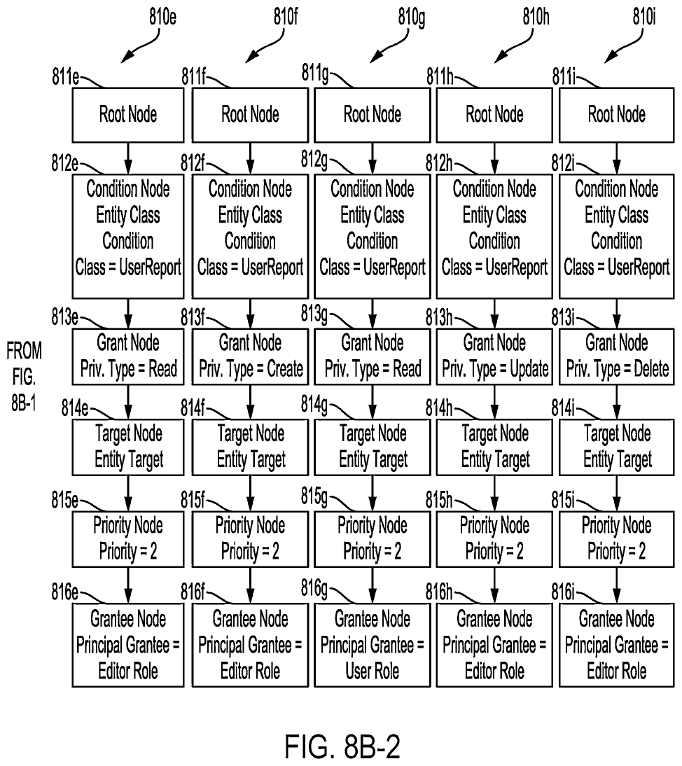

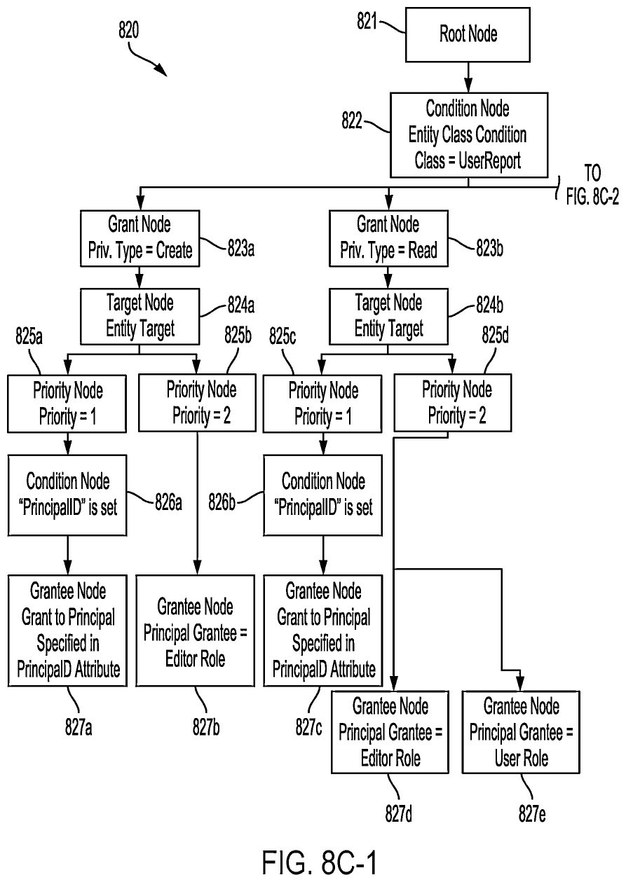

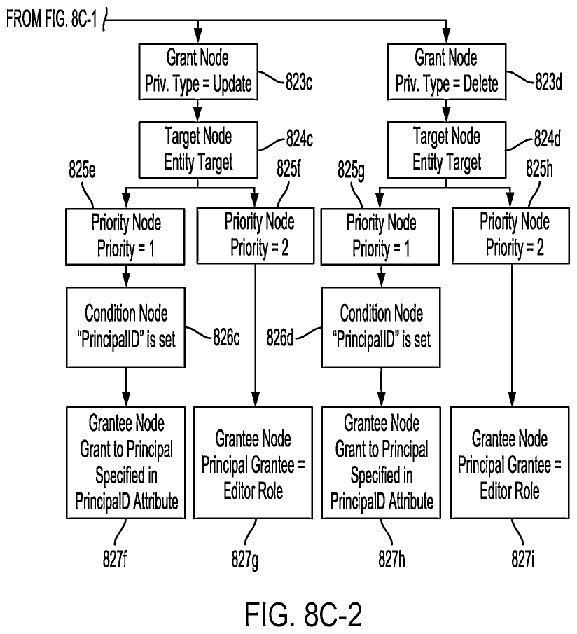

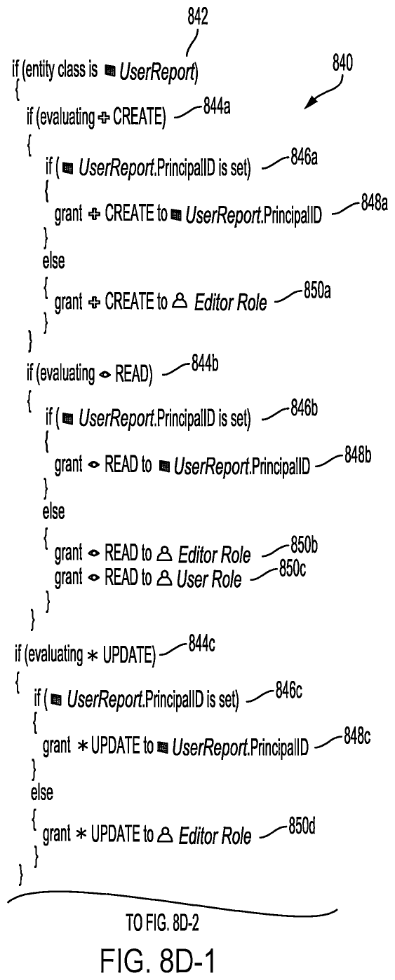

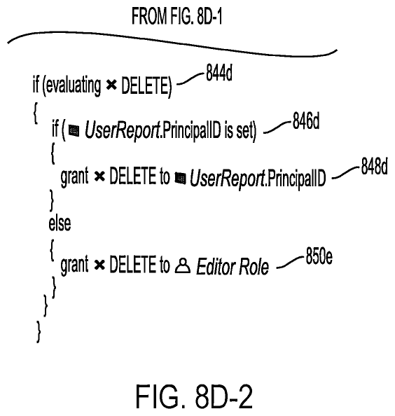

As another example, FIG. 8A illustrates a table 800 of example rules obtained from data store 146 for granting and/or denying privileges to actor(s) for performing action(s) on one or more instances of a “User Report” data entity. Table 800 includes three rules 802, 804, and 806 for granting and/or denying privileges to actors to perform create, update, read, and delete actions on one or more instances of the “User Report” data entity. For example, rule 802 indicates that an actor specified in “PrincipalID” attribute is granted privileges to perform create, update, read, and delete actions (e.g., indicated by “Y”) on one or more instances of the “User Report” data entity. Rule 804 indicates that an actor with a “User Role” is granted privileges to perform a read action (e.g., indicated by “Y” for read and “N” for the other actions) on one or more instances of the “User Report” data entity. Rule 806 indicates that an actor with an “Editor Role” is granted privileges to perform create, update, read, and delete actions on one or more instances of the “User Report” data entity. As shown in FIG. 8A, each rule 802, 804, and 806 includes information regarding which actor is granted privilege to perform which action on one or more instances of the “User Report” data entity. Each column of table 800 indicates certain characteristics or parameters of the rules. For example, a “Name” column identifies a name for the rule; a “Description” column describes the rule; a “Create Privilege” column indicates whether an actor has privilege or is granted privilege to perform a create action on one or more instances of a data entity identified in the “POClassID” column; an “Update Privilege” column indicates whether an actor has privilege or is granted privilege to perform an update action on one or more instances of a data entity identified in the “POClassID” column; a “Read Privilege” column indicates whether an actor has privilege or is granted privilege to perform a read action on one or more instances of a data entity identified in the “POClassID” column; a “Delete Privilege” column indicates whether an actor has privilege or is granted privilege to perform a delete action on one or more instances of a data entity identified in the “POClassID” column; a “Priority” column indicates an ordering for the rule; a “POClassID” column identifies the data entity; a “GrantPrincipalID” column indicates particular roles of actors who are granted privileges to perform actions on one or more instances of the data entity; and “GrantPrincipalAttribute” column identifies an attribute whose value indicates the actor who is granted privileges to perform actions on one or more instances of the data entity.

Next, at act 604, an attribute of the data entity whose values are used by at least some of the rules obtained at act 602 is identified. The attribute may be identified by generating rule chains from the obtained rules at act 604a; generating a rules tree from the rule chains at act 604b; and identifying attribute(s) associated with condition nodes in the generated rules tree at act 604c.

In some embodiments, a rule chain is a representation of a rule in a linear form. The linear form may include multiple nodes linearly connected to one another, each of the nodes represents a respective element of the rule (e.g., a type of privilege, an actor, a condition for when the privilege is granted or denied to the actor, a priority, etc.). There are multiple different type of nodes that may be part of a rule chain. For example, a rule chain may include a node of a first type, such as a grant node. This type of node indicates a privilege type. As another example, a rule chain may include a node of a second type such as a condition node. This type of node indicates condition(s) that apply to a data entity or an attribute of the data entity.

In some embodiments, a rules tree is a representation of multiple rules with nodes that are common between at least some of the multiple rules shown together in a flowchart-like structure. The condition nodes in a generated rules tree indicate how a rule will be applied to a particular data entity based on one or more attributes associated with that particular entity. In this manner, a condition node may be used to identify attributes of a data entity whose values are used by one or more privilege rules.

FIG. 7B illustrates rule chains generated, at act 604a, using the example rules 702, 704, and 706 of FIG. 7A, in accordance with some aspects of the technology described herein. FIG. 7B illustrates rule chains 710a, 710b, 710d, and 710e generated using rule 702, rule chain 710c generated using rule 704, and rule chains 710f, 710g, 710h, and 710i generated using rule 706. Each rule chain includes a number of nodes, where each node has one child. Each node in the rule chain is an element of the respective rule. For example, if a rule has a condition that indicates that it applies to a particular data entity or attribute associated with the data entity, then the rule chain includes a condition node, such as condition nodes 712a, 712b, 712c, 712d, 712e, 712f, 712g, 712h, and 712i that indicate a condition that applies to data entity “DataElement” or condition nodes 716a, 716b, 716c, 716d, 716e that indicate a condition that applies to an attribute “Security Group” of the data entity “DataElement”.

As shown in FIG. 7B, each rule chain includes i) a root node, such as root nodes 711a, 711b, 711c, 711d, 711e, 711f, 711g, 711h, and 711i; ii) one or more condition nodes indicating conditions being applied to a particular data entity or attribute(s) associated with the data entity, such as condition nodes 712a, 712b, 712c, 712d, 712e, 712f, 712g, 712h, 712i and/or condition nodes 716a, 716b, 716c, 716d, 716e; iii) a grant node indicating a privilege type (e.g., create, read, update, or delete), such as grant nodes 713a, 713b, 713c, 713d, 713e, 713f, 713g, 713h, and 713i; iv) a target node indicating a target (e.g., data entity and/or attribute of the data entity) for the rule, such as target nodes 714a, 714b, 714c, 714d, 714e, 714f, 714g, 714h, and 714i; v) a priority node indicating an ordering for the rule, such as priority nodes 715a, 715b, 715c, 715d, 715e, 715f, 715g, 715h, and 715i; and vi) a grantee node indicating an actor who is granted the privilege type indicated by the respective grant node, such as grantee nodes 717a, 717b, 717c, 717d, 717e, 717f, 717g, 717h, and 717i.

As another example, FIG. 8B illustrates rule chains generated, at act 604a, using the example rules 802, 804, and 806 of FIG. 8A, in accordance with some embodiments of the technology described herein. FIG. 8B illustrates rule chains 810a, 810b, 810c, and 810d generated using rule 802, rule chain 810e generated using rule 804, and rule chains 810f, 810g, 810h, and 810i generated using rule 806. Each rule chain includes a number of nodes, where each node has one child. Each node in the rule chain is an element of the respective rule. For example, if a rule has a condition that indicates that it applies to a particular data entity or attribute associated with the data entity, then the rule chain includes a condition node, such as condition nodes 812a, 812b, 812c, 812d, 812e, 812f, 812g, 812h, and 812i that indicate a condition that applies to data entity “User Report” or condition nodes 816a, 816b, 816c, 816d that indicate a condition that applies to an attribute “PrincipalID” of the data entity “User Report”.

As shown in FIG. 8B, each rule chain includes i) a root node, such as root nodes 811a, 811b, 811c, 811d, 811e, 811f, 811g, 811h, and 811i; ii) one or more condition nodes indicating conditions being applied to a particular data entity or attribute(s) associated with the data entity, such as condition nodes 812a, 812b, 812c, 812d, 812e, 812f, 812g, 812h, 812i and/or condition nodes 816a, 816b, 816c, 816d; iii) a grant node indicating a privilege type (e.g., create, read, update, or delete), such as grant nodes 813a, 813b, 813c, 813d, 813e, 813f, 813g, 813h, and 813i; iv) a target node indicating a target (e.g., data entity and/or attribute of the data entity) for the rule, such as target nodes 814a, 814b, 814c, 814d, 814e, 814f, 814g, 814h, and 814i; v) a priority node indicating an ordering for the rule, such as priority nodes 815a, 815b, 815c, 815d, 815e, 815f, 815g, 815h, and 815i; and vi) a grantee node indicating an actor who is granted the privilege type indicated by the respective grant node, such as grantee nodes 817a, 817b, 817c, 817d, 817e, 817f, 817g, 817h, and 817i.

FIG. 7C illustrates an example rules tree 720 generated, at act 604b, using the example rule chains of FIG. 7B, in accordance with some embodiments of the technology described herein. Rules tree 720 is generated my merging the rule chains of FIG. 7B. In some embodiments, identical nodes across all the rule chains 710a-710i are merged to form a single node in the rules tree 720. For example, identical nodes of a particular type may be identified and these nodes may be replaced by a single node of that type. This may cause previously unconnected rule chains to be connected by this common node. Rules tree 720 includes a root node 721 obtained by merging all the root nodes 711a, 711b, 711c, 711d, 711e, 711f, 711g, 711h, and 711i. Once the root nodes are merged, the process analyzes the downstream nodes in each of the rule chains 710a-710i and attempts to merge the nodes. If the next node in each of the rule chains 710a-710i is the same, the nodes can be merged. For example, because the condition nodes 712a, 712b, 712c, 712d, 712e, 712f, 712g, 712h, 712i are the same, these nodes can be merged to form condition node 722 in rules tree 720. This merge process is performed for all downstream nodes in the rule chains 710a-710i. For example, all grant nodes indicating a common privilege type are merged to form a grant node in the rules tree. For example all grant nodes (713a, 713g) with the privilege type “Create” are merged together to form grant node 723a in rules tree 720, all grant nodes (e.g., grant nodes 713b, 713c, 713f) indicating privilege type “Read” are merged together to form grant node 723b in rules tree 720, all grant nodes (e.g., grant nodes 713d, 713h) indicating privilege type “Update” are merged together to form grant node 723c in rules tree 720, and all grant nodes (e.g., grant nodes 713e, 713i) indicating privilege type “Delete” are merged together to form grant node 723d in rules tree 720.

Grant nodes 723a-723d form a set of branching points in the rules tree 720. Within each branch, nodes in the associated rule chains are analyzed and the same nodes are merged. For example, within the branch associated with grant node 723a, nodes downstream from the grant node in rule chains 710a and 710g are analyzed for purposes of determining whether the nodes can be merged. As shown in FIG. 7C, target nodes 714a and 714g are merged to form target node 724a in rules tree 720. Because priority nodes 715a and 715g have different priorities (i.e., are not the same), the priority nodes are not merged and retained as separate nodes, for example, priority nodes 725a and 725b. Condition node 726a and grantee node 727a correspond to condition nodes 716a and 717a of rule chain 710a, respectively. Grantee node 727b corresponds to grantee node 716g of rule chain 710g.

As will be appreciated the merge process described herein may be performed on each of the rule chains 710a, 710b, 710c, 710d, 710e, 710f, 710g, 710h, and 710i and at each of the branching points to generate the rules tree 720 of FIG. 7C. For example, within the branch associated with grant node 723b, nodes downstream from the grant node in rule chains 710b, 710c, and 710f are analyzed for purposes of determining whether the nodes can be merged. Accordingly, nodes associated with the grant node 723b branch include target node 724b, priority nodes 725c, 725d, condition node 726b, and grantee nodes 727c, 727d, 727e. Within the branch associated with grant node 723c, nodes downstream from the grant node in rule chains 710d and 710h are analyzed for purposes of determining whether the nodes can be merged. Accordingly, nodes associated with the grant node 723c branch include target node 724c, priority nodes 725e, 725f, condition node 726c, and grantee nodes 727f, 727g. Within the branch associated with grant node 723d, nodes downstream from the grant node in rule chains 610e and 610i are analyzed for purposes of determining whether the nodes can be merged. Accordingly, nodes associated with the grant node 723d branch include target node 724d, priority nodes 725g, 725h, condition node 726d, and grantee nodes 727h, 727i.

As another example, FIG. 8C illustrates an example rules tree 820 generated, at act 604b, using the example rule chains of FIG. 8B, in accordance with some embodiments of the technology described herein. Rules tree 820 is generated by merging the rule chains of FIG. 8B. In some embodiments, identical nodes across all the rule chains 810a-810i are merged to form a single node in the rules tree 820. For example, identical nodes of a particular type may be identified and these nodes may be replaced by a single node of that type. This may cause previously unconnected rule chains to be connected by this common node. Rules tree 820 includes a root node 821 obtained by merging all the root nodes 811a, 811b, 811c, 811d, 811e, 811f, 811g, 811h, and 811i. Once the root nodes are merged, the process analyzes the downstream nodes in each of the rule chains 810a-810i and attempts to merge the nodes. If the next node in each of the rule chains 810a-810i is the same, the nodes can be merged. For example, because the condition nodes 812a, 812b, 812c, 812d, 812e, 812f, 812g, 812h, 812i are the same, these nodes can be merged to form condition node 822 in rules tree 820. This merge process is performed for all downstream nodes in the rule chains 810a-810i. For example, all grant nodes (e.g., grant nodes 813a, 813f) indicating a common privilege type are merged to form a grant node in the rules tree. For example all grant nodes with the privilege type “Create” are merged together to form grant node 823a in rules tree 820, all grant nodes (e.g., grant nodes 813b, 813e, 813g) indicating privilege type “Read” are merged together to form grant node 823b in rules tree 820, all grant nodes (e.g., grant nodes 813c, 813h) indicating privilege type “Update” are merged together to form grant node 823c in rules tree 820, and all grant nodes (e.g., grant nodes 813d, 813i) indicating privilege type “Delete” are merged together to form grant node 823d in rules tree 820.

Grant nodes 823a-823d form a set of branching points in the rules tree 820. Within each branch, nodes in the associated rule chains are analyzed and the same nodes are merged. For example, within the branch associated with Grant node 823a, nodes downstream from the grant node in rule chains 810a and 810f are analyzed for purposes of determining whether the nodes can be merged. As shown in FIG. 8C, target nodes 814a and 814f are merged to form target node 824a in rules tree 820. Because priority nodes 815a and 815f have different priorities (i.e., are not the same), the priority nodes are not merged and retained as separate nodes, for example, priority nodes 825a and 825b. Condition node 826a and grantee node 827a correspond to condition nodes 816a and 817a of rule chain 810a, respectively. Grantee node 827b corresponds to grantee node 817f of rule chain 810f.

As will be appreciated the merge process described herein may be performed on each of the rule chains 810a, 810b, 810c, 810d, 810e, 810f, 810g, 810h, and 810i and at each of the branching points to generate the rules tree 820 of FIG. 8C. For example, within the branch associated with grant node 823b, nodes downstream from the grant node in rule chains 810b, 810e, and 810g are analyzed for purposes of determining whether the nodes can be merged. Accordingly, nodes associated with the grant node 823b branch include target node 824b, priority nodes 825c, 825d, condition node 826b, and grantee nodes 827c, 827d, 827e. Within the branch associated with grant node 823c, nodes downstream from the grant node in rule chains 810c and 810h are analyzed for purposes of determining whether the nodes can be merged. Accordingly, nodes associated with the grant node 823c branch include target node 824c, priority nodes 825e, 825f, condition node 826c, and grantee nodes 827f, 827g. Within the branch associated with grant node 823d, nodes downstream from the grant node in rule chains 810d and 810i are analyzed for purposes of determining whether the nodes can be merged. Accordingly, nodes associated with the grant node 823d branch include target node 824d, priority nodes 825g, 825h, condition node 826d, and grantee nodes 827h, 827i.

Next, at act 604c, attribute(s) associated with condition nodes in the rules tree generated at act 604b may be identified. For example, an attribute (e.g., PrincipalID) associated with condition nodes 826a, 826b, 826c, and 826d in rules tree 820 may be identified. As another example, an attribute (e.g., Security Group) associated with condition nodes 726a, 726b, 726c, and 726d in rules tree 720 may be identified.

Next, at act 606 of FIG. 6B, a value of the identified attribute of the “User Report” data entity is obtained. The value may be obtained from a user or the data entity instances data store 144. For example, a value of the PrincipalID attribute may be obtained. The value may indicate whether the PrincipalID attribute of the “User Report” data entity is set. As another example, a value of the identified attribute (e.g., Security Group) of the “DataElement” data entity may be obtained. The value may be obtained from a user or the data entity instances data store 144. The value may indicate whether the “Security group” attribute of the “DataElement” data entity is set.

Next, at act 608 of FIG. 6B, one or more rules that depend on the attribute value obtained at act 606 are identified. The rule(s) may be identified by filtering the rules tree 720 or 820. In some embodiments, filtering the rules tree 720 or 820 may include identifying one or more applicable branches of the rules tree 720 or 820 based on the attribute value. In some embodiments, in a simulation mode, the applicability of the branches may be determined based on the values provided by the user, for example, via GUI element 410 in the first portion of GUI 400 as shown in FIG. 4A. In other embodiments, in an evaluation mode, the applicability may be determined based on values obtained from the data store 144. In yet other embodiments, the applicability may be determined based on a combination of values obtained from the user and the data store 144.

Continuing with the example rules tree 820, in some embodiments, process 600 at act 608 may identify branches of rules tree 820 that include nodes indicating a dependency on the PrincipalID attribute and/or its value. In some embodiments, branches of the rules tree 820 including condition nodes 826a, 826b, 826c, and 826d that indicate a dependency on the value of the PrincipalID attribute may be identified. For example, referring back to FIG. 8C, one or more of these branches may be identified: i) first branch including nodes 821, 822, 823a, 824a, 825a, 826a, 827a; ii) second branch including nodes 821, 822, 823b, 824b, 825c, 826b, 827c; iii) third branch including nodes 821, 822, 823c, 824c, 825e, 826c, 827f; and iv) fourth branch including nodes 821, 822, 823d, 824d, 825g, 826d, 827h. In some embodiments, branches with other nodes than condition nodes or without condition nodes may be identified as indicating a dependency on the PrincipalID attribute and/or its value. For example, other branches, such as a branch including nodes 821, 822, 823a, 824a, 825b, 827b, may be identified as indicating a dependency on the PrincipalID attribute and/or its value because this branch is applicable when the value of the PrincipalID attribute is not set. It will be appreciated that a similar process may be utilized to identify branches of rules tree 720 that include nodes indicating a dependency on the “Security Group” attribute or its value.

Next, at act 610 of FIG. 6B, a GUI including a visual rendering of at least some of the rules obtained at act 602 is generated. For example, FIG. 8D illustrates a visual rendering of at least some of the example rules for granting and/or denying privileges to actor(s) for performing action(s) on one or more instances of a “User Report” data entity, in accordance with some aspects of the technology described herein. The visual rendering may include text associated with the rules, such as rules 802, 804, and 806 as shown in FIG. 8A. In other embodiments, the visual rendering may include a rendering of text associated with the rules identified at act 608, which may include a rendering of some but not all the rules 802, 804, 806. The visual rendering of FIG. 8D may be included in a second portion of a GUI, as described herein. The rule(s) may be emphasized by visually emphasizing text representing the rule(s). The text may be visually emphasized by highlighting, underlining, and/or changing font characteristics of at least some of the text representing the rule(s). In some embodiments, generating the GUI comprises generating the first portion of the GUI by generating a GUI element for each of the identified attributes associated with the condition nodes (e.g., attributes identified at act 604c). The GUI element may enable the user to provide input indicating a value for the attribute or otherwise present an obtained value for the attribute.

As shown in FIG. 8D, the visual rendering includes a condition statement 842 with respect to the data entity (e.g., Entity class is User Report) corresponding to condition node 822 of rules tree 820. The visual rendering includes evaluation statements 844a, 844b, 844c, and 844d corresponding to grant nodes 823a, 823b, 823c, and 823d, respectively, indicating whether create, read, update or delete privileges are evaluated. The visual rendering includes condition statements 846a, 846b, 846c, and 846d corresponding to condition nodes 826a, 826b, 826c, and 826d, respectively. The visual rendering includes grant statements 848a, 848b, 848c, and 848d corresponding to grantee nodes 827a, 827c, 827f and 827h, respectively. The visual rendering includes grant statements 850a, 850b, 850c, 850d, and 850e corresponding to grantee nodes 827b, 827d, 827e, 827g, and 827i, respectively.

In some embodiments, a visual rendering of at least some of the example rules for granting and/or denying privileges to actor(s) for performing action(s) on one or more instances of a “DataElement” data entity is illustrated in FIG. 4A. In some embodiments, the visual rendering in FIG. 4A may include text associated with the rules, such as rules 702, 704, and 706 as shown in FIG. 7A. In other embodiments, the visual rendering may include a rendering of text associated with the rules identified at act 608, which may include a rendering of some but not all the rules 702, 704, 706. The visual rendering of FIG. 4A may be included in a second portion of a GUI, as described herein. The rule(s) may be emphasized by visually emphasizing text representing the rule(s), as shown in FIGS. 4B-4D, for example. The text may be visually emphasized by highlighting, underlining, and/or changing font characteristics of at least some of the text representing the rule(s). In some embodiments, generating the GUI comprises generating the first portion of the GUI (e.g., GUI 400) by generating a GUI element for each of the identified attributes associated with the condition nodes (e.g., attributes identified at act 604c). The GUI element (e.g., GUI element 410) may enable the user to provide input indicating a value for the attribute or otherwise present an obtained value for the attribute.

Next, at act 612 of FIG. 6B, the generated GUI is displayed. Next, process 600 proceeds to act 614, where a determination may be made regarding whether information indicating a different attribute value has been obtained, for example, from the user or data store 144. In response to determining that information indicating a different attribute value has been obtained, the process loops back to either act 608 or 604c. In some embodiments, when the information indicates a different attribute value for the same attribute that was previously identified at act 604c, the process proceeds to act 608, where one or more rules that depend on the different attribute value are identified. In other embodiments, when the information indicates a different attribute value for another attribute different from the attribute that was previously identified at act 604c, the process loops back to act 604c, where the other attribute of the data entity whose values are used by at least some of the rules is identified. In either case, process 600 proceeds through the remaining downstream acts until a determination is made at act 614 that information indicating a different attribute value has not been obtained. In response to a determination that information indicating a different attribute value has not been obtained, the process 600 of FIG. 6B ends.

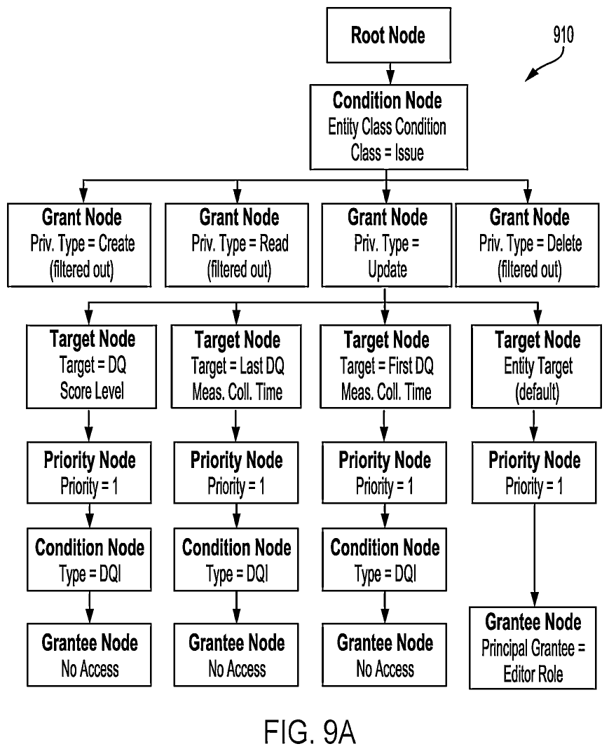

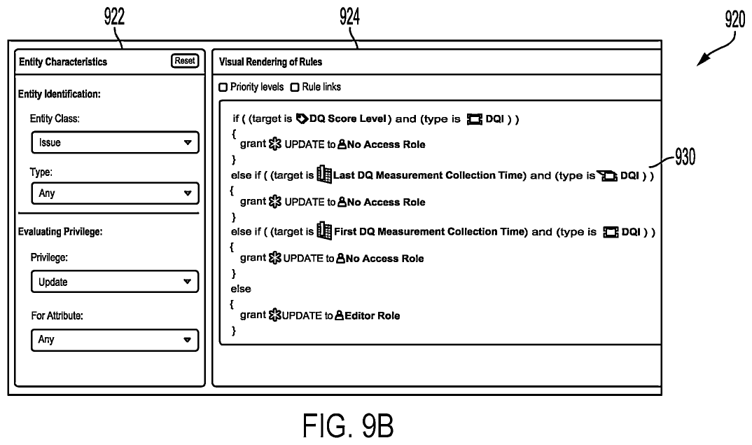

FIG. 9A illustrates an example rules tree 910 embodying rules having a logical ‘and’ condition, in accordance with some aspects of the technology described herein. The rules tree 910 illustrates branches associated with a grant node indicating an update privilege type. These branches may be identified by filtering the rules tree 910 based on the value of the privilege type, obtained from the user or the data store 144. Because the obtained value of privilege type indicates an “Update” privilege type, only branches associated with the respective grant node are considered applicable for purposes of generating the visual rendering of FIG. 9B, described below. The other branches associated with create, read, and delete privilege types are filtered out. As shown in FIG. 9A, combinations of target nodes and condition nodes indicate a logical ‘and’ condition for determining which actor(s) is granted privileges to perform the update action on one or more instances of the “Issue” data entity. For example, a first combination indicates that if target=DQ Score Level and Type=DQI, no actor is granted privileges to perform the update action on one or more instances of the “Issue’ entity; a second combination indicates that if target=Last DQ Measurement Collection Time and Type=DQI, no actor is granted privileges to perform the update action on one or more instances of the “Issue’ data entity; and a third combination indicates that if target=First DQ Measurement Collection Time and Type=DQI, no actor is granted privileges to perform the update action on one or more instances of the “Issue’ data entity.

FIG. 9B illustrates a GUI 920 including a visual rendering, generated using the rules tree of FIG. 9A, of at least some of the example rules for granting and/or denying privileges to actor(s) for performing action(s) on one or more instances of a “Issue” data entity, in accordance with some aspects of the technology described herein. GUI 920 includes a first portion 922 including GUI elements indicating the value of the data entity class as “Issue” and the privilege type of interest as “Update.” The GUI 920 includes a second portion 924 including the visual rendering generated using the rules tree 910 of FIG. 9A.

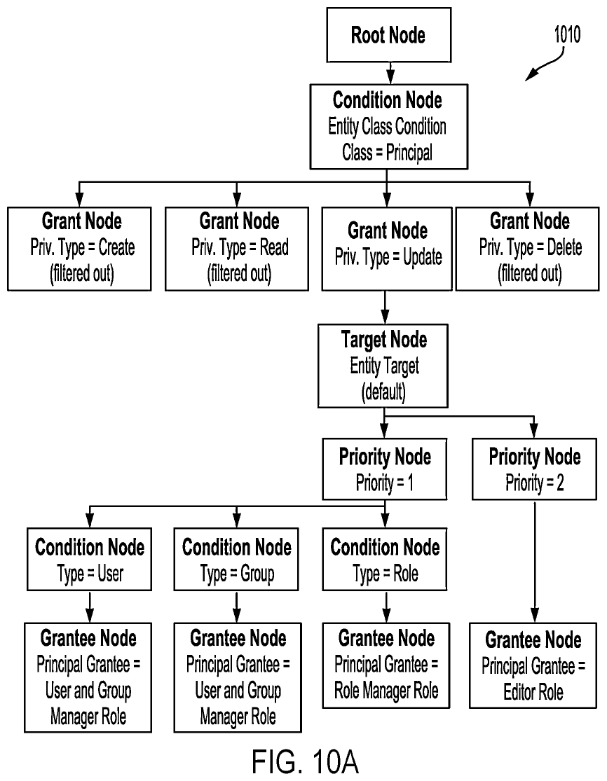

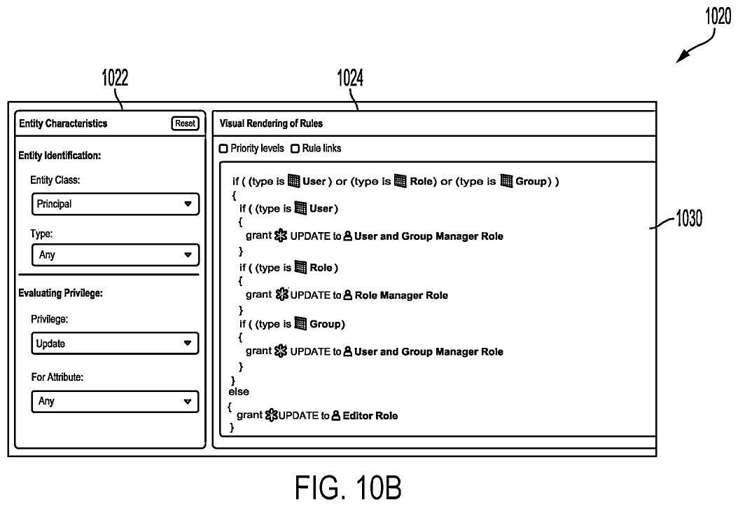

FIG. 10A illustrates an example rules tree 1010 embodying rules having a logical ‘or’ condition, in accordance with some aspects of the technology described herein. The rules tree 1010 illustrates branches associated with a grant node indicating an update privilege type. These branches may be identified by filtering the rules tree 1010 based on the value of the privilege type, obtained from the user or the data store 144. Because the obtained value of privilege type indicates an “Update” privilege type, only the branches associated with the respective grant node are considered applicable for purposes of generating the visual rendering of FIG. 10B, described below. The other branches associated with create, read, and delete privilege types are filtered out. As shown in FIG. 10A, the condition nodes specifying the type of roles indicate a logical ‘or’ condition for determining which actor(s) is granted privileges to perform the update action on one or more instances of the “Principal” entity.

FIG. 10B illustrates a visual rendering, generated using the rules tree of FIG. 10A, of at least some of the example rules for granting and/or denying privileges to actor(s) for performing action(s) on one or more instances of a “Principal” data entity, in accordance with some aspects of the technology described herein. GUI 1020 includes a first portion 1022 including GUI elements indicating the value of the data entity class as “Principal” and the privilege type of interest as “Update.” The GUI 1020 includes a second portion 1024 including the visual rendering generated using the rules tree 1010 of FIG. 10A.

FIG. 11A is an illustrative diagram of an example GUI 1115 through which a user may select an “editor” mode of operation, in accordance with some aspects of the technology described herein. GUI 1115 includes a GUI element 1020 for selecting the “editor” mode of operation in which a user can create, make changes to, and/or delete one or more rules associated with one or more data entities. In some embodiments, GUI 1115 may be displayed in response a user navigating through various configuration options and selecting a GUI element (not shown) labeled “Privileges”. In some embodiments, GUI 1115 may include a GUI element 1102 for selecting the “simulator” mode of operation as described herein.

GUI 1115 provides a user with options for selecting a privilege of interest for one or more rules for granting and/or denying privileges, in accordance with some aspects for the technology described herein. GUI 1115 includes a GUI element 1125 for selecting a privilege of interest. In some embodiments, a user may be guided to select a particular privilege of interest from among a number of privilege types (e.g., “CREATE”, “READ”, “UPDATE”, “DELETE”, etc.) displayed via GUI element 1125. This assists the user in entering values into the system by identifying the possible values that are compatible with the data processing system. This avoids the introduction of incompatible values in the data processing system, which may result in run-time errors. In some embodiments, GUI element 1125 may include a drop-down menu, but other GUI elements, such as, radio buttons, check boxes, etc., may be used additionally or alternatively.

GUI 1115 also provides a user with options for selecting a data entity to which one or more rules for granting and/or denying privileges apply, in accordance with some embodiments for the technology described herein. FIG. 11A shows a selection of the “CREATE” privilege via GUI element 1125. GUI 1115 includes a GUI element 1130 for selecting a data entity (e.g., “DataElement” data entity) to which rule 1135 applies and/or to which any newly created rules will apply. In some embodiments, rule 1135 may include a default rule that the system generates for granting and/or denying privileges to one or more actors (e.g., actors with Editor role and/or other actors) to perform a “CREATE” action on one or more instances of the “DataElement” data entity selected via GUI element 1130. In some embodiments, GUI 1115 may include additional GUI elements that allow selection of attributes of the “DataElement” data entity to which one or more rules apply. In these embodiments, the GUI 1115 may include an additional GUI element (not shown) for selecting a target attribute associated with the “DataElement” data entity for which one or more rules may be created.

FIG. 11B-11D are illustrative diagrams of example GUIs 1116, 1117, 1118 through which a user may create new rules and/or edit existing rules associated with a particular privilege of interest and data entity, in accordance with some aspects of the technology described herein. As shown in FIG. 11B, a user may be provided with options 1140 to edit, add, and delete one or more rules. GUI 1116 includes a GUI element 1142 for editing one or more rules, a GUI element 1144 for adding one or more rules, and a GUI element 1146 for deleting one or more rules.

In some embodiments, selection of GUI element 1142 in GUI 1116 causes GUI 1117 depicted in FIG. 11C to be generated and presented where a user may edit one or more rules. In some embodiments, editing the rules may include making changes to conditions associated with existing rules, actors who are granted the privilege of interest, and/or other changes. As shown in FIG. 11C, the user may change the actor who is granted privilege to perform the “CREATE” action. GUI 1117 includes a GUI element 1150 for selecting a grantee or actor who is granted the “CREATE” privilege type. As shown in FIG. 11C, GUI 1117 provides various options from which a user can select a desired grantee. Some example options depicted in FIG. 11C include “BizHierarchy Accountable Party” grantee, “Classification Accountable Party” grantee, “Empty” grantee, “Inherit from parent” grantee, “Accountable Party” grantee, “Principal” grantee, and “Principal Attribute” grantee.

In some embodiments, the “BizHierarchy Accountable Party” grantee option grants “CREATE” privilege to an accountable party associated with a hierarchy (e.g., BizHierarchy) to which the data entity selected via GUI element 1130 belongs. Selection of this option may prompt the user to select the BizHierarchy using an additional GUI element, such as a drop-down menu (not shown in GUI 1117).

In some embodiments, the “Classification Accountable Party” grantee option grants “CREATE” privilege to an accountable party associated with a classification specified for the data entity selected via GUI element 1130. Selection of this option may prompt the user to select the classification using an additional GUI element, such as a drop-down menu (not shown in GUI 1117).

In some embodiments, the “Empty” grantee option does not specify a grantee.

In some embodiments, the “Inherit from parent” grantee option grants “CREATE” privilege to the same grantees (e.g., actors, accountable parties, etc.) assigned to the parent data entity of the data entity selected via GUI element 1130. As shown in FIG. 11C, the “Inherit from parent” grantee option is selected via GUI element 1150.

In some embodiments, the “Accountable Party” grantee option grants “CREATE” privilege to an accountable party directly associated with the data entity selected via GUI element 1130. Selection of this option may prompt the user to select a value for the accountable party using an additional GUI element, such as a drop-down menu (not shown in GUI 1117).

In some embodiments, the “Principal” grantee option grants “CREATE” privilege to a user, group, or role directly associated with the data entity selected via GUI element 1130. Selection of this option may prompt the user to select a user, group, or role using a first additional GUI element, such as a drop-down menu (not shown in GUI 1117) including the three options user, group, and role, followed by selection of the principal to whom the “CREATE” privilege is granted using a second additional GUI element, such as a drop-down menu (also not shown in GUI 1117).

In some embodiments, the “Principal Attribute” grantee option grants “CREATE” privilege to a user, group, or role associated with an attribute of the data entity selected via GUI element 1130. Selection of this option may prompt the user to select a user, group, or role using a first additional GUI element, such as a drop-down menu (not shown in GUI 1117) including the three options user, group, and role, followed by selection of the attribute using a second additional GUI element, such as a drop-down menu (also not shown in GUI 1117).

In some embodiments, selection of GUI element 1144 in GUI 1116 of FIG. 11B causes GUI 1118 depicted in FIG. 11D to be generated and displayed where a user may add new rules or add new conditions to existing rules. In some embodiments, GUI 1118 may allow a user to edit and/or add conditions under which the rule applies. A grant portion 1155 of the rule may be created based on selection of the “Principal” grantee option via GUI element 1150 in FIG. 11C. GUI 1118 includes a dialog box 1156 for selecting, adding and/or editing one or more conditions under which the rule applies. For example, a rule may include an if-statement which describes one or more conditions that are to be met. Such conditions may be specified via GUI 1118. The rule applies to the data entity when the specified conditions are met.

FIG. 11E is an illustrative diagram of an example GUI 1119 through which a user may view one or more rules associated with a particular data entity and privilege of interest, in accordance with some aspects for the technology described herein. Selection of GUI element 1160 in GUI 1119 causes one or more rules associated with the “UserReport” data entity and the “DELETE” privilege to be displayed. GUI 1119 includes two rules 1150, 1152 associated with the “UserReport” data entity and the “DELETE” privilege. The rules define conditions under which the “DELETE” privilege applies and to whom the “DELETE” privilege is granted. Rule 1150 specifies a condition (if “PrincipalID” is set) under which the “DELETE” privilege applies. Rule 1150 indicates that an actor (e.g., principal) specified in “PrincipalID” attribute is granted privileges to perform a “DELETE” action on one or more instances of the “UserReport” data entity if the “PrincipalID” is set. Rule 1152 grants an actor (with an Editor role) privileges to perform a “DELETE” action on one or more instances of the “UserReport” data entity selected via GUI element 1130. Rule 1152 may be considered to include an implied if-statement, where an actor is granted privileges to perform the “DELETE” action if the actor is associated with the Editor role.

In some embodiments, rules that are evaluated together are grouped into a case. As shown in FIG. 11E, GUI 1119 includes two cases 1172, 1174, each of which contain a single rule. For example, the first case 1172 includes rule 1150 that allows an actor who created the report (i.e., the actor who is the principal specified in the PrincipalID attribute) to delete it. The second case 1174 includes rule 1152 that allows an actor who is associated with an Editor role to delete the report. Although GUI 1119 depicts each case with a single rule, a case can contain multiple rules with multiple conditions (for example, if-statements). Referring to FIG. 11D, GUI 1118 includes a GUI element 1157 that allows a user to add a new case and specify/create rules within the case.

In some embodiments, all rules in a case have the same priority value and are evaluated together by the data processing system 120. In some embodiments, evaluation of the rules may be performed in the “evaluator” mode of operation. If a condition defined by any of the rules in a case is met, the data processing system 120 may grant the privilege defined in the rule or rules associated with the case and does not continue to evaluate any subsequent cases. If none of the conditions defined in a case are met, the data processing system 120 evaluates the next case until a case is identified where one or more conditions set in its rules is met.

In some embodiments, a determination of whether or when one or more rules apply to a data entity and/or evaluation of the rules may include performing the determination and/or evaluation on one or more instances of the data entity (e.g., instances obtained from the data entity instances data store 144).

FIGS. 12A-12E are illustrative diagrams of example GUIs 1200, 1202, 1204, 1206, and 1208 through which a user may create a new rule and/or edit existing rules for granting and/or denying privileges to actor(s) for performing action(s) on one or more instances of a “BizAsset” data entity, in accordance with some aspects of the technology described herein. FIGS. 12A-12E depict GUIs that the user traverses to edit a rule to include conditions for granting privileges to actors to perform “READ” actions on one or more instances of the “BizAsset” data entity. For example, an actor with an Executive role may be granted privileges to perform “READ” actions on one or more instances of a “BizAsset” data entity having a classification attribute indicating a sensitivity level of “Highly Confidential.”

FIG. 12A illustrates a GUI 1200 that is generated and presented in response to the user selecting the “editor” mode of operation, selecting the privilege of interest (i.e., READ) via GUI element 1125, and selecting the data entity (e.g., “BizAsset”) via GUI element 1130. In some embodiments, GUI 1200 may be presented in response to the user selecting the “editor” mode of operation and the user may be presented with options to select the privilege of interest, the data entity, and any target attributes associated with the data entity via GUI 1200.

As shown in FIG. 12A, any existing rules 1220, 1222 associated with the “BizAsset” data entity and the selected privilege of interest are displayed in GUI 1200. GUI 1200 includes two cases 1211 and 1212. Case 1211 includes rule 1220 and case 1212 includes rule 1222. Rule 1220 specifies a condition (e.g., if a current workflow state of the data entity is the “Draft” state) under which the “READ” privilege applies. Rule 1220 indicates that an actor (with an Editor role) is granted privileges to perform a “READ” action on one or more instances of the “BizAsset” data entity if the specified condition is met. Rule 1222 grants an actor (with an Editor role) privileges to perform a “READ” action on one or more instances of the “BizAsset” data entity. GUI 1200 also includes a GUI element 1216 for selecting a target attribute associated with the “BizAsset” data entity for which one or more rules may be defined/created.

FIG. 12B illustrates a GUI 1202 that allows the user to add a condition to rule 1222 via dialog box 1225. FIG. 12B depicts a condition associated with the sensitivity classification attribute of the “BizAsset” data entity being added to rule 1222 via dialog box 1225. The dialog box 1225 allows the user to specify the condition indicating a sensitivity level of “Highly Confidential.”

In some embodiments, the data processing system 105 automatically generates a third case 1213 to provide at least one fallback rule 1224 for instances when neither the rule/condition in case 1211 nor the rule/condition in case 1212 applies.

FIG. 12C illustrates a GUI 1204 that allows the user to edit a grantee for rule 1222 via dialog box 1226. FIG. 12C depicts a selection of “Executive” via dialog box 1226 that indicates that the “READ” privilege is granted to an actor associated with the Executive role if the condition specified for rule 1222 via GUI 1204 is met.

In some embodiments, the data processing system 120 may evaluate the cases defined for a data entity and privilege of interest in the order in which they appear in the GUI. For example, as shown in GUI 1206 of FIG. 12D, case 1211 may be evaluated first followed by case 1212 and then case 1213. GUI 1206 includes GUI elements 1281, 1282 for changing the order in which cases are evaluated. For example, a user may utilize GUI elements 1281, 1282 to move cases up or down to alter the order of evaluation. GUI elements 1281, 1282 may include downward or upward pointing arrow buttons, but other GUI elements may be used additionally or alternatively.

FIG. 12E illustrates a GUI 1208 that depicts a finalized version of rules for granting and/or denying privileges to actor(s) for performing “READ” actions on one or more instances of a “BizAsset” data entity. As shown in GUI 1208, case 1212 is moved up such that it is evaluated before case 1211. In some embodiments, the data processing system 105 may evaluate case 1212. Evaluation of case 1212 may include evaluation of condition(s)/criteria specified in rule 1222. If the criteria are met during evaluation, the data processing system 105 grants the specified privileges and stops evaluating further cases. For example, if the condition indicating a sensitivity level of “Highly Confidential” is met (i.e., the sensitivity level associated with the BizAsset data entity is set to “Highly Confidential”) and the user is associated with an Executive role, the data processing system 105 may grant the user with the Executive role privileges to perform the “READ” action on one or more instances of a “BizAsset” data entity. On the other hand, if the criteria are not met, for example, when the sensitivity level is set to “Highly Confidential”, but the user has an Editor role rather than an Executive role, the data processing system 120 continues to evaluate case 1211.

In some embodiments, evaluation of case 1211 comprises evaluating a current workflow state in the workflow associated with the BizAsset data entity. The criteria specified in rule 1220 may include determining whether the current workflow state for the BizAsset data entity is a “Draft” state. If the current workflow state for the BizAsset data entity is the “Draft” state, the data processing system 105 may grant “READ” privileges to users with an Editor rule. As with case 1212, if the criteria in case 1211 are met, the data processing system 105 may grant the specified privileges and stop evaluating further cases. On the other hand, if the criteria are not met, the data processing system 105 continues to evaluate case 1213. Because case 1213 is the final fallback case, if none of the criteria specified in case 1212 or case 1211 are met, the data processing system 105 may grant “READ” privileges to users with a User role.

In some embodiments, the user may make edits to the rules by editing nodes of rules trees. In these embodiments, at least a portion of a rules tree, for example, rule tree 720, 820, 910, 1010 may be presented to a user via a GUI and the user may edit one or more nodes of the rules tree. For example, an edit to a single node of a rules tree may cause associated updates to one or more underlying rules. Referring to FIG. 8C, if rules tree 820 is presented to the user via a GUI and node 827b is edited to change the Principal Grantee from “Editor Role” to “User Role”, a corresponding change may be made to grant statement 850a shown in FIG. 8D.

FIG. 13 is a flowchart of an illustrative process 1300 for creating and/or editing rules associated with a data entity, in accordance with some aspects of the technology described herein. Process 1300 may be executed by any suitable data processing system and, for example, may be executed by data processing system 105 described with reference to FIG. 2.

Process 1300 begins at act 1302, during which a selection of a first privilege and a selection of a first data entity among a plurality of data entities is obtained. For example, the selection of a first privilege, such as “CREATE” privilege, and the selection of a first data entity, such as the “DataElement” data entity, may be obtained via GUI 1115 depicted in FIG. 11A. As another example, in some embodiments, the selection of a first privilege, such as “READ” privilege, the selection of a first data entity, such as the “BizAsset” data entity, and a selection of any target attributes associated with the “BizAsset” data entity, may be obtained via GUI 1100 depicted in FIG. 11A. In some embodiments, the selections may be obtained via separate GUIs.

Next, at act 1304, one or more rules for granting and/or denying the first privilege to one or more actors to perform one or more actions on one or more instances of the first data entity are obtained (e.g., by receiving information from a computer over a network and/or accessing information from a computer readable storage medium and/or data store). For example, a rule such as rule 1220 of FIG. 12A may be obtained. One or more additional rules, for example, rule 1222, may also be obtained. The rule(s) may be obtained from any suitable source(s), for example, from a data store 146 communicatively coupled to the data processing system 105, as aspects of the technology described herein are not limited in this respect.

Next, at act 1306, the one or more rules may be updated. A first rule may be updated to obtain a second rule based on user input obtained through the GUI. Updating the first rule may include updating the first rule by adding a new condition to the rule and/or editing an existing condition associated with the rule. In some embodiments, the first rule may be updated by determining a condition under which the first rule applies. A condition under which the first rule applies may be determined by obtaining a selection of a first attribute of a plurality of attributes associated with the first data entity at act 1306a; presenting, via the GUI, a plurality of selectable options corresponding to a respective plurality of values of the first attribute at act 1306b; and obtaining, via the GUI, a selection of a first value among plurality of values of the first attribute at act 1306c.

Referring to FIG. 12B, rule 1222 may be updated based on user input obtained via dialog box 1225. At act 1306a, a selection of the sensitivity classification attribute associated with the “BizAsset” data entity may be obtained. In response to the selection, at act 1306b, a plurality of selectable options may be presented via the dialog box 1225. The selectable options may be presented via a drop-down menu and correspond to respective values of the sensitivity classification attribute, such as, Confidential, Highly Confidential, Internal, and Public. In some embodiments, the selectable options are identified using metadata stored in the data store 144. The metadata may specify values for the first data entity and the selectable options may correspond to these values specified in the system. In some embodiments, the selectable options are identified using metadata specifying relationships among data entities stored in the data store 244. For example, the metadata may be used to identify one or more data entities related to the first data entity according to a hierarchy and a determination may be made regarding whether an attribute (and its values) associated with a related data entity applies to the first data entity. In response to a determination that the attribute (and its values) associated with the related data entity applies to the first data entity, the selectable options corresponding to the values associated with the related data entity may be presented via the GUI. Utilizing the metadata to identify selectable options in this manner results in only relevant options being presented to the user.

At act 1306c, a selection of a first value among the various values may be obtained. FIG. 12B depicts a selection of the value “Highly Confidential.” This selection indicates that rule 1222 applies to the “BizAsset” data entity when the sensitivity classification attribute takes on the “Highly Confidential” value. In some embodiments, an indication that a rule applies to a data entity (e.g., when an attribute of the entity takes on a particular value) may include an indication that the rule applies to an instance of the data entity (e.g., an instance obtained from a data store, such as data entity instances data store 144).

In some embodiments, the first rule may be updated to reflect the selections. A condition under which the first rule applies may be added or edited based on the selections. For example, based on the selections made via dialog box 1225 in FIG. 12B, rule 1222 may be updated by adding a condition associated with the sensitivity classification attribute of the “BizAsset” data entity to rule 1222.

In some embodiments, updating the first rule may include saving any changes made as a result of the various obtained user inputs/selections (e.g., obtained by receiving input via a GUI, receiving information from a computer over a network and/or accessing information from a computer readable storage medium and/or data store). Updated rule(s) may be saved to the data store 146.

FIG. 14 is a flowchart of an illustrative process 1400 for creating and/or editing rules associated with a data entity, in accordance with some aspects of the technology described herein. Process 1400 may be executed by any suitable data processing system and, for example, may be executed by data processing system 105 described with reference to FIG. 2.

Process 1400 begins at act 1402, during which a selection of a first privilege and a selection of a first data entity among a plurality of data entities is obtained. For example, the selection of a first privilege, such as “CREATE” privilege, and the selection of a first data entity, such as the “DataElement” data entity, may be obtained via GUI 1115 depicted in FIG. 11A. As another example, in some embodiments, the selection of a first privilege, such as “READ” privilege, the selection of a first data entity, such as the “BizAsset” data entity, and a selection of any target attributes associated with the “BizAsset” data entity, may be obtained via GUI 1100 depicted in FIG. 11A. In some embodiments, the selections may be obtained via separate GUIs.

Next, at act 1404, one or more rules for granting and/or denying the first privilege to at least one actor to perform at least one action on one or more instances of the first data entity are obtained (e.g., by receiving information from a computer over a network and/or accessing information from a computer readable storage medium and/or data store). For example, referring to FIG. 12A, a rule, such as rule 1220 for granting and/or denying the “READ” privilege to an actor (e.g., with an Editor role) to perform a READ action on one or more instances of the “BizAsset” data entity, may be obtained. One or more additional rules, for example, rule 1222, may also be obtained. The rule(s) may be obtained from any suitable source(s), for example, from a data store 146 communicatively coupled to the data processing system 120, as aspects of the technology described herein are not limited in this respect.

Next, at act 1406, the one or more rules may be updated. A first rule may be updated to obtain a second rule based on user input obtained through the GUI. Updating the first rule may include updating the first rule by changing an actor specified in the first rule and/or adding an actor to the first rule. In some embodiments, in response to obtaining user input to edit an actor specified in the rule, a plurality of actors to whom the first privilege can be granted are identified in act 1406a and a plurality of selectable options corresponding to the plurality of actors are presented in act 1406b.

Referring to FIG. 12C, rule 1222 may be updated based on user input obtained via dialog box 1226 in GUI 1204. At act 1406a, a plurality of actors to whom the “READ” privilege can be granted may be identified in response to obtaining user input to edit an actor specified in rule 1222. In some embodiments, the plurality of actors may be identified based on one or more values of one or more attributes of the “BizAsset” data entity. In some embodiments, the actor(s) are identified using metadata specifying relationships among data entities stored in the data store 244. The metadata may be used to identify one or more data entities related to the first data entity according to a hierarchy to which the first data entity belongs. For example, when a value of an attribute of the “BizAsset” data entity indicates a particular hierarchy to which the data entity belongs, a determination may be made regarding whether actors specified in rules associated with a related data entity (i.e., related to the “BizAsset” data entity according to the hierarchy) apply to the “BizAsset” data entity. One data entity may be related to another data entity in a hierarchy in any of numerous ways. For example, one data entity may be an ancestor (a parent, a grandparent, etc.) of another data entity in a hierarchy. As another example of a relationship, one data entity may be a descendant (e.g., a child, a grandchild, etc.) of another data entity in a hierarchy. As yet another example of a relationship, one data entity may share a common ancestor with another data entity in a hierarchy. In response to a determination that actors specified in rules associated with a related data entity apply to the “BizAsset” data entity, the actors may be identified in act 1406a.

A plurality of selectable options corresponding to the identified actors may be presented via the dialog box 1226 at act 1406b. The selectable options may be presented in a drop-down menu and correspond to the actors identified in act 1406a.

In some embodiments, the first rule may be updated to reflect the selections. An actor specified in the first rule may be updated based on the selections. For example, based on the selections made via dialog box 1226 in FIG. 12C, rule 1222 may be updated by changing the actor to whom the “READ” privilege is granted.

In some embodiments, updating the first rule may include saving any changes made as a result of the obtained user inputs/selections (e.g., obtained by receiving input via a GUI, receiving information from a computer over a network and/or accessing information from a computer readable storage medium and/or data store). Updated rule(s) may be saved to the data store 146.

In some embodiments, updating a rule may include updating the rule by i) adding a new condition to the rule and/or editing an existing condition associated with the rule, and ii) changing an actor specified in the rule and/or adding an actor to the rule. In these embodiments, acts of FIG. 13 (e.g., acts 1306, 1306a, 1306b, 1306c) and FIG. 14 (e.g., acts 1406, 1406a, 1406b) may be performed sequentially to update the rule.

### Additional Implementation Detail

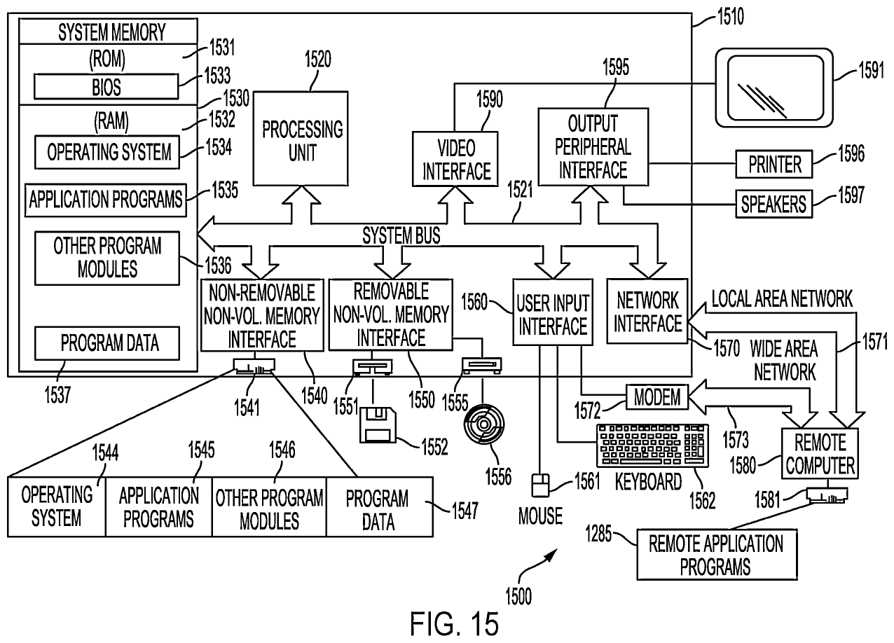

FIG. 15 illustrates an example of a suitable computing system environment 1500 on which the technology described herein may be implemented. The computing system environment 1500 is only one example of a suitable computing environment and is not intended to suggest any limitation as to the scope of use or functionality of the technology described herein. Neither should the computing environment 1500 be interpreted as having any dependency or requirement relating to any one or combination of components illustrated in the exemplary operating environment 1500.

The technology described herein is operational with numerous other general purpose or special purpose computing system environments or configurations. Examples of well-known computing systems, environments, and/or configurations that may be suitable for use with the technology described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. The technology described herein may also be practiced in distributed computing environments where tasks are performed by remote processing devices that are linked through a communications network. In a distributed computing environment, program modules may be located in both local and remote computer storage media including memory storage devices.

With reference to FIG. 15, an exemplary system for implementing the technology described herein includes a general purpose computing device in the form of a computer 1500. Components of computer 1510 may include, but are not limited to, a processing unit 1520, a system memory 1530, and a system bus 1521 that couples various system components including the system memory to the processing unit 1520. The system bus 1521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 1510 typically includes a variety of computer readable media. Computer readable media can be any available media that can be accessed by computer 1510 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 1510. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 1530 includes computer storage media in the form of volatile and/or nonvolatile memory such as read only memory (ROM) 1531 and random access memory (RAM) 1532. A basic input/output system 1533 (BIOS), containing the basic routines that help to transfer information between elements within computer 1510, such as during start-up, is typically stored in ROM 1531. RAM 1532 typically contains data and/or program modules that are immediately accessible to and/or presently being operated on by processing unit 1520. By way of example, and not limitation, FIG. 15 illustrates operating system 1534, application programs 1535, other program modules 1536, and program data 1537.

The computer 1510 may also include other removable/non-removable, volatile/nonvolatile computer storage media. By way of example only, FIG. 15 illustrates a hard disk drive 1541 that reads from or writes to non-removable, nonvolatile magnetic media, a flash drive 1551 that reads from or writes to a removable, nonvolatile memory 1552 such as flash memory, and an optical disk drive 1555 that reads from or writes to a removable, nonvolatile optical disk 1556 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1541 is typically connected to the system bus 1521 through a non-removable memory interface such as interface 1540, and magnetic disk drive 1551 and optical disk drive 1555 are typically connected to the system bus 1521 by a removable memory interface, such as interface 1550.

The drives and their associated computer storage media described above and illustrated in FIG. 15, provide storage of computer readable instructions, data structures, program modules and other data for the computer 1510. In FIG. 15, for example, hard disk drive 1541 is illustrated as storing operating system 1544, application programs 1545, other program modules 1546, and program data 1547. Note that these components can either be the same as or different from operating system 1534, application programs 1535, other program modules 1536, and program data 1537. Operating system 1544, application programs 1545, other program modules 1546, and program data 1547 are given different numbers here to illustrate that, at a minimum, they are different copies. An actor may enter commands and information into the computer 1510 through input devices such as a keyboard 1562 and pointing device 1561, commonly referred to as a mouse, trackball or touch pad. Other input devices (not shown) may include a microphone, joystick, game pad, satellite dish, scanner, or the like. These and other input devices are often connected to the processing unit 1520 through a user input interface 1560 that is coupled to the system bus, but may be connected by other interface and bus structures, such as a parallel port, game port or a universal serial bus (USB). A monitor 1591 or other type of display device is also connected to the system bus 1521 via an interface, such as a video interface 1590. In addition to the monitor, computers may also include other peripheral output devices such as speakers 1597 and printer 1596, which may be connected through an output peripheral interface 1595.

The computer 1510 may operate in a networked environment using logical connections to one or more remote computers, such as a remote computer 1580. The remote computer 1580 may be a personal computer, a server, a router, a network PC, a peer device or other common network node, and typically includes many or all of the elements described above relative to the computer 1510, although only a memory storage device 1581 has been illustrated in FIG. 15. The logical connections depicted in FIG. 15 include a local area network (LAN) 1571 and a wide area network (WAN) 1573, but may also include other networks. Such networking environments are commonplace in offices, enterprise-wide computer networks, intranets and the Internet.

When used in a LAN networking environment, the computer 1510 is connected to the LAN 1571 through a network interface or adapter 1570. When used in a WAN networking environment, the computer 1510 typically includes a modem 1572 or other means for establishing communications over the WAN 1573, such as the Internet. The modem 1572, which may be internal or external, may be connected to the system bus 1521 via the actor input interface 1560, or other appropriate mechanism. In a networked environment, program modules depicted relative to the computer 1510, or portions thereof, may be stored in the remote memory storage device. By way of example, and not limitation, FIG. 15 illustrates remote application programs 1585 as residing on memory device 1581. It will be appreciated that the network connections shown are exemplary and other means of establishing a communications link between the computers may be used.

Having thus described several aspects of at least one embodiment of the technology described herein, it is to be appreciated that various alterations, modifications, and improvements will readily occur to those skilled in the art.

Such alterations, modifications, and improvements are intended to be part of this disclosure, and are intended to be within the spirit and scope of disclosure. Further, though advantages of the technology described herein are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. However, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, aspects of the technology described herein may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments described above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the technology as described above. As used herein, the term “computer-readable storage medium” encompasses only a non-transitory computer-readable medium that can be considered to be a manufacture (i.e., article of manufacture) or a machine. Alternatively or additionally, aspects of the technology described herein may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the technology as described above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the technology described herein.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the technology described herein may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the technology described herein may be embodied as a method, of which examples are provided herein including with reference to FIGS. 5A and 5B. The acts performed as part of any of the methods may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by an “actor” or a “user”. It should be appreciated that an “actor” or a “user” need not be a single individual, and that in some embodiments, actions attributable to an “actor” or a “user” may be performed by a team of individuals and/or an individual in combination with computer-assisted tools or other mechanisms.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

1.-21. (canceled)

22. A method performed by a data processing system for editing rules for controlling access privileges to data stored by the data processing system in instances of data entities, the method comprising:
using at least one computer hardware processor of the data processing system to perform:
obtaining, via a graphical user interface (GUI), a selection of a first privilege and a selection of a first data entity of the data entities, wherein the first data entity comprises attributes including a first attribute;
obtaining a first rule for granting and/or denying the first privilege to a first actor to perform at least one action on one or more instances of the first data entity;
updating the first rule based on user input obtained through the GUI to obtain a second rule, the updating comprising:
determining a condition under which the first rule applies, the determining comprising:
obtaining, via the GUI, a selection of the first attribute;
presenting, via the GUI, a plurality of selectable options corresponding to a respective plurality of values of the first attribute; and
obtaining, via the GUI, a selection of a first value among plurality of values of the first attribute, the selection indicating that the first rule applies to the first data entity when the first attribute takes on the first value.

23. The method of claim 22, wherein updating the first rule based on the user input further comprises:
updating, based on the selection of the first value, the condition under which the first rule applies to obtain the second rule, the second rule including the updated condition.

24. The method of claim 22, wherein the first privilege is a create, a read, an update, or a delete privilege.

25. The method of claim 22, wherein the data processing system comprises at least one data store that stores metadata specifying relationships among the data entities, wherein the data entities are organized into one or more hierarchies, wherein the metadata specifies the one or more hierarchies, and wherein the first value of the first attribute indicates a first hierarchy, of the one or more hierarchies, to which the first data entity belongs.

26. The method of claim 25, wherein presenting, via the GUI, the plurality of selectable options comprises:
identifying the plurality of selectable options corresponding to the respective plurality of values of the first attribute using the metadata specifying relationships among the plurality of data entities.

27. The method of claim 22, wherein presenting, via the GUI, the plurality of selectable options comprises:
presenting, via at least one GUI element in the GUI, the plurality of selectable options corresponding to the respective plurality of values of the first attribute.

28. The method of claim 27, wherein the at least one GUI element comprises a drop-down menu, a radio button, and/or a check box.

29. The method of claim 22, wherein obtaining, via the GUI, the selection of the first attribute comprises:
obtaining a selection of a sensitivity classification attribute for the first data entity.

30. The method of claim 22, wherein obtaining, via the GUI, a selection of the first attribute comprises:
obtaining a selection of a workflow attribute for the first data entity.

31. The method of claim 22, wherein the first rule specifies one or more conditions under which the first rule applies, the one or more conditions including the determined condition.

32. A method performed by a data processing system for editing rules for controlling access privileges to data stored by a data processing system in instances of data entities, the method comprising:
using at least one computer hardware processor of the data processing system to perform:
obtaining, via a graphical user interface (GUI), a selection of a first privilege and a selection of a first data entity of the data entities, wherein the first data entity comprises attributes;
obtaining a first rule for granting and/or denying the first privilege to a first actor to perform at least one action on one or more instances of the first data entity;
updating the first rule based on user input obtained through the GUI to obtain a second rule, the updating comprising:
in response to obtaining user input to edit the first actor specified in the first rule:
identifying a plurality of actors to whom the first privilege can be granted based on at least one value of a first attribute of the attributes; and
presenting, via the GUI, a plurality of selectable options corresponding to the plurality of actors.

33. The method of claim 32, wherein updating the first rule based on the user input further comprises:
updating the first rule to obtain the second rule based on a selection of a first selectable option corresponding to a second actor, the second rule specifying the second actor.

34. The method of claim 32, wherein the first privilege is a create, a read, an update, or a delete privilege.

35. The method of claim 32, wherein the data processing system comprises at least one data store that stores metadata specifying relationships among the data entities, the data entities are organized into one or more hierarchies, the metadata specifies the one or more hierarchies, and the at least one value of the first attribute comprises a first value of the first attribute, and wherein the first value of the first attribute indicates a first hierarchy, of the one or more hierarchies, to which the first data entity belongs.

36. The method of claim 35, wherein identifying a plurality of actors to whom the first privilege can be granted comprises:
identifying the plurality of actors to whom the first privilege can be granted using the metadata specifying relationships among the data entities.

37. The method of claim 32, wherein presenting, via the GUI, a plurality of selectable options comprises:
presenting, via at least one GUI element in the GUI, the plurality of selectable options corresponding to the plurality of actors.

38. The method of claim 37, wherein the at least one GUI element comprises a drop-down menu, a radio button, and/or a check box.

39. The method of claim 32, wherein the first rule specifies one or more conditions under which the first rule applies and one or more actors to whom the first privilege can be granted.

40. The method of claim 32, further comprising:
obtaining a plurality of rules for granting and/or denying the first privilege to the first actor to perform the at least one action on one or more instances of the first data entity, the plurality of rules comprising the first rule;
presenting, via the GUI, the plurality of rules arranged in a first order; and
evaluating the plurality of rules in accordance with the first order.

41. The method of claim 40, further comprising:
in response to obtaining user input to update the first order of the plurality of rules via at least one GUI element in the GUI:
presenting, via the GUI, the plurality of rules arranged in an updated order; and
evaluating the plurality of rules in accordance with the updated order.

42. A data processing system, comprising:
at least one computer hardware processor;
at least one non-transitory computer-readable storage medium storing processor executable instructions that, when executed by the at least one computer hardware processor, cause the at least one computer hardware processor to perform a method comprising:
obtaining, via a graphical user interface (GUI), a selection of a first privilege and a selection of a first data entity of the data entities, wherein the first data entity comprises attributes including a first attribute;
obtaining a first rule for granting and/or denying the first privilege to a first actor to perform at least one action on one or more instances of the first data entity;
updating the first rule based on user input obtained through the GUI to obtain a second rule, the updating comprising:
determining a condition under which the first rule applies, the determining comprising:
obtaining, via the GUI, a selection of the first attribute;
presenting, via the GUI, a plurality of selectable options corresponding to a respective plurality of values of the first attribute; and
obtaining, via the GUI, a selection of a first value among plurality of values of the first attribute, the selection indicating that the first rule applies to the first data entity when the first attribute takes on the first value.

43. At least one non-transitory computer-readable storage medium storing processor executable instructions that, when executed by at least one computer hardware processor, cause the at least one computer hardware processor to perform a method comprising:
obtaining, via a graphical user interface (GUI), a selection of a first privilege and a selection of a first data entity of the data entities, wherein the first data entity comprises attributes including a first attribute;
obtaining a first rule for granting and/or denying the first privilege to a first actor to perform at least one action on one or more instances of the first data entity;
updating the first rule based on user input obtained through the GUI to obtain a second rule, the updating comprising:
determining a condition under which the first rule applies, the determining comprising:
obtaining, via the GUI, a selection of the first attribute;
presenting, via the GUI, a plurality of selectable options corresponding to a respective plurality of values of the first attribute; and
obtaining, via the GUI, a selection of a first value among plurality of values of the first attribute, the selection indicating that the first rule applies to the first data entity when the first attribute takes on the first value.
